(19) United States
(12) Patent Application Publication
(10) Pub. No.: US 2015/0302533 A1
(43) Pub. Date: Oct. 22, 2015

(54) GLOBAL EXCHANGE PLATFORM FOR THE FILM INDUSTRY PROFESSIONALS

(71) Applicant: Ranjeet Thakur, Tarzana, CA (US)

(72) Inventor: Ranjeet Thakur, Tarzana, CA (US)

(21) Appl. No.: 14/688,949

(22) Filed: Apr. 16, 2015

Related U.S. Application Data
(60) Provisional application No. 61/980,172, filed on Apr. 16, 2014.

(51) Int. Cl. G06Q 50/00; G06Q 10/00

(52) U.S. Cl. CPC G06Q 50/01; G06Q 10/00

(57) ABSTRACT

In one aspect, disclosed is a global online portal which provides an end-to-end solution for film industry professionals worldwide and in all languages. From writers to directors to technicians, every vertical related to a film is listed in a separate category and validated/authenticated by the portal. Each listed entity is defined in categories depending on its rating arrived at via a logical process. The services of each listed entity along with commercial terms & availability of their schedules are posted on their homepages. The portal manages intellectual property issues and creates a global exchange platform for all potential film makers around the world. It enables one to buy scripts listed in one language and use them to make a film in a different language. It also allows a producer to pick his desired actors and crew members for his next film at the click of a mouse.

### CROSS REFERENCE TO RELATED APPLICATIONS

This patent document claims priority to and the benefits of U.S. Provisional Patent Application No. 61/980,172, filed on Apr. 16, 2014. The entire content of the before-mentioned patent application is incorporated by reference as part of the disclosure of this application.

### TECHNICAL FIELD

The subject matter described in this disclosure generally relates to systems, devices, and techniques for providing an online portal for professionals in a select industry.

### BACKGROUND

Film making involves a collaboration of a large number of talented professionals in various domains of the multimedia industry. The collaboration in film making includes multiple stages and processes such as development, pre-production, post-production, and distribution. In each state and process, different domain experts in the multimedia industry are involved to provide their input and experience. Casting the right individual throughout the different stages and processes can be a complex and time consuming process.

### SUMMARY

Examples of implementations of the disclosed technology can provide an online portal to organize the complex movie making process by connecting talented multimedia professionals of different domains to a global single unified platform, where the media professionals' expertise, experience and knowledge are shared. The disclosed online portal of the global single unified platform can generate ample opportunities for the best talented professionals in the various domains of the multimedia field that includes all types of films including full-length movies and shorts.

### BRIEF DESCRIPTION OF THE DRAWINGS

FIG. 1 is a block diagram illustrating an example work flow of film production followed worldwide.

FIG. 2A is a diagram illustrating an exemplary login process.

FIG. 2B is an exemplary login screen.

FIG. 2C is an exemplary Forgot Password screen.

FIG. 2D is a process flow diagram of another exemplary login process.

FIGS. 3A and 3B are exemplary Create An Account screens for directing a user to create an account.

FIG. 3C is a diagram illustrating an example Registration Form to be filled for signing up with the disclosed portal.

FIG. 4A shows an exemplary main section of the profile page.

FIG. 4B shows an exemplary Experience (Professional experience with time period & description) and Preference services sections.

FIG. 4C shows the new skills 408, endorsed skills and education sections.

FIGS. 4D, 4E, and 4F show the photo gallery section.

FIG. 4G shows an exemplary Show-reels section.

FIG. 4H shows an uploaded show-reel can be viewed on a popup screen.

FIG. 4I shows an Update Profile Form as a part of the profile page.

FIG. 4J shows an Add Blog form that includes fields like Title, a Radio button image, a YouTube link, descriptions, etc. to allow a user to add a blog.

FIG. 4K shows a News Form to allow a user to add news.

FIG. 4L shows an Experience Form to allow a user to add experience.

FIG. 4M shows a Preferred Services form to allow a user to add preferred services.

FIG. 4N shows a New Skills form to allow a user to add his new or key skills.

FIG. 4O shows an exemplary Endorse Skills section.

FIG. 4P shows an Education form to allow the user to add his education.

FIG. 4Q shows a Share Show-reel form to allow a user to share a show-reel with anyone.

FIG. 4R shows a Share Photo form.

FIG. 5 is a flow diagram illustrating an example process of posting products and services.

FIG. 6 shows an example Blog page.

FIG. 7A, 7B, and 7C show an exemplary News Section.

FIG. 8A shows an exemplary Search page.

FIG. 8B shows an example of sending a Friend request from the search page.

FIG. 8C shows how an interested user can send friend requests or messages using the send request button and send message button from the search page.

FIG. 9A shows Friends request and unread messages alert on the dashboard.

FIGS. 9B and 9C show examples of Pop up of friend Request and Unread Messages.

FIG. 9D shows the Shared Gallery section.

FIG. 9E shows the Watch shared Show-reel page or section.

FIG. 9F shows the Shared Photo Gallery page.

FIG. 9G shows the View Shared Photo page.

FIG. 9H shows an exemplary Connection page.

FIG. 9I shows the Public Profile page.

FIG. 9J shows an exemplary Rating a Friend section.

FIG. 9K shows the star ratings on a search result.

FIG. 9L shows an exemplary Ratings details page.

FIG. 10A shows a notification icon 1000 and a timeline page.

FIG. 10B is a way of displaying a list of events in chronological order which is redirected from notification.

FIG. 10C shows an exemplary Message page.

FIG. 10D shows an exemplary Chat window.

FIG. 10E shows an exemplary Message popup window.

FIG. 11 is a flow diagram illustrating an example process of searching products and services.

FIG. 12 is a diagram illustrating an example collection of features of the portal.

FIG. 13 shows an example of displaying and identifying a mutual associate in a mutual associate or friend list.

FIG. 14 shows an example of a privacy settings page.

FIG. 15 is an example of a public profile page.

FIG. 16 shows an example Change Password form.

FIG. 17 shows an exemplary Endorsement Skills section.

FIG. 18A shows an exemplary login screen for entering the admin panel.

FIG. 18B is a process flow diagram of a login process for an admin panel.

FIG. 18C is an exemplary Admin User List Section.

FIG. 18D is an exemplary Admin User add form.

FIG. 18E is an exemplary Add Registered Portal User form.

FIG. 18F shows an exemplary Dashboard.

FIG. 18G shows an exemplary Blog Control Panel for displaying Blog Content.

FIG. 18H shows an exemplary Blog Comment panel for displaying Blog Comment. Admin User can edit or delete the comment placed on any blog.

FIG. 18I shows an exemplary Edit Blog Comment panel for editing Blog Comments.

FIG. 18J shows an exemplar News Content panel.

FIG. 18K shows an exemplary Add News form.

FIG. 18L shows an exemplary Edit News Content panel.

FIG. 18M shows an exemplary News Comment panel.

FIG. 18N shows an exemplary Edit News Comment form.

FIG. 18O shows an exemplary Photo Gallery.

FIG. 18P shows an exemplary popup window for displaying a photo.

FIG. 18Q shows an exemplary Photo Comment page.

FIG. 18R shows an exemplary Show-reel Gallery.

FIG. 18S shows an exemplary popup window for viewing a Show-reel.

FIG. 18T show an exemplary Show-reel Comment page.

FIG. 18U shows an exemplary Show-reel Comment Edit form.

FIG. 18V shows an exemplary Service page.

FIG. 18W shows an exemplary Edit and Delete Services form.

FIG. 18X shows an exemplary Email Template.

FIG. 18Y shows an exemplary Add Email Template.

FIG. 18Z shows an exemplary Search History page.

FIG. 18AA shows an exemplary Background Images page for storing uploaded Background Images.

FIG. 18AB shows an exemplary Edit Background Image form for adding and deleting Background Images.

FIG. 18AC is an exemplary Key Skills page.

FIG. 18AD shows an exemplary Edit Key Skills form.

FIG. 18AE shows an exemplary Sections page.

FIG. 18AF shows an exemplary Section Modules page.

FIG. 18AG shows an exemplary Admin Feature diagram that illustrates an exemplary collection of features of the Admin Panel.

FIG. 19A shows an exemplary Terms and Conditions page.

FIG. 19B shows an exemplary Help page.

FIG. 19C shows an exemplary Compatible Browser page.

FIG. 20A shows an exemplary Log bank -News Section.

FIG. 20B shows an exemplary News Count page that shows the News Title, News Date, and News Author.

FIG. 20C shows an exemplary New Advice or Comment Count page.

FIG. 20D shows an exemplary Hate Bar.

FIG. 20E shows an exemplary News Love Bar.

FIG. 20F shows an exemplary Blog section.

FIG. 20G shows an exemplary Photos section.

FIG. 20H shows an exemplary Shared Photos bar of the Photos section.

FIG. 20I shows an exemplary Love Bar of the Photos section,

FIG. 20J shows an exemplary Show-reel Section of the Log Bank.

FIG. 20K shows an exemplary All Section of the Log Bank.

FIG. 21 is a block diagram illustrating an example machine representing the computer systemization of the online management portal 101 as a controller 2100.

### DETAILED DESCRIPTION

Filmmaking involves a number of discrete stages including an initial story, idea, or plot, through scriptwriting, casting, shooting, editing, and screening the finished product before an audience that may result in a film release and exhibition. Filmmaking takes place in several countries around the world in a range of economic, social, and political contexts, and using a variety of technologies, equipment and cinematic techniques. Typically, filmmaking involves a large number of technicians, artists & crew. This process can take from a few months to several years to complete. The disclosed technology provides for a system or a portal that basically focuses on connecting Media talents in the entertainment and multimedia industry where a variety of online and offline activities are carried out. The disclosed system or portal can provide users with direct access to talented professionals in the multimedia industry who can truly make a difference in the Process of making Movies. Here each user is associated with their expertise and services (Actors, Directors, Singers, writers etc.) by which they can be searched and contacted by other users in need of their services. Overall this portal is a unique idea that can generate ample of opportunity for the users within media and entertainment industry.

Film production involves several major stages:

Development—The first stage in which the ideas for the film are created, rights to books/plays are bought etc., and the screenplay are written. Financing for the project has to be sought and green lit.

Pre-production—Preparations are made for the shoot in which cast and film crew are hired, locations are selected, and sets are built.

Production—The raw elements for the film are recorded during the film shoot.

Post-production—The images, sound, and visual effects of the recorded film are edited.

Distribution—The finished film is distributed and screened in cinemas and/or released on Home entertainment.

Development:

In this stage, the project's producer selects a story. Its source could be from a book or a play or another film or a true story or an original idea, etc. After identifying a theme or underlying message, the producer works with writers to prepare a synopsis. Next they produce a step outline, which breaks the story down into one-paragraph scenes that concentrate on dramatic structure. Then, they prepare a 25-to-30-page description of the story, its mood, and characters. This usually has little dialogue and stage direction, but often contains drawings that help visualize key points. Another way is to produce a scriptment once a synopsis is produced.

Next, a screenwriter writes a screenplay over a period of several months. The screenwriter may rewrite it several times to improve dramatization, clarity, structure, characters, dialogue, and overall style. However, producers often skip the previous steps and develop submitted screenplays which investors, studios, and other interested parties assess through a process called script coverage. A film distributor may be contacted at an early stage to assess the likely market and potential financial success of the film. Hollywood distributors adopt a hard-headed business approach and consider factors such as the film genre, the target audience, the historical success of similar films, the actors who might appear in the film, and its potential directors. All these factors imply a certain appeal of the film to a possible audience. Not all films make a profit from the domestic theatrical release alone, so film companies take the satellite, DVD sales and worldwide distribution rights into account.

The producer and screenwriter prepare a film pitch, or treatment, and present it to potential financiers. If the pitch is successful, the film receives a “green light”, meaning someone offers financial backing: typically a major film studio, film council, or independent investor. The parties involved negotiate a deal and sign contracts. Once all parties have met and the deal has been inked, the film may proceed into the pre-production period. By this stage, the film normally has a clearly defined marketing strategy and target audience.

Pre-Production:

During the pre-production phase, every step of actually creating the film is carefully designed and planned. The production company is created and a production office is established. The film is pre-visualized by the director and may be storyboarded with the help of illustrators and concept artists. A production budget is drawn up to plan expenditures for the film. Most often, insurance is bought to protect against all associated risks.

The producer hires a crew. The nature of the film and the budget determine the size and type of crew used during filmmaking Many Hollywood blockbusters employ a cast and crew of hundreds, while a low-budget, independent film may be made by a skeleton crew of eight or nine (or fewer).

Typical Crew Positions are listed below:

Storyboard Artist: creates visual images to help the director and production designer communicate their ideas to the production team.

Director: is primarily responsible for the storytelling, creative decisions and acting of the film.

Assistant Director (AD): manages the shooting schedule and logistics of the production, among other tasks. There are several types of AD, each with different responsibilities.

Unit Production Manager: manages the production budget and production schedule. They also report, on behalf of the production office, to the studio executives or financiers of the film.

Location Manager: finds and manages film locations. Nearly all pictures feature segments that are shot in the controllable environment of a studio sound stage, outdoor sequences call for filming on location.

Production Designer: creates the visual conception of the film, working with the art director.

Art Director: manages the art department, which makes production sets.

Costume Designer: creates the clothing for the characters in the film working closely with the actors, as well as other departments.

Makeup and Hair Designer: works closely with the costume designer in addition to create a certain look for a character.

Casting Director: finds actors to fill the parts in the script. This normally requires that actors audition.

Choreographer: creates and coordinates the movement and dance—typically for musicals. Some films also credit a fight choreographer.

Director of Photography (DOP): is the cinematographer who supervises the photography of the entire film.

Director of Audiography (DA): is the audiographer who supervises the audiography of the entire film. For productions in the Western world this role is also known as either sound designer or supervising sound editor.

Production Sound Mixer: is the head of the sound department during the production stage of filmmaking They record and mix the audio on set—dialogue, presence and sound effects in mono and ambience in stereo. They work with the boom operator, Director, DOA, DOP, and First AD.

Sound Designer: creates the aural conception of the film, working with the supervising sound editor. On some productions the sound designer plays the role of a director of audiography.

Composer: Creates new music for the film. (Usually not until post-production.)

Production:

During the production phase the content is created and shot. More crew will be recruited at this stage. Example: Property master, script supervisor, assistant directors, stills photographer, picture editor and sound editors. These are just the most common roles in filmmaking The production office is free to create any unique blend of roles to suit the various responsibilities possible during the production of a film.

For the production phase on live-action films, synchronizing work schedules of key cast and crew members is very important, since for many scenes, several cast members and most of the crew must be physically present at the same place at the same time (and bankable stars may need to rush from one project to another). Animated films have different workflow at the production phase, in that voice talent can record their takes in the recording studio at different times and may not see one another until the film's premiere, while most physical live-action tasks are either unnecessary or are simulated by various types of animators. We conclude that each genre of films have a different method of production in every respect.

Post-Production:

The video/film is assembled by the video/film editor. The shot film material is edited. The production sound (dialogue) is also edited; music tracks and songs are composed and recorded if a film is sought to have a score; sound effects are designed and recorded. Any computer-graphic visual effects are digitally added. Finally, all sound elements are mixed into “stems”, which are then married to picture, and the film is fully completed (“locked”).

Distribution:

This is the final stage, where the film is released to cinemas or, occasionally, directly to consumer media (DVD, VCD, VHS, Blu-ray) or direct download from a provider. The film is duplicated as required (either onto reels or hard disk drives) and distributed to cinemas for exhibition (screening). Press kits, posters, and other advertising materials are published, and the film is advertised and promoted. A B-roll clip may be released to the press based on raw footage shot for a “making of” documentary, which may include making-of clips as well as on-set interviews.

Since the advent of home video in the 1970s, most major films have followed a pattern of having several distinct distribution windows. A film also penetrates in different market segments like rental, retail, pay-per-view, in-flight entertainment, cable, satellite, and/or free-to-air broadcast television. The distribution rights for the film are also usually sold for worldwide distribution. The distributor and the production company share profits per the agreed term or may have a customized business model between them.

Current Gaps in the Dynamic World of Content Creation:

Whichever way you look at it, filmmaking is a very complex process. First there is the idea, then writing the script, then the financing, picking the right casting, crew, prep, equipment's, technology, expertise, shoot, post production, the list seems to go on forever. Let alone the new aspiring film makers, even experienced professionals struggle to understand how all the various parts of the filmmaking process fit together. Even if the process is kind of known to some individuals, finding the right talent at a price that will make the project commercially viable is the biggest challenge faced by all industry personnel.

The entire world is a common ground for creative ideas & good content. A good story or script written or told in a particular country in one language is most likely true for other countries using different languages as well. With the current infrastructure the industry cannot leverage on a global platform because there is no such common field ever created where the industry can have access to all the information & talent that it requires. This shunts the growth for real talented & creative individuals who can get a lot more financial benefit if their work is offered on a larger platform covering different countries around the world. The advantages in creating such a platform is mind boggling & cannot even be thought of very similar to when the world transformed to the internet revolution.

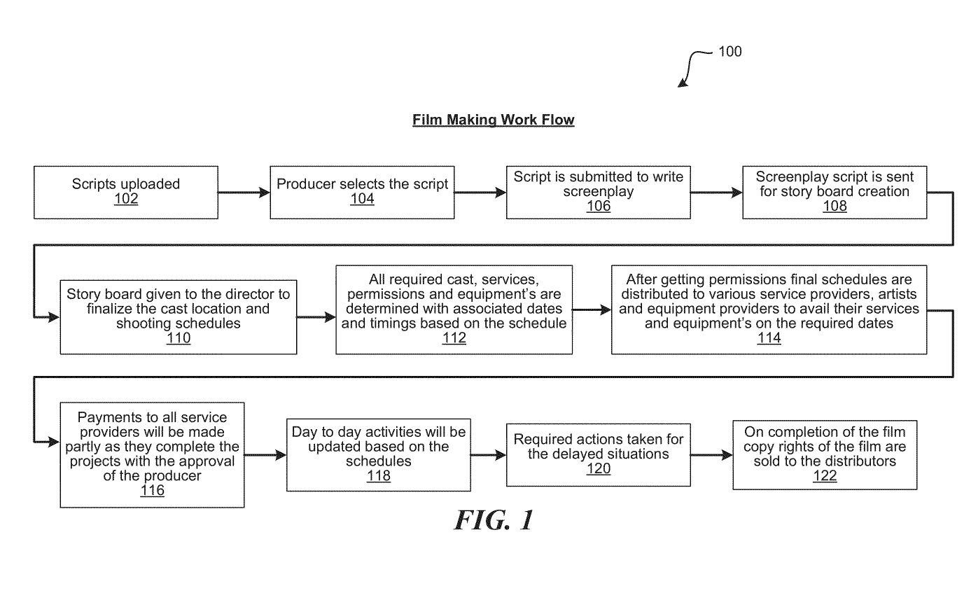

FIG. 1 is a block diagram illustrating an example work flow process 100 of film production followed worldwide. The process 100 includes an online portal for receiving scripts uploaded by various writers (102) as disclosed in this patent document. The system enables a producer to select a script from the received scripted (104). The system enables the selected script to be submitted to write a screenplay (106). The system enables the screen play script to be given for creating a story board (108). The system enables the story board to be sent to a director to finalize the case location and shooting schedules, for example (110). The system enables for the determination of all required cast, services, permissions, and equipment with associated dates and timings based on the shooting schedule (112). The system enables for the distribution of final schedule, after obtaining the necessary permissions, to various service providers, artists, and equipment providers to avail their services and equipment on the required dates (114). The system enables for the payments to be made to all service providers according to the agreement, for example, in parts as the service providers complete their services, and with the approval of the produce as needed (116). The system enables for a process for updating day to day activities based on the final schedule (118). The system enables for any required actions to be taken to address any delayed situations (120). The system enables for the sale of the copy rights of the completed film to the distributors upon completion of the film (122).

Thousands of feature films, documentaries & short films are made across the world year after year. Yet, if you ask film makers, they are always struggling to put together all the pieces of the puzzle in order to finally see their dream come true on the big screen. Talent & creative people are somehow always hard to find and that too at a price that fits the requirements of the project. Most budding film makers don't even have access to all the verticals that are required to make a film & often get short changed even though they may have had outstanding ideas or screenplays.

The disclosed system is the first global online portal to provide end to end solution for all film makers across the world irrespective of their country or the language in which they would like to make their film. From script writers to directors to technicians, every vertical that is required to make a film are listed in a separate category and validated/authenticated by the system. Each listed entity is given its own identity in several ways. This will act as a copyright shield, ensure that each one gets its due credit & most importantly create a global exchange platform for all potential film makers around the world. One could potentially buy scripts that are listed in a particular language & then end up using that screen play to make a film in a completely different language or hire a director of your choice from the U.S. but use his services to make a Bollywood blockbuster in India or even approach a private equity funder to finance your potential film project. The services of each listed entity along with all commercial terms & availability of their schedules will be posted & updated on their homepage. A producer could pick his desired actors, crew, directors & stuntmen for his next film at the click of a mouse if he wants to pay their listed price or woo them with a counter offer price by sharing the details of his project. Basically right from screenplay to the sets to marketing, everything can be arranged from the comfort of one's home/office. Each listed entity will be defined in categories depending on its rating arrived at via a logical process. The portal can by default become an auction and a reverse auction platform for all film making services across the globe.

The Portal

In one aspect, disclosed is a global online portal which provides an end-to-end solution for film makers across the world irrespective of their country or language. From writers to directors to technicians, every vertical that is required to make a film is listed in a separate category and validated/authenticated by the portal. Each listed entity is defined in categories depending on its rating arrived at via a logical process. The services of each listed entity along with commercial terms & availability of their schedules are posted on their homepages. The portal manages intellectual property issues and creates a global exchange platform for all potential film makers around the world. It enables one to buy scripts listed in one language and use them to make a film in a different language. It also allows a producer to pick his desired actors and crew members for his next film at the click of a mouse.

The disclosed system or portal for uniting professionals in the multimedia, entertainment, and film industries can provide a number of unique features to facilitate the users to directly access talented professionals in the multimedia, entertainment, and film industry. Each registered user of the portal is associated with his expertise and services, such as Actors, Directors, Singers, writers etc. by which they can be searched and contacted by other users in need of their services.

The disclosed portal focuses on entertainment industries with two essential modules Profile management & Friends organization. Profile management module maintain the Profile pic, Name, Role, Experience, show-reels, Photos, Blogs, News, Skill sets. Friends Organization module maintains the friend list, handles request and sends request to the other user. Profiles and Friends lists are two main features on social network sites. Friend's organization module increases friend's network as in personal or in professional terms. Third is public communication & commenting feature. Users can comment and like or dislike on Blog, News, shared Photos & Videos. These comments are displayed prominently and visible for anyone who has access to that profile. Just like in real life, the connections between people aren't just one-on-one, it is network of connections.

The disclosed portal is a social network that is very useful in spreading information through blogs, news, pictures and videos. So a user can keep the update related to the user's film industry and provide the user's feedback. For example, a user can easily set up a web page with personal details and pictures and short show-reels which can be shared by the users. In short, this portal allows you to show creativity to other users & get globally connected to your own sector.

The disclosed technology can provide a social networking portal to provide a well-established web-based social networking system for professionals working in the entertainment industry. This patent documents a networking system scope, functionalities, requirements and feasibility.

The social networking website or portal is an online community designed to make a user's social & professional life more active and stimulating. The social network can help the user to keep up with the user's professional life and friends by sharing photos, updates & messages and establish new connection by reaching out people you never met before.

The disclosed portal also provides the features of blogging all at one place. The blogging feature allows the user to share thoughts or ideas with all of the user's friends or selected users of the website. The user either can chase or share the blogs.

The portal also provides the user with a news section which is auto generated on daily basis or else users can also provide news from his end and at the same time can share with concern person from news page itself.

The disclosed portal can enhance job opportunity within the film industry related to a user's skillsets & experiences. They come across with different people who are related to this industry and get in touch with them.

One of the most fascinating shifts in our history is the democratization of communication and content creation. Anyone with a smartphone can make a video and capture just as many views as a blockbuster film, its trailers and ads combined and with little to no budget. Social Networking has opened up communication, allowing rich media to be distributed across multiple global networks and connect millions with similar interests.

Social network sites can be defined as web-based services that allow individuals to construct a public or semi-public profile within a bounded system, articulate a list of other users with whom they share a connection, and view and traverse their list of connections and those made by others within the system. The nature and nomenclature of these connections may vary from site to site. The disclosed portal is focused on providing a social networking site for the entertainment industry to bring together users from different professional domains related to the entertainment industry.

The disclosed frame work for the portal is focused on the entertainment industries. Users can register their profile as per their services provided to the entertainment industries. Users can connect to people in the entertainment industries globally. Users are provided with online communication as the Communication is lifeblood of any networking sites. Users can place their blogs and chase others blog with like-hate or comment options associated with the blogs. Users can upload unlimited photos/show-reels and which can be shared accordingly.

The disclosed portal is a social networking site or portal, which initiates to bring people from different parts of world under one umbrella. The disclosed portal focuses on entertainment industries where millions of people can keep up with their friends by their blogs, news, photos and their show-reels. They can upload and share unlimited photos, show-reels and blogs which help other to know them better. This in turn increases the reachability within industry.

The disclosed framework of the portal provides to the users a platform were they can showcase their skills which in turn help them to promote themselves for the opportunities within different entertainment (e.g., film) industries. The disclosed portal helps users to get involved in networking, run for opportunities and provide them with direct access to the directors, producers, agents, and so on.

Portal Features

Examples of the features of the system or portal include Search, Blog, News, Chase, Un-Chase, Sharing, Rating Service Provider, Log, Offline Chat, Log History, and Hate. The Search feature in the portal displays (responsive to a search for service, product, or user), user details on a global map indicating the user details and the location where the requested services or products are provided. The Blog features allow the registered user of the portal to post his blogs with various options to upload images (photos), videos (e.g., YouTube videos), etc. that are linked with his posted blog. Using the blog, the user can share expert advises, knowledge, and information with other users (e.g., in the same interest and category, such as Actors). The News features allows the user or the admin of the portal to post latest relevant industry news and share the news with other users. The portal can filter the posted news to present the posted News to appropriate user groups on the portal automatically. The Chase features allows a user to obtain all posts (news, blogs, photos, show-reels, etc.) from an expert in a user group (of a particular interest or category, such as Actors) in real time and automatically so as to share the wisdom of the users in the same category or professional domain, such as Actors. The Un-Chase feature allows the user to stop automatically displaying the posts of a user who has been un-chased.

The Sharing features provides a user with sharing options where the user can share his content or already shared content with other users and groups. Sharing can be performed in various ways publicly, with friends, and with selected service categories. For example, content shared publicly can be viewed by all including all users of the portal. Content shared with selected friends will be viewable by those selected friends only. Content shared with selected service or product categories can be viewed by the users from the selected service or product categories (i.e., selected professional domain). The Rating Service Provider feature provides a rating option to the user where the user can rate the service or product providers based on the user's experience with the service or product providers. The user rating and comments given to a particular service or product provider can be viewed by other users. The user rating and comments can help other users to find the superlative talent in a specific professional domain, category, etc. The Log feature provides for the updates to the user's profile to be logged in log bank section of the portal. Any updates performed on various sections including the following are logged on the log section: (1) News (any update in terms of love/hate or advice on newly posted or followed news); (2) Blog (any update in terms of love/hate or advice on newly posted or chased blogs); (3) Photos & show reel (video's)(any update in terms of love/hate or advice on shared photos & show reels); and (4) Page visited by the users is provided in pie chart.

The Offline Chat feature provides the user with an option to set his status as offline even when the user is online. Using the Offline Chat feature option, the user can chat with known or unknown users without acknowledging or allowing them to know about the user's online or offline status. The Log History feature in the portal provides the log history of all the activities on the user's profile as a notification count. Some examples of the activities that are logged into log history include: (1) Friend request, (2) Sharing, (3) Advice, (4) Love, (5) Hate, (6) Photos uploaded, (7) Show reel uploaded, and (8) Blog upload. The Hate feature in the portal provides a hate option where the user can show his rage or dislike for any uploaded post.

Registration Process

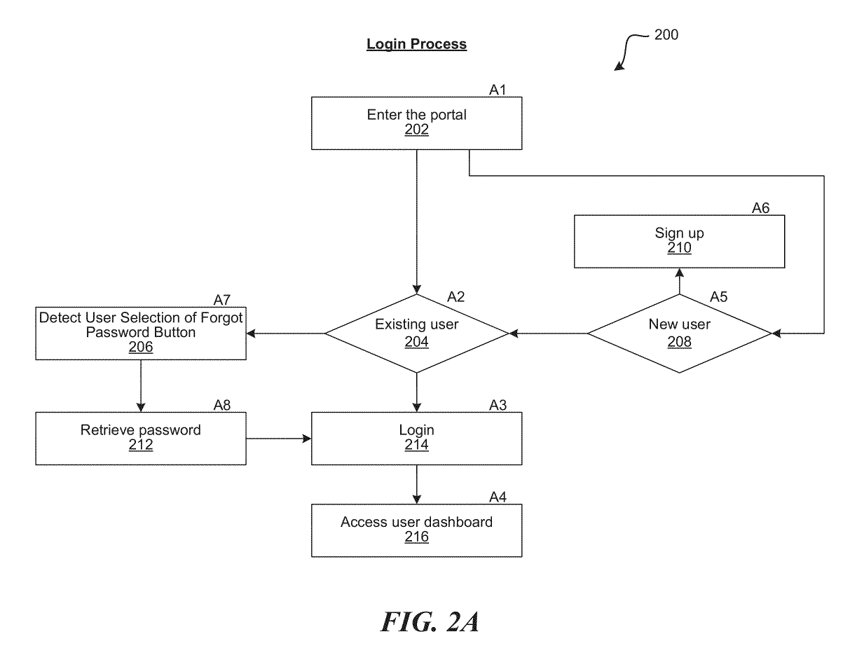

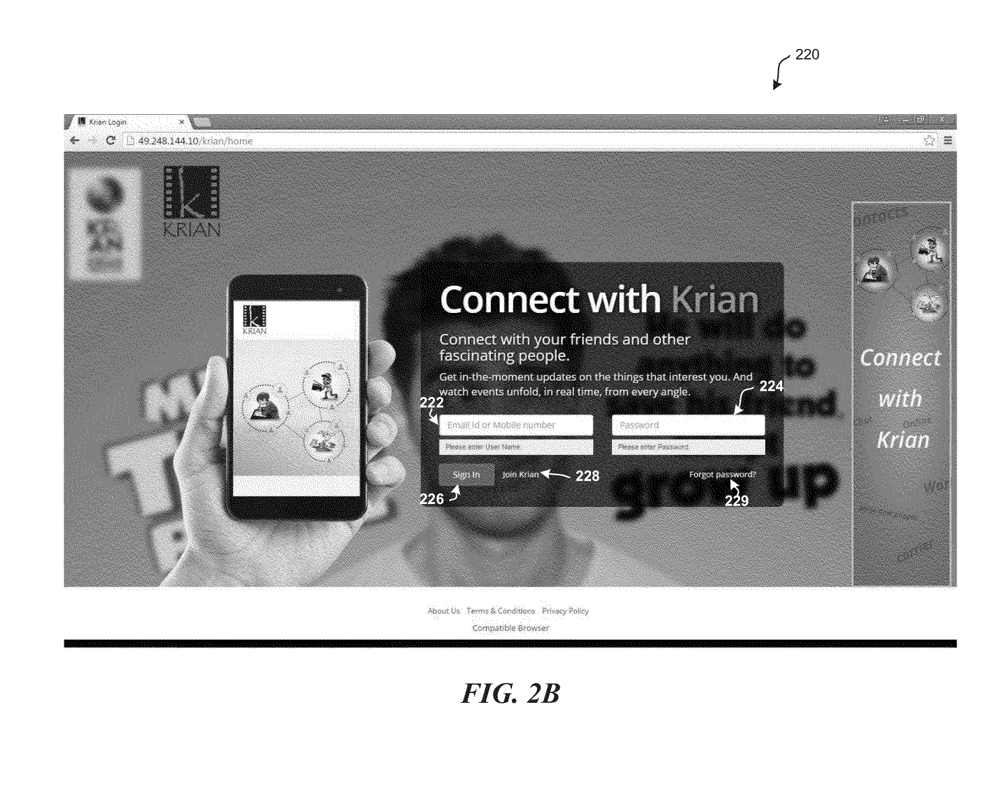

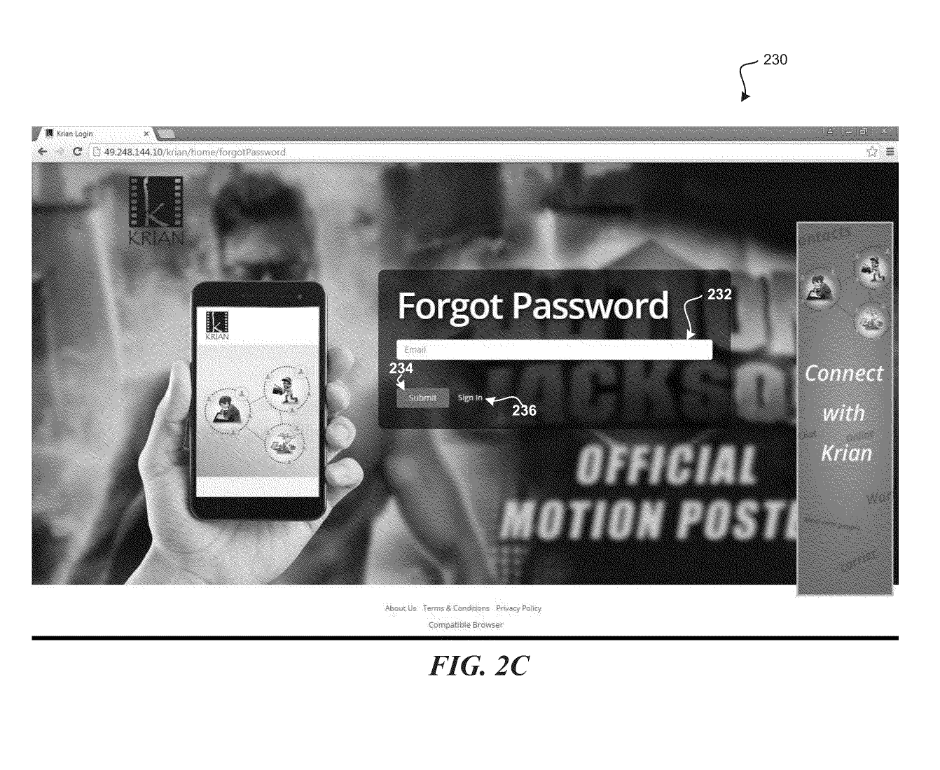

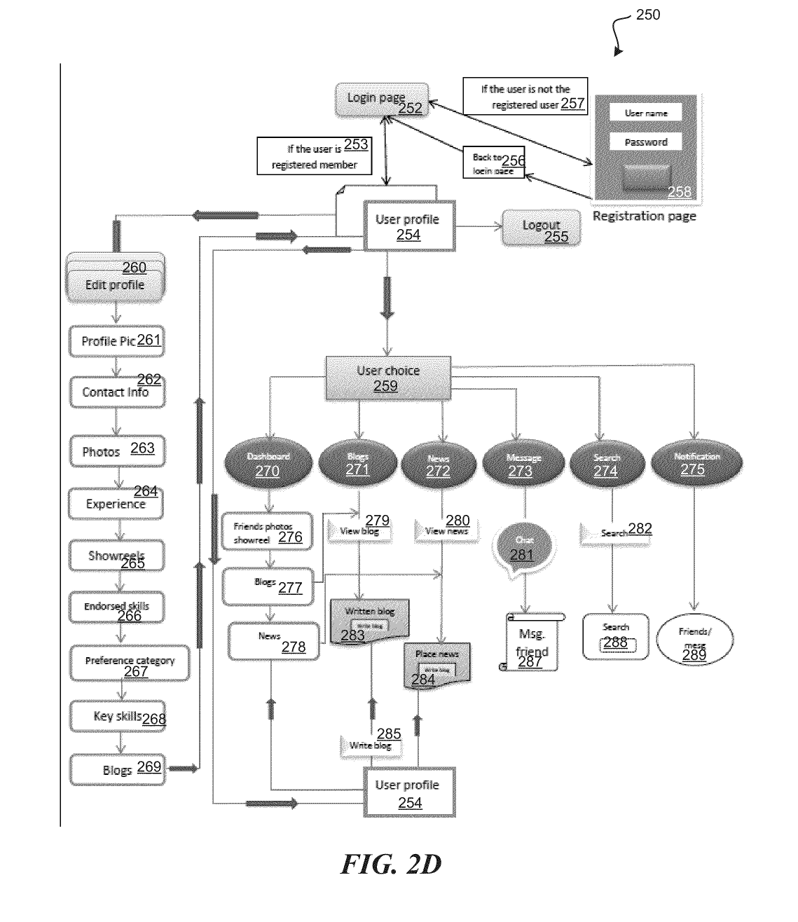

Every user can Login to the portal with a valid Username and Password. FIG. 2A is a diagram illustrating an example login process 200. FIG. 2B is an exemplary login screen 220. When a user accesses the portal it will ask for the login credentials. If the user is a registered user he/she can login to the portal using their username and the password. If the user is unregistered they can Sign up by filling a registration form. The process 200 includes the system detecting a request to enter the portal (202). For example, the system may receive a request from a user attempting to login through a login screen 220, such as the exemplary login screen shown in FIG. 2B. This can include receiving from the user, a User ID or Username through a User ID window 222 and a Password through a Password window 224. In some implementations, user can use his mobile phone number in place of User Id to login to the portal. The system also detects when the user selects the Sign In button 226 after inputting the User ID and Password. Alternatively, the system can detect the user selecting the Join button 228 to initiate a registration process as a new user. Based on the user input received, the system can determine whether the user is an existing user or a new user (204). When the system detects a user selection of the Forgot Password button 229 (206), the system initiates retrieval of the user's password (212). When the system determines that the user is an existing user and the correct user credentials (i.e., User ID and Password) have been received, the user is allowed to login (214) and enables the user to access his user dashboard (216). When the user is determined to be a new user (208), which could be due to the detection of user selection of the Join button 228, the system enables the user to Sign Up and join the portal (210). Once the user has been signed up, the user is directed to the Sign In or Login screen 220 (202) to login to the portal.

The system provides for, e.g., through the Login screen 220, error reporting based on the errors detected. For example, when the system determines that the received User ID, Password, or both are wrong, the system can provide an appropriate error message, such as “Please Enter a Valid User ID and Password.” When the system detects that the User ID,

Password, or both are missing (i.e., detects user selection of the Sign In button 256 without the User ID, Password, or both entered into the corresponding windows 222 and 224), the system can display an error message, such as (1) “User ID is missing. Please enter a Valid User ID”, (2) “Password is missing. Please enter a Valid Password”, or (3) “User ID and Password are missing. Please enter a Valid User ID and Password.”

FIG. 2C is an exemplary Forgot Password screen 230. When an existing user forgets his password, the user can select the forgot password screen 230 or page to provide information for retrieving the forgotten password. For example, the Forgot Password screen 230 can include an input window 232 for the user to input the User ID or Email address. When the system detect the user selection of the Submit button 234, the system can send a temporary password to the user's registered email address if the email address entered through the window 232 matches the stored email address associated with the user. After retrieving and sending the password to the user's email address, the system can direct the user to the login screen 220 of FIG. 2B to enable the user to logon to the portal. However, immediately after the login portal will ask the user to change the password.

FIG. 2D is a process flow diagram of another exemplary login process 250. Process 250 includes receiving a request to login to the portal at the login page (252). When the portal determines that the user is not a registered user (257), the user is directed to the registration page (258). Once registered, the user is directed back to the login page (256). When determined that the user is a registered user (253), the user is directed to the user's profile page (254) responsive to a successful login (portal validates username and password). The user can opt to logout at any time (255). When receiving a request to edit the profile page, the user is directed to the edit profile page and relevant forms (260). At the Edit profile page, the user can edit a number of things including: Edit Profile picture (261); Edit Contact Information (262); Edit Photos (263); Edit Experience (264); Edit Show-reels (265); Edit Endorsed Skills (266); Edit Preference category (267); Edit Key skills (268); and Edit Blogs (269). Editing any of the contents and information at the Edit Profile page can include adding, deleting and modifying.

Once logged in, the user can make a select to be navigated to any one of the user selected choices (259). The available User Choices can include: Dashboard (270); Blogs (271); News (272); Message (273); Search (274); and Notification (275). When the user selection of the Dashboard is received (270), the user is provided access to Friends Photos and Show-reels (276); Blogs (277); and News (278). When the user selection of the Blogs (271) is received, the user is allowed to view the blog (279) and write to the blog (283). The user can also view the blog from the blogs accessed under the Dashboard. When the user selection of the News is received (272), the user is provided with an option to view the news (280) or place the news (284). Also, the user is allowed to place the news from the news that the user accessed through the Dashboard. When the user selection of the Message is received (273), the user is directed to the chat page 281, where the user can compose and send messages to other users (287). When the user selection of the Search is received (274), the user is directed to the search page (282). The search page allows the user to submit a request to search for a service, product, user, etc. (288). When the user selection of the Notification is received (275), the user is directed to the Message page (289) to allow the user to view the messages. In addition, the user can write to his blog from the user profile page 254.

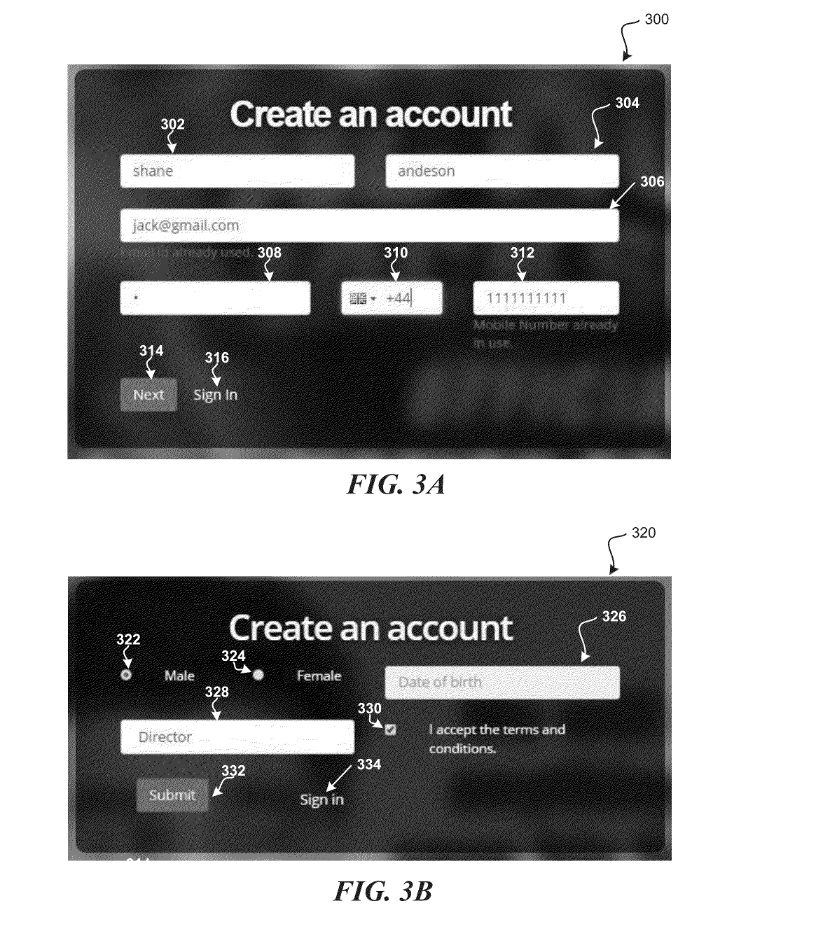

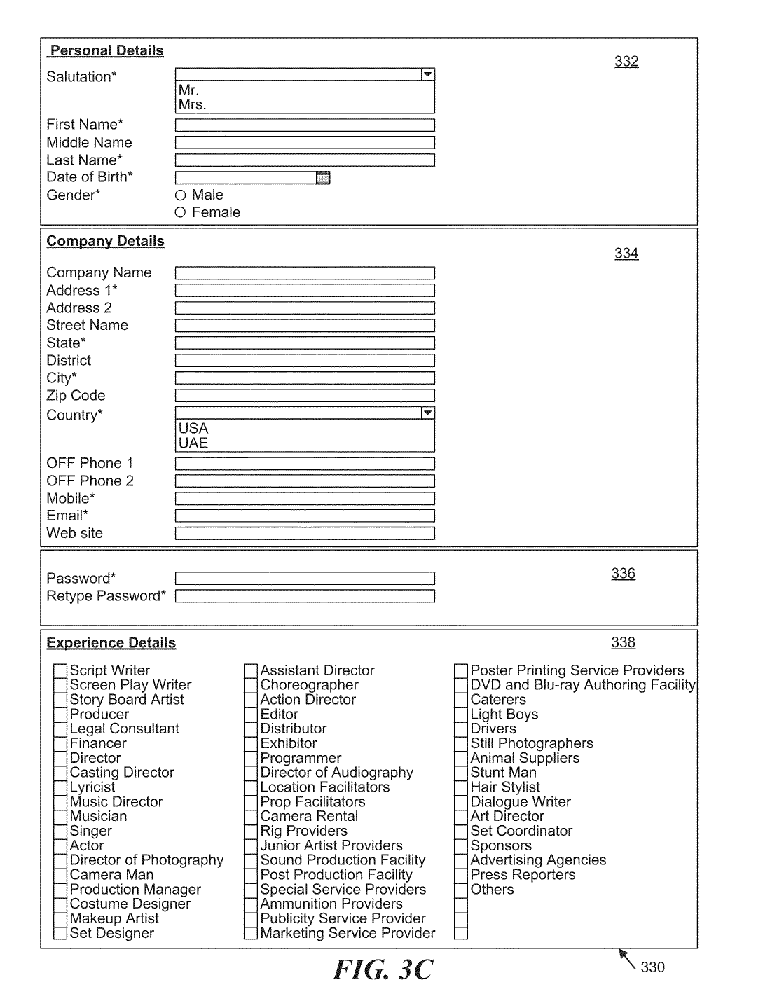

FIGS. 3A and 3B are exemplary Create An Account screens 300 and 320 for directing a user to create an account. Users can register for the system account by providing their detailed information. They will then be asked to upload photos, video or show reels, provide a category under which they want to be listed as well as a description of their expertise with their Industry experience. However this is not mandatory for every registered user. To create a User's account the screens 300 and 310 provide a list of fields for receiving user information including First Name Field 302, Last Name Field 304, Email Address Field 306, Password Field 308, Country Code Field 310, Phone Number Field 312, Gender Fields 322 and 324, User's Title Field 328, Date of Birth Field 326, and Terms Acceptance Field 330. When the system detects that the user selected (e.g., by clicking on the Join button or link 228 in FIG. 2B), the system directs the user to the registration screens or pages 300 and 320.

To enhance the validation of the registered user, any or all of the fields in FIGS. 3A and 3B can be made mandatory. A user is not allowed to register under an Email ID or User ID that is associated with an existent user. Validity of the phone number & country code are verified by the system. Screen 300 can include a Next button 314 to allow the user to navigate to the next screen 320 to enter additional information. The next screen 320 can include the Date of Birth Field 326, which is also validated to be a valid date up to the current date. The user must check the Terms Acceptance Field button 330 to accept the terms and conditions of the portal. Screen 320 includes a submit button 332 to allow the user to submit the information entered in the screens 300 and 320. The screen 320 can include a Sign In button 334 to allow the user to login to the portal. In some implementations, the screens 300 and 320 can be combined into a single screen or page.

The system also provides for error message reporting with the registration screens 300 and 320: If valid conditions are not satisfied for a Field, a corresponding error message is displayed for that Field and could include a visual emphasis of the error. For example, the error can be visually emphasized by using a font color, such as red. Examples of the Email ID Error message can include “Email Id is not valid!” or “Email id already used.” Examples of the Mobile Number verification & validation Error message can include “Mobile Number already in use” or “10 digits required”.

The system also includes a Verification mail process. Once the registration is complete, an email is send to the user's registered email id for verification. User can confirm the email address by opening a link in the mail sent when the user sign up and registered with the portal. Confirming the email address or the phone number provides verification to the system that the system is sending user account details to the correct email address and the correct user.

FIG. 3C is a diagram illustrating an example Registration Form 330 where the user can provide various user information as a part of the signing up process. The registration form 330 can include a personal details section 332, a company details section 334, a password section 336, and an experience details section 338. The registration form 330 can include any one or a combination of the different sections 332, 334, 336, and 338. The registration form 330 can also include additional sections not shown in FIG. 3C to allow the user to share various information about the user including the user's Industrial experience.

Once the login process is successful, the user is presented with the user's deck or profile page where the user can edit the user's profile and update it as desired for the user to access the user's latest information with the most recent work profile attached to the user's credit. Each user can subscribe to the forums on the portal with the objective being mainly to discuss each user's experiences and update any new technology, for example.

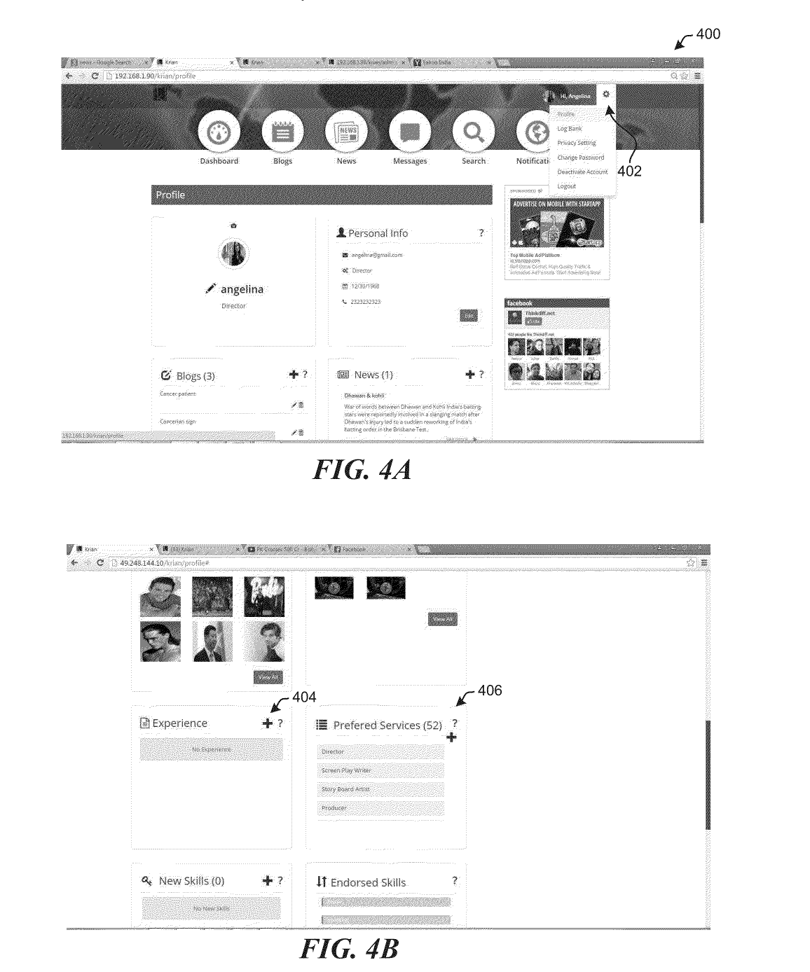

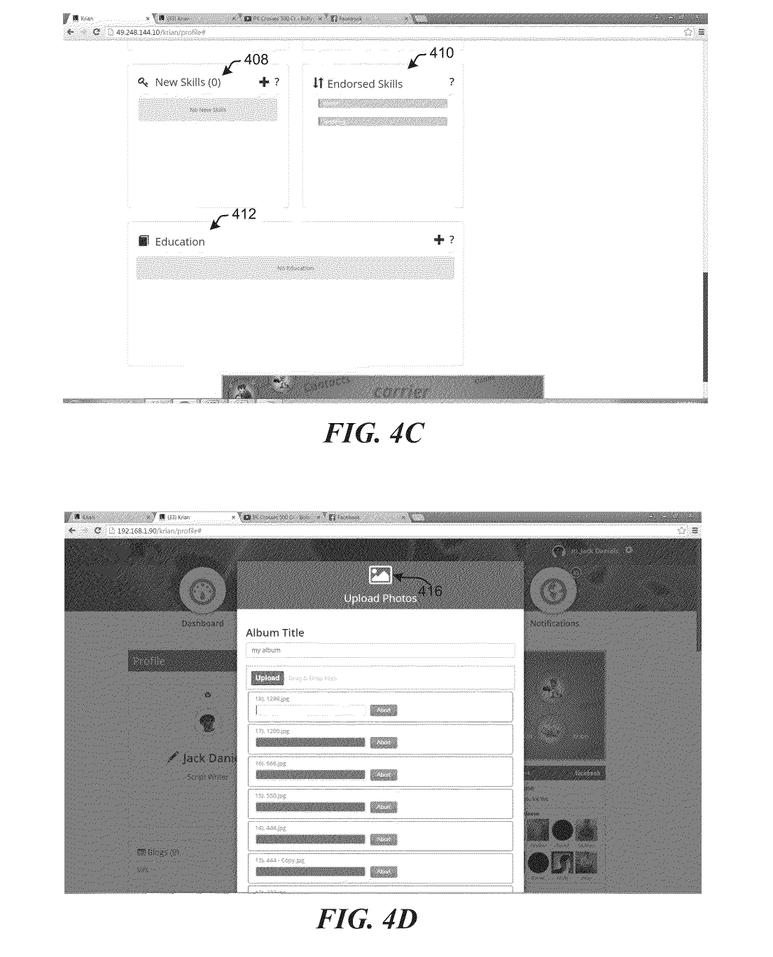

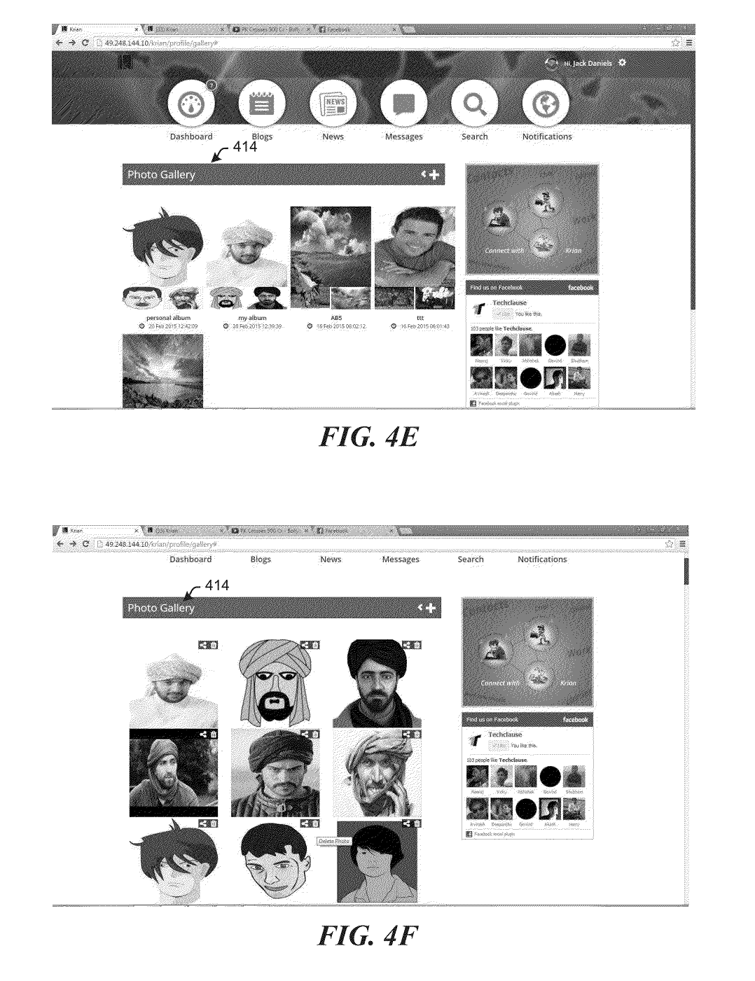

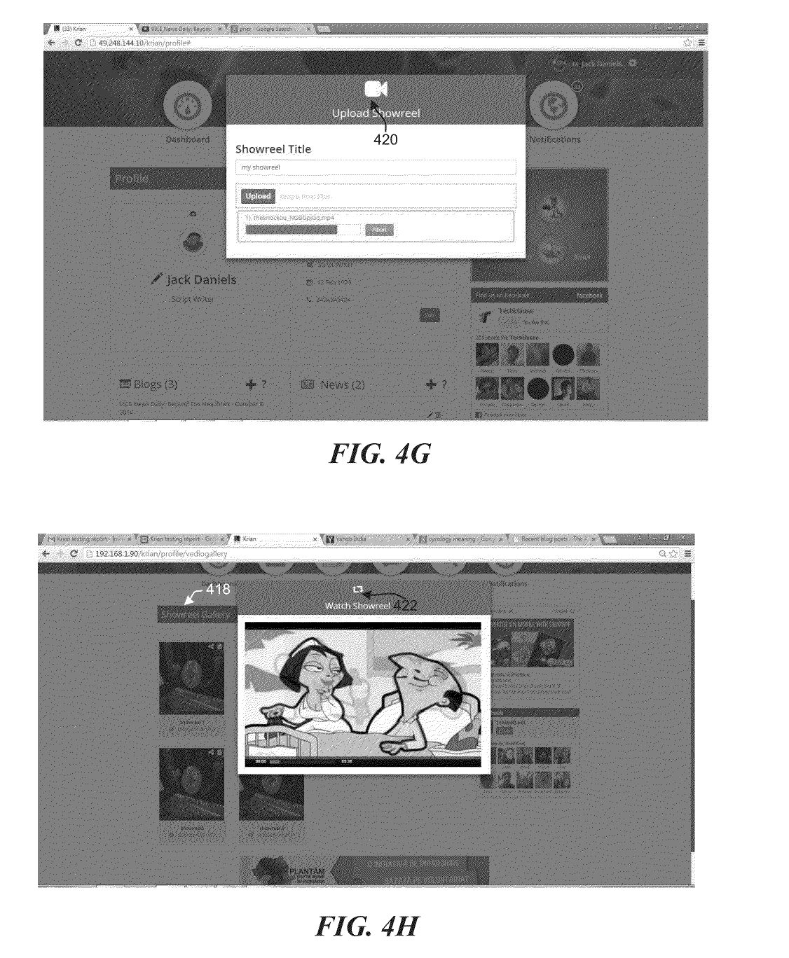

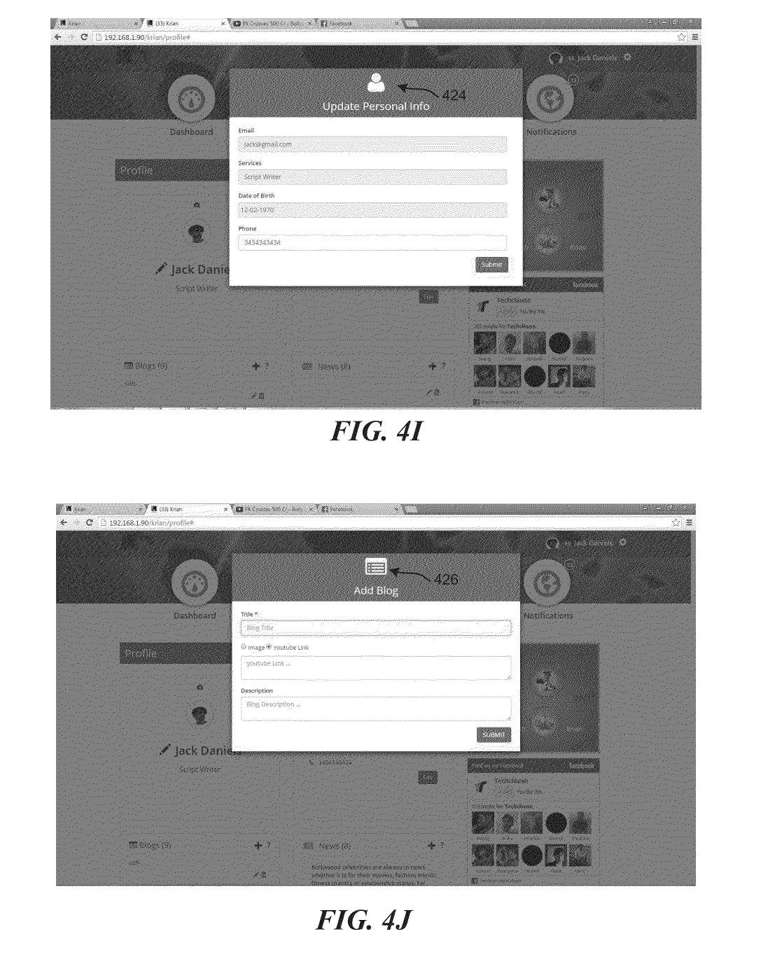

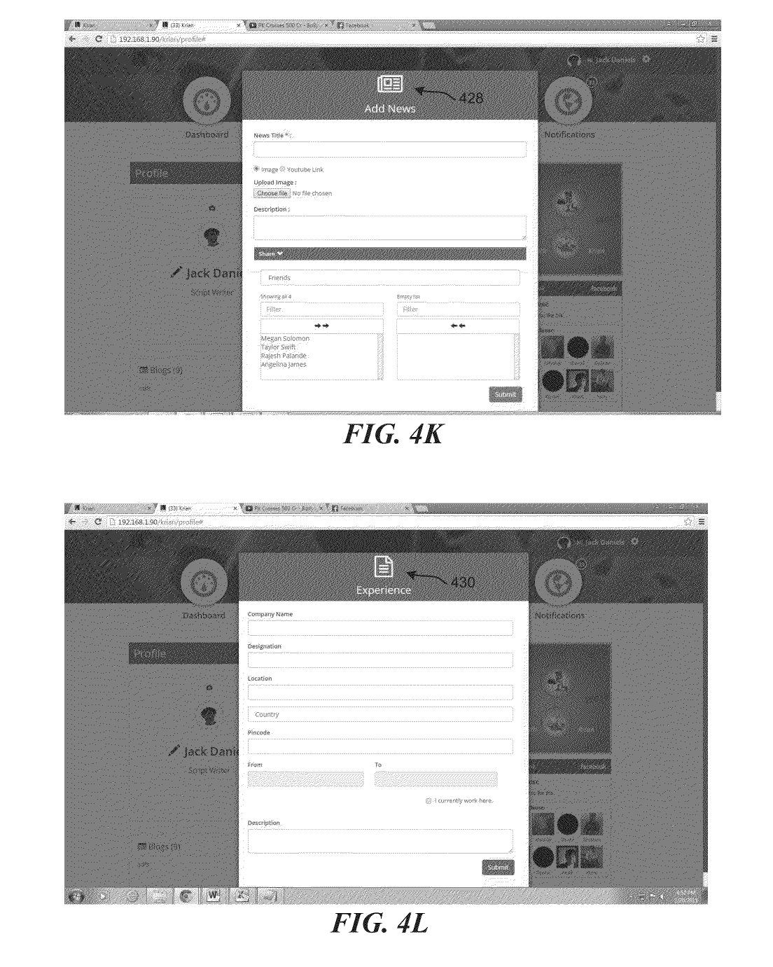

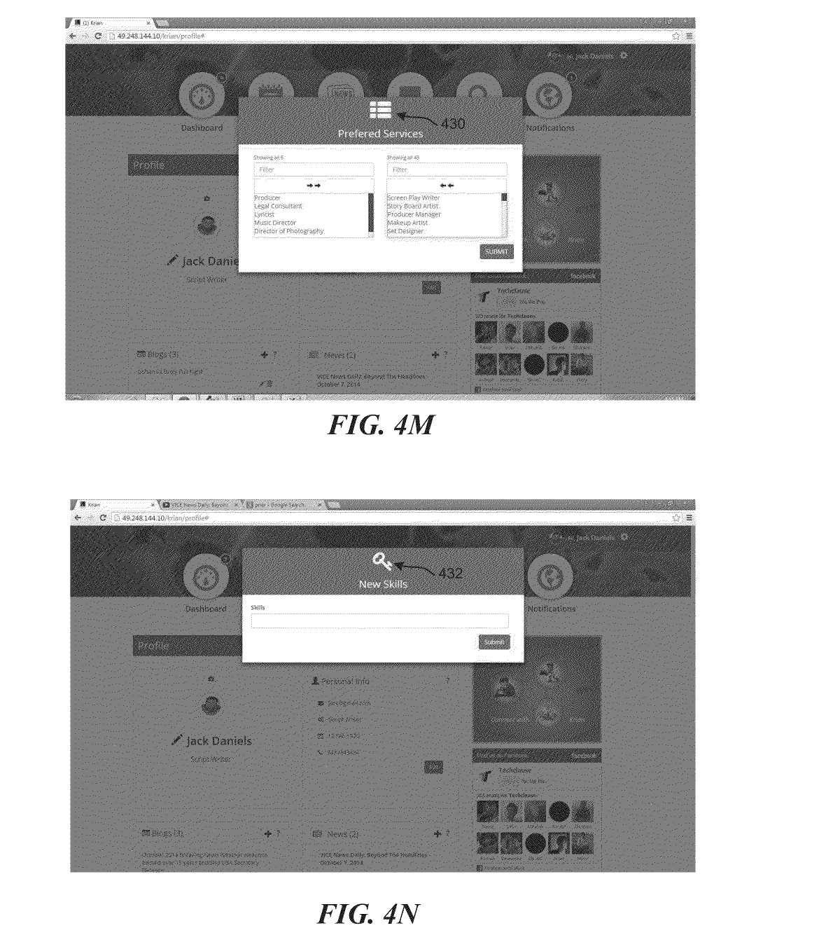

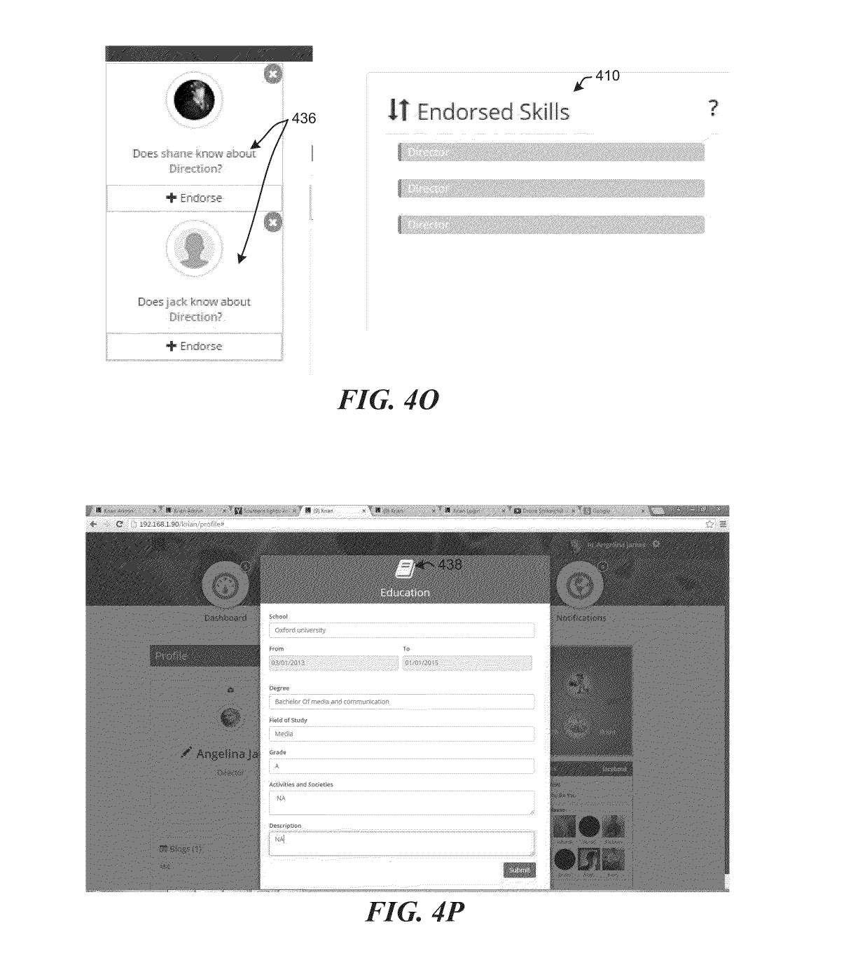

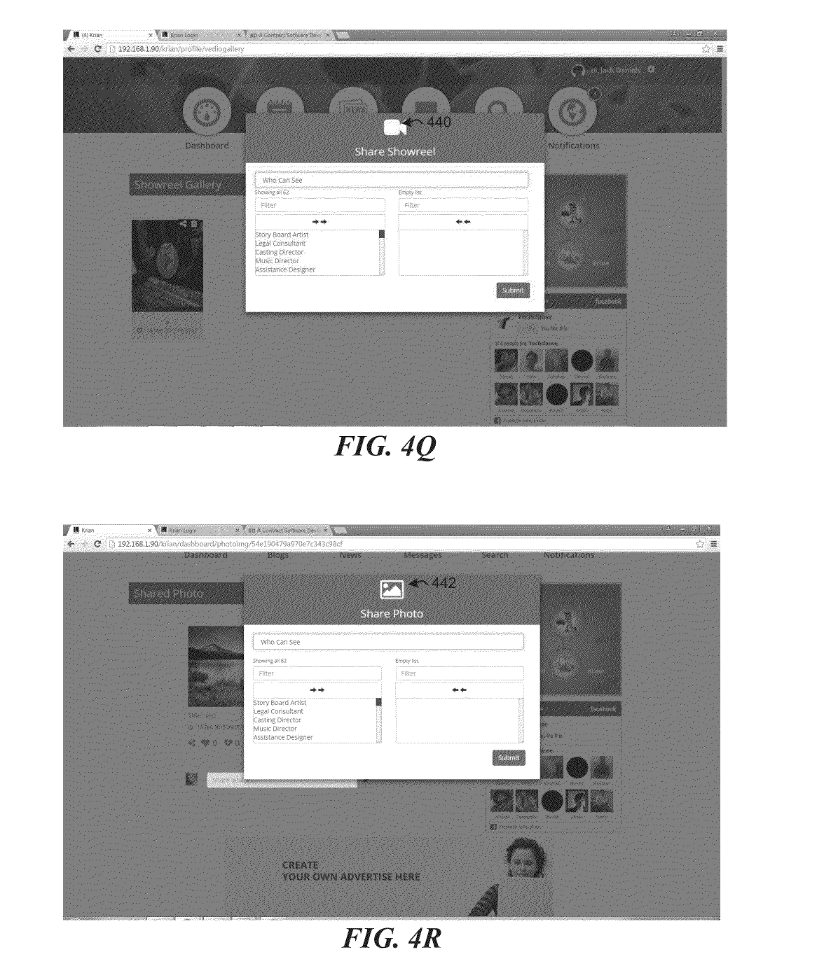

FIGS. 4A, 4B, 4C, 4D, 4E, 4F, and 4G show different sections of an exemplary profile page 400. After a successful login, the logged-in user is can be automatically directed to his profile page. Also, each user can access his profile page by clicking on “Profile setting” and then “Profile” from the drop-down menu panel 402. Each user can personalize his profile page by uploading profile photo, adding experience and education background. The Profile Page can include multiple sections. Examples of the different sections of the profile page includes Profile pic section (Profile pic, Name & Service), Personal Info (Users ID, Service, Date of birth, Phone no.), Blogs (user can upload blog from this section), News (User can provide news from his end), Photo Gallery, Show-reels, Experience (Professional experience with time period & description), Preference services, Key skills (additional skills), New Skills, Education, and Endorsed skills (skills endorsed by users friends).

FIG. 4A shows the main section of the profile page 400. FIG. 4B shows the Experience (Professional experience with time period & description) 404 and Preference services 406 sections. FIG. 4C shows the new skills 408, endorsed skills 410 and education 412 sections. FIGS. 4D, 4E, and 4F show the photo gallery 414 section. The user can upload photos by clicking on “add new photo” icon 416. The uploaded photos can be viewed on the photo gallery page 414. The user can view a photo in the photo gallery section 414 by clicking on the desired photo and then pressing the next button. When clicking on a photo, the photo can be shared or deleted also. FIGS. 4G and 4H show the Show-reels section 418. A show-reel upload form 420 is provided with a show-reel title field and an upload button to allow the user to upload any show-reel. An appropriate message can also be presented, such as “please upload single show-reel at a time.” In case of an error, an appropriate error message, such as “upload has failed—please enter the title first, and then select show-reel.” As shown in FIG. 4H, an uploaded show-reel can be viewed on a popup screen 422. FIG. 4I shows an Update Profile Form 424 as a part of the profile page 400. FIG. 4J shows an Add Blog form 426 that includes fields like Title, a Radio button image, a YouTube link, descriptions, etc. to allow a user to add a blog. FIG. 4K shows a News Form 428 to allow a user to add news. FIG. 4L shows an Experience Form 430 to allow a user to add experience. FIG. 4M shows a Preferred Services form 432 to allow a user to add preferred services. FIG. 4N shows a New Skills form 434 to allow a user to add his new or key skills. FIG. 4O shows the Endorse Skills section 410. Users can endorse their friends by providing their input through auto generated questions 436. This endorsement action automatically updates the endorsed friends' profiles under the Endorsed Skills Section 410. Examples of the auto generated questions include “Does Shane know about Direction?” FIG. 4P shows an Education form 438 to allow the user to add his education. FIG. 4Q shows a Share Show-reel form 440 to allow a user to share a show-reel with anyone. The system provides for several sharing options. The show-reel or any other content can be shared by all users (i.e., public), shared with selected friends form a list (Friends), or shared by service providers, such as a Director, Actor, Script Writer, etc. (Who can see). The user can share photos, show-reels, blogs, and news with the target users. FIG. 4R shows a Share Photo form 442. Different forms for sharing a corresponding content can be provided.

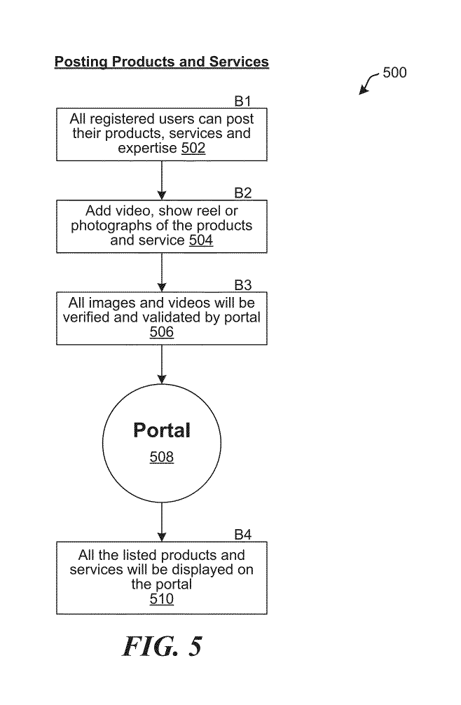

From the deck or profile page, users can track and manage their posts, personal account settings, industry information, messages, their current post status and even Forums and more from one single, secure location. FIG. 5 is a flow diagram illustrating an example process 500 of posting products and services. User can Browse listings when they are not sure what they are looking for or when they simply want to explore the range of products and services on the system or in a particular category. Process 500 can include the system receiving an initiation of posting of product or service from a registered user (502). All registered users can post their products, services, and expertise. The system can receive as a part of the received posting, videos, show-reels, or photos of the products, services, etc. (504). The system verifies, validates, or both verifies and validates the posting including the posted photos, videos, show-reels, etc. Once verified, validated, or both, the contents of the posting are stored at the portal (508). The system presents the postings stored at the portal for display and viewing at the portal (510). The user can upload new blog in this section by using the add blog form which has an option to upload contents such as a YouTube video or an image. For uploading a Video user can paste the embedded code of YouTube video in YouTube link text box, for example.

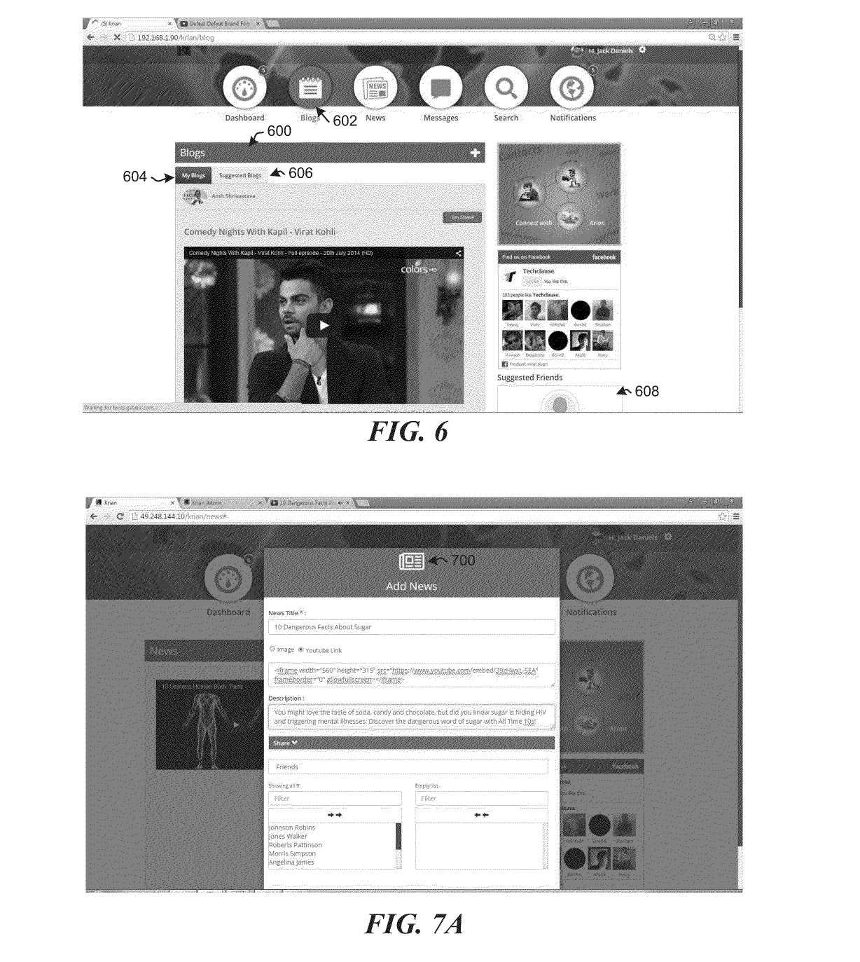

FIG. 6 shows an example Blog page 600. Blogs can be viewed by clicking on “view all” link from blog section of dashboard and clicking on blog symbol 602 on header. On dashboards the “see more link” of a particular blog leads to that single blog. A Blog page is divided into two sections My Blogs 604 and Suggested Blogs 606. Also, a Suggested Friends option 608 is shown at right bottom. The My Blogs 604 includes user's own blogs, friend's blogs with Un-chase option. Suggested Blogs 606 includes Blogs uploaded by other users with chase option. Suggested Friends.

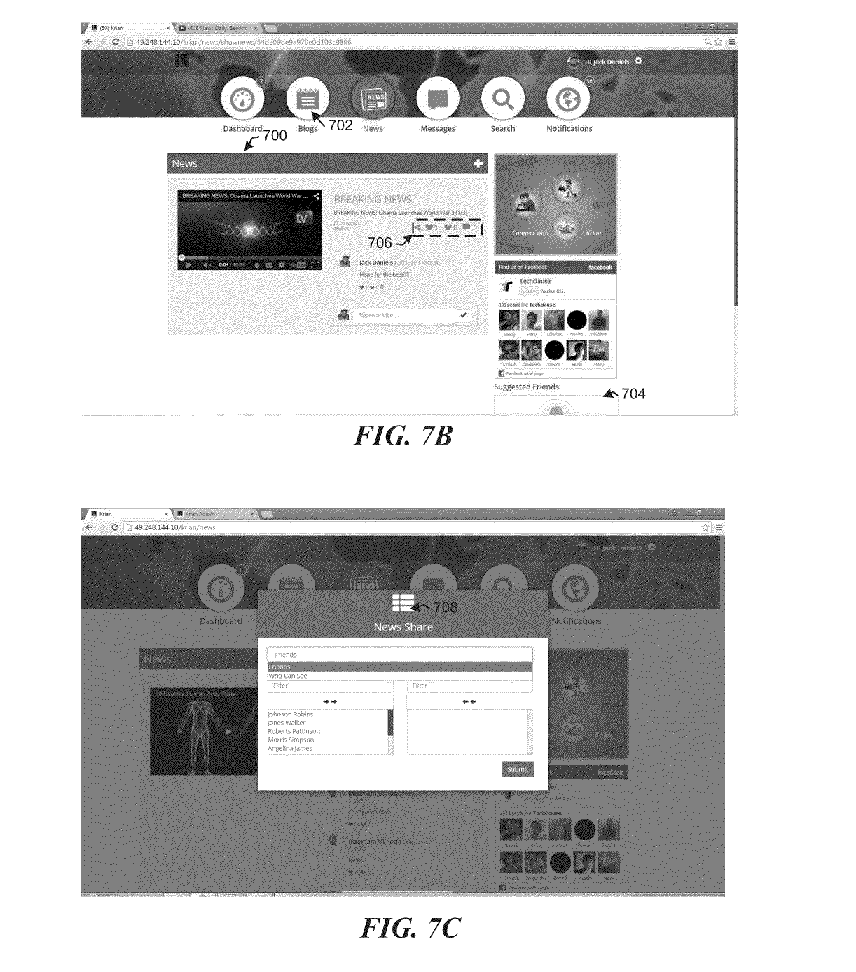

FIG. 7A, 7B, and 7C show an exemplary News Section 700. News can be uploaded by a user from this page or from profile page. In some implementations, News can be provided by the admin. News is associated with Author name with option for users, including a feedback 706 provided by users, such as “Like,” “Hate,” “Comment,” and “Sharing News” (Friends or to respective services). Along with the news, the user can add friends from suggested friends option 704. The News section 700 can be viewed directly from Dashboard or by clicking on News icon 702 on the Header. To go to a particular news page, the user can click “see more” link from the News section 700 of the dashboard or profile page. The user can upload news from the news page or from the profile page. As shown in FIG. 7C, a user can share News by using a News Share form 708.

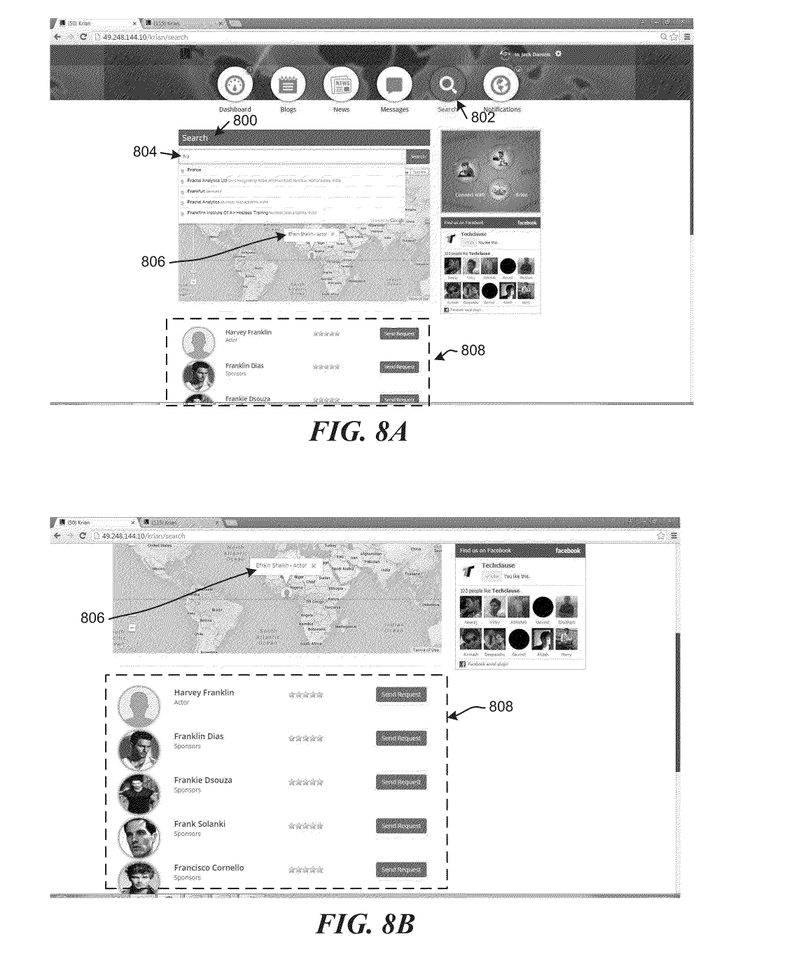

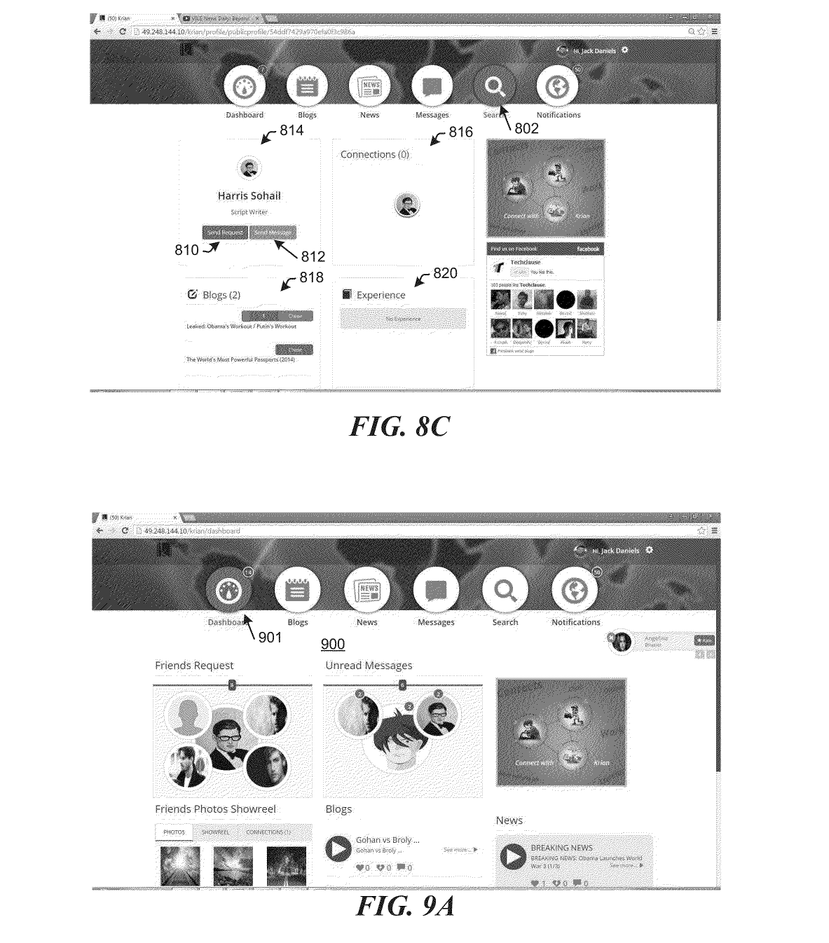

A user can also Search for items when the user is looking for a specific item that the user can describe using a few words. In such cases, the user can simply go to the search box, enter a few words describing what the user is looking for, select a category and click the “Search” button. A search results page of the system listings will be displayed. The user can review his search results pages and depending on the user's level of interest the user can click on the title which will display further details of the service provider. FIGS. 8A, 8B, and 8C show an exemplary Search page 800. A user can search for a service or a user based on the Service id, User name etc. by simply describing few words on search box 804. A listing for each search is generated with the location on map 806. From this section, the user can send request, view public profile or message him. Related to the Search page 800, the user can access a ratings page 808.

A user can increase his network by sending a friend request to other users. Depending on their level of interest they can click on profile pic to view their further details including Search page, Public profile page, Suggestion friend section (Blog page, News page, Message page), and Message popup form (Dashboard). FIG. 8B shows an example of sending a Friend request from the search page. Interested users can send friend requests or messages using the send request button 810 and send message button 812 from the search page as shown in FIG. 8C. Messages are sent as alerts to recipient's dashboard as unread message. A search can return the Public Profile Page of the searched user. The public profile is a page by which other users can view information related to that user's profile. Users can block this profile page from being viewed by the public using the profile setting. The Public Profile Page includes multiple sections, including a Profile section (profile pic, users name, service name, send friend option, send messages) 814, Connections (Friends count) section 816, Blogs (user's blog count and title with chase option & count) section 818, and Experience section 820.

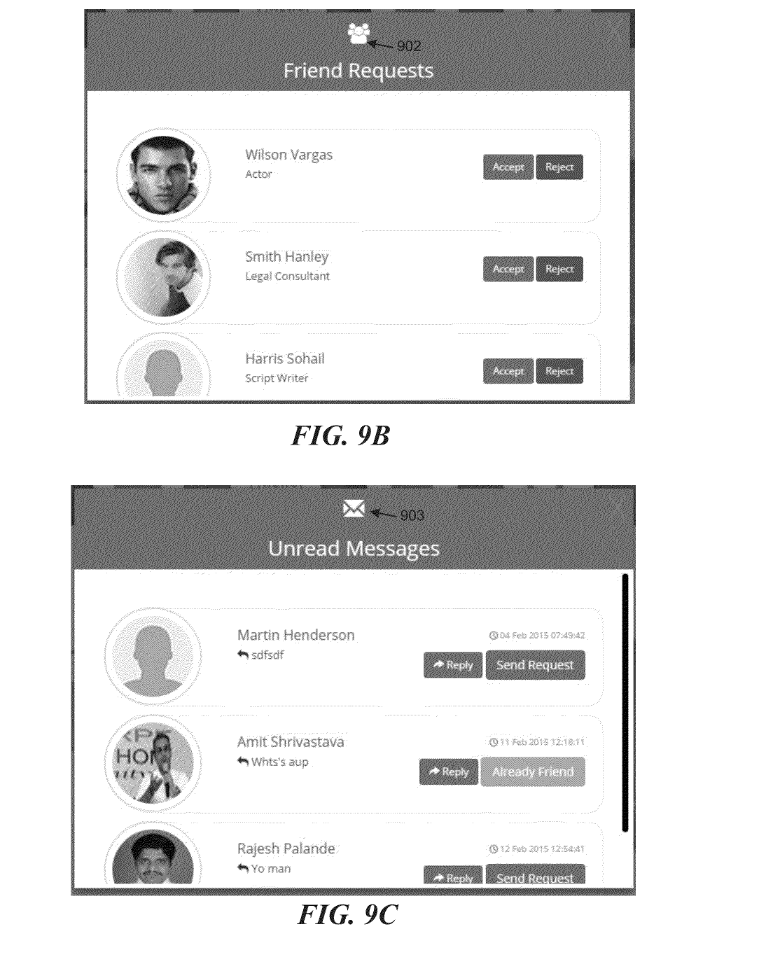

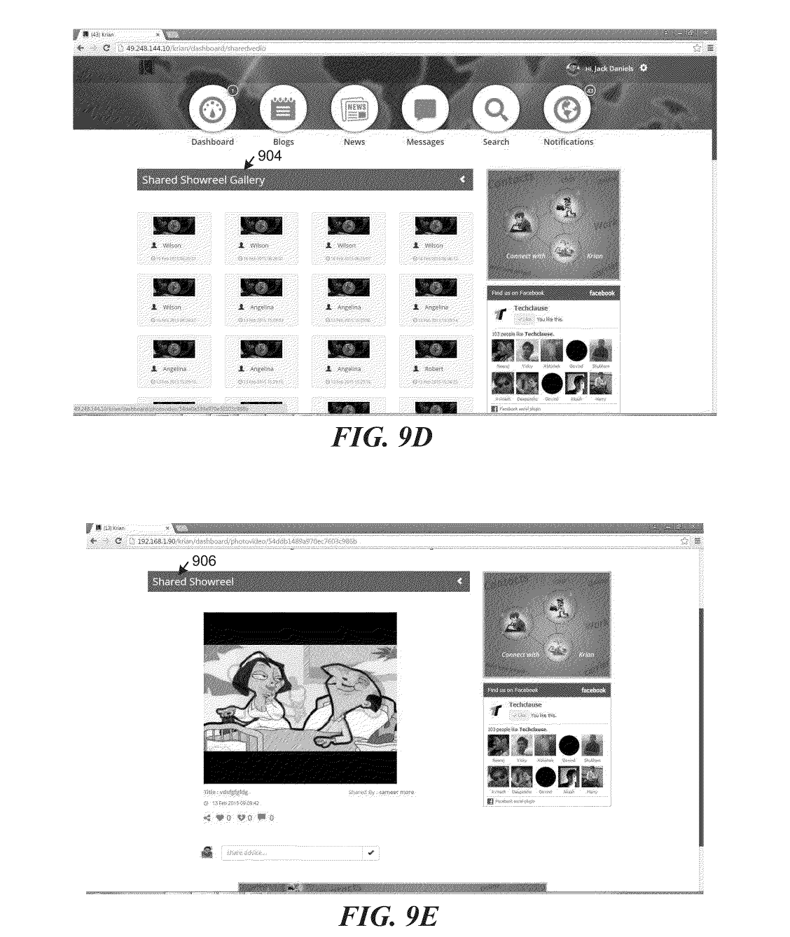

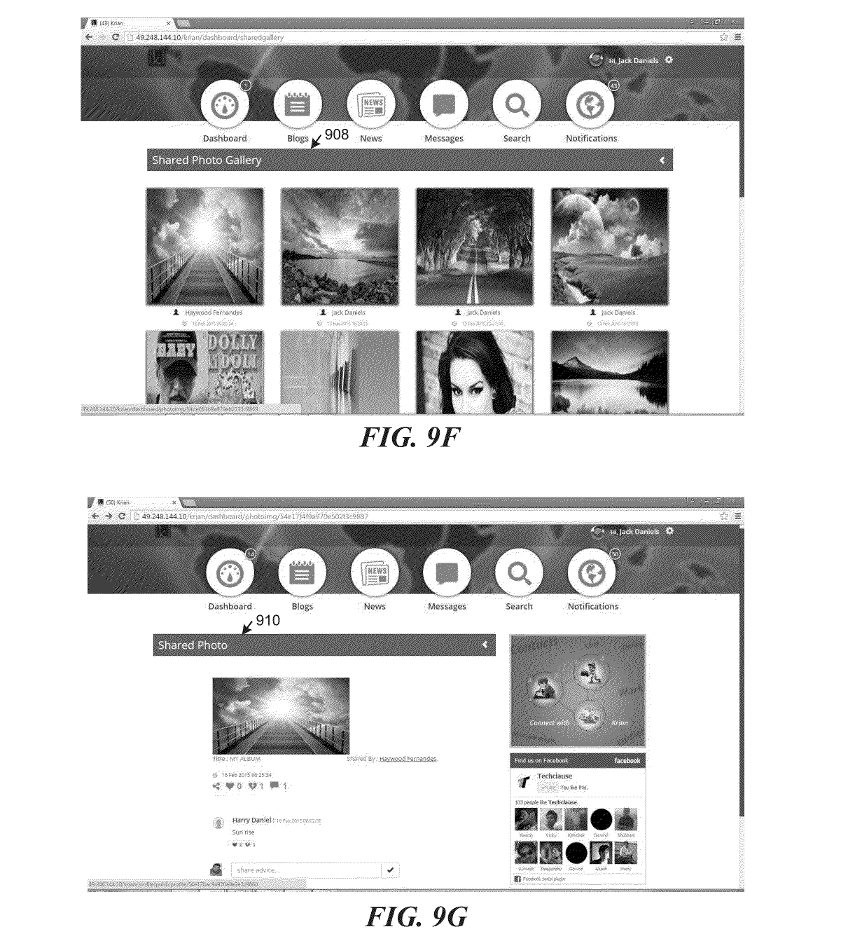

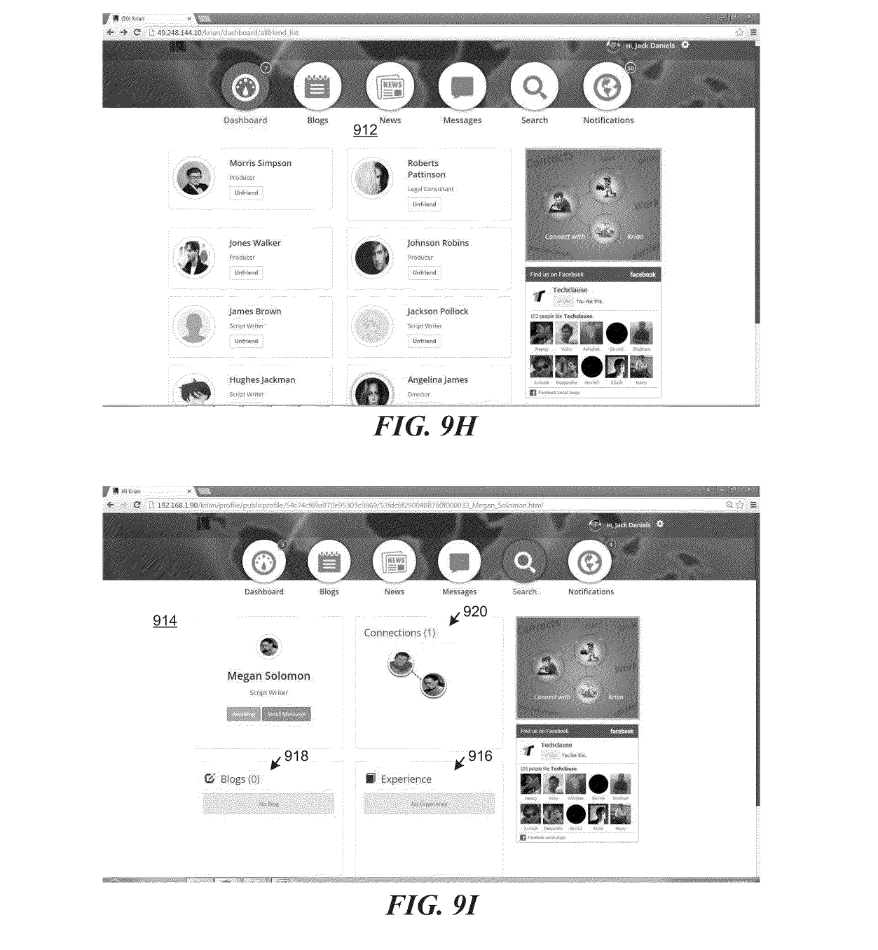

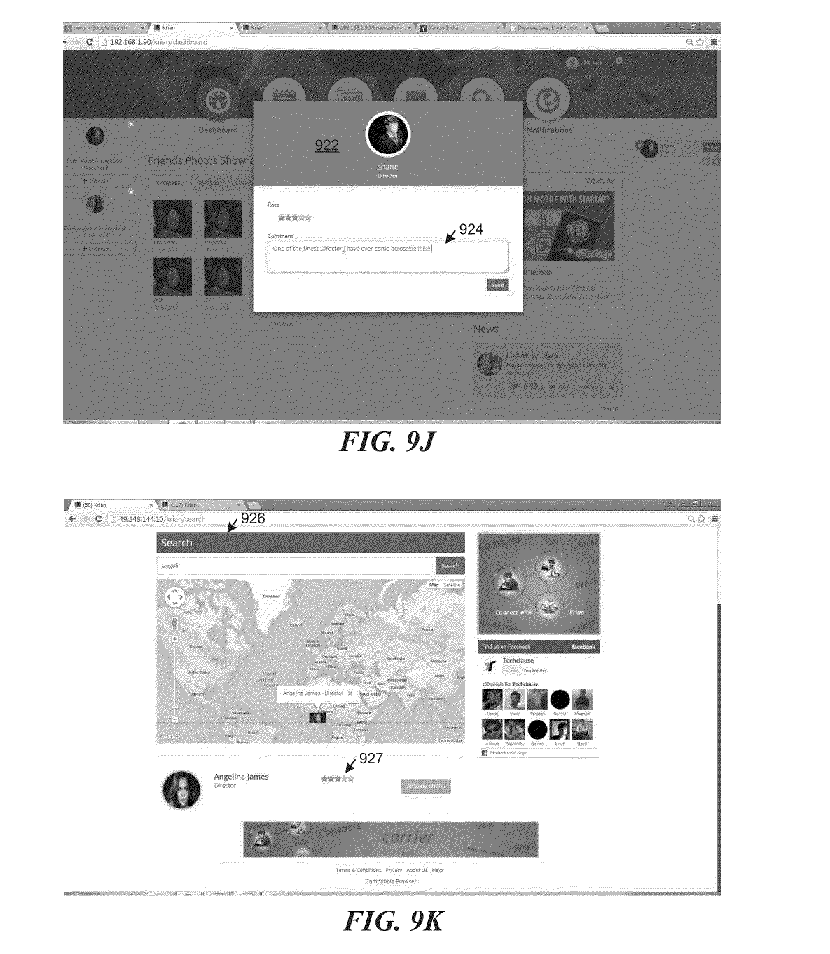

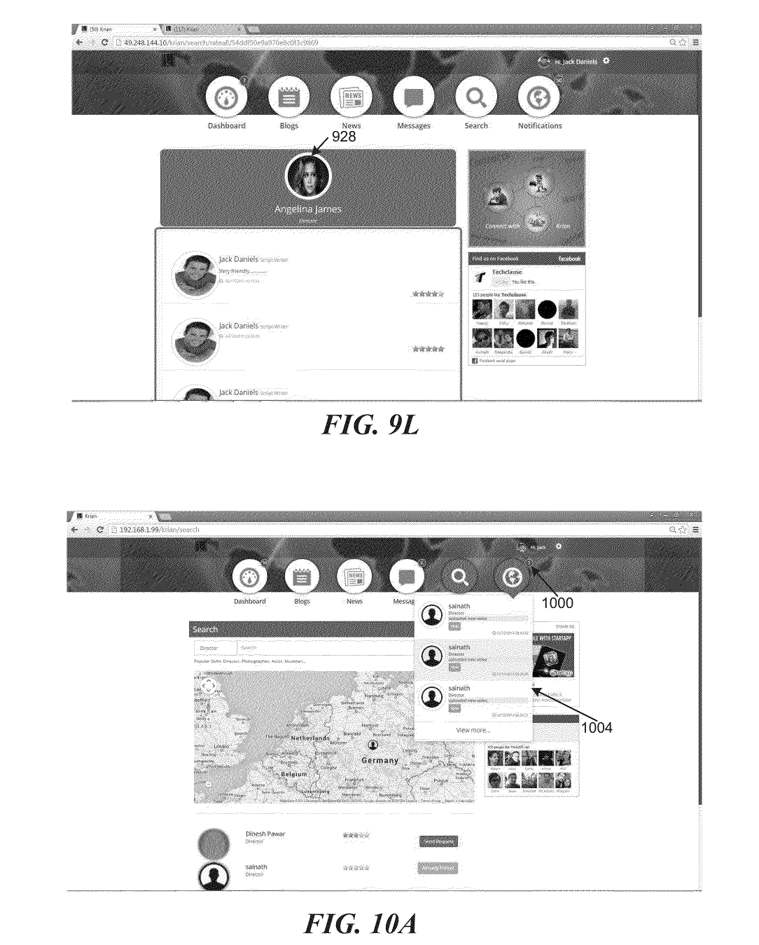

Once the user finds his relevant products and services he contacts the product or service supplier offline. The portal provides an alert to all respective providers of a particular category when any buyer is searching for their product or service. Alerts to the providers will be sent by the portal depending on the preferences selected on the user's deck. Each service provider will get preferred way to contact the interested buyer as per his settings in the DECK. FIGS. 9A, 9B, 9C, 9D, 9E, 9F, 9G, 9H, 9I, 9J, 9K, and 9L show various aspects of a dashboard 900.

FIG. 9A shows Friends request and unread messages alert on the dashboard. The A user can access the dashboard by selecting the dashboard icon button 901. A user can provide his interest to the respective user by sending him friend request or message. In addition, the dashboard also provides advertisement in terms of banners on right hand side (161×623) and on footer (720×90). FIGS. 9B and 9C show examples of Pop up of friend Request 902 and Unread 903 Messages. FIG. 9D shows the Shared Gallery section 904. Shared show-reels can be viewed in shared show-reels page or section 904 by clicking on “view all” link. Users are provided with shared users name and shared timing. Sharing can be categorized in three ways, including Public (Shared as a default to all users), Friends (Shared to selected friends from friend list), and who can see (shared by service e.g. Directors, Scrip writer, Actor etc.). In addition, the dashboard also provides the advertisement in terms of banners on right hand side (161×623) and on footer (720×90). FIG. 9E shows the Watch shared Show-reel page or section 906. A single shared Show-reel has the following details: Show-reel title name, Shared by user name, Like/hate option, Comment option, Like/hate & comment count, and Sharing to other users. FIG. 9F shows the Shared Photo Gallery page 908. A user's Shared photos are displayed on the Shared Photo Gallery page 908. Shared photos are provided with attributes, such as Photo shared by, and Date and time of sharing. FIG. 9G shows the View Shared Photo page 910. Shared photos can have attributes, such as Photo title name, Shared by user name, Like/hate option, Comment option, Like/hate, and comment count. FIG. 9H shows the Connection page 912. The Connection page shows all of the users who are currently in the friend list. The user can select the “View all of the connection” to navigate to the friend list page. Friend list page has an option to unfriend particular user or else you can view his profile (Public Profile). FIG. 9I shows the Public Profile page 914. A user can view his friend's profile by clicking on his profile picture, which redirect to the Public Profile page. The Public profile page is associated with experience 916, blogs 918, and the Connection 920 sections respective to the user. FIG. 9J shows Rating a Friend section. Friends can be rated using a rating slider on the dashboard which provides a popup form 922 on single click. A Rating can be provided by clicking stars out of 5 stars. Also, along with the stars there is a comment box 924 provided. FIG. 9K shows the star ratings on a search result 926. In search result, the star rating can be viewed. Clicking on the star rating 927 displays the ratings details. On click on the start rating associated with the search result displays the Ratings details page 928 as shown in FIG. 9L. Ratings details page has the user's name and the friend who has rated that user.

The system also provides for a Notification system. Options for the alerts in the user deck or profile page area can include the following:
1. SMS
2. Email
3. Mobile and tablet Apps
4. Web alerts in users deck

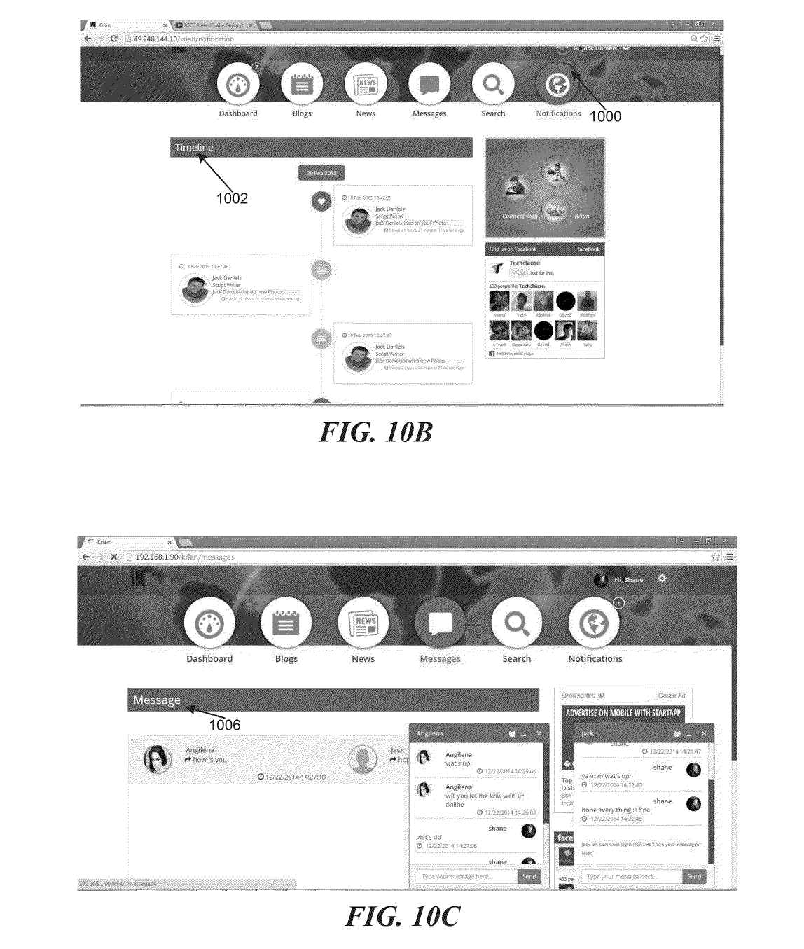

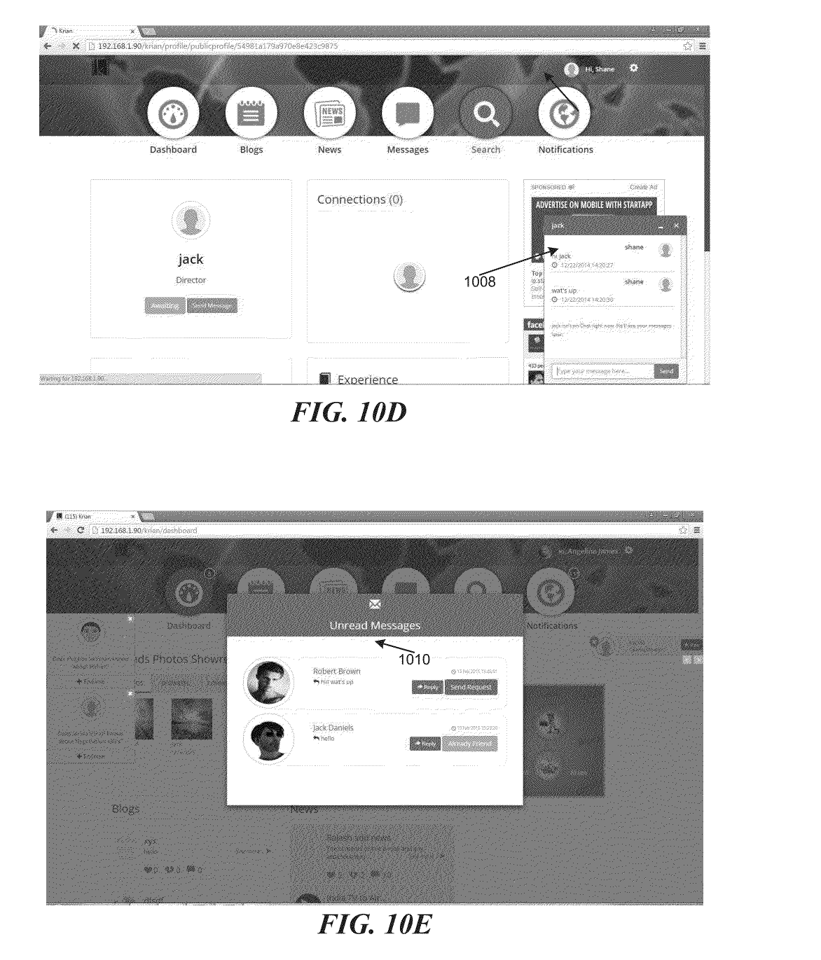

FIG. 10A shows a notification icon 1000 and a timeline page 1002. Notification is an alert that notifies the user regarding any update on the user's profile. Any Update related to the user's profile is shown as a count on the notification icon 1000 and can be viewed in detail on a time line page 1002. The drop down list 1004 shows the latest notification related to the profile. Notification shows the alerts from various sections including Friend request related update; Shared show-reel; Shared photos; Love or Hate on show-reel; and photos, blogs, news. The user can also provide Comment on show-reel, photos, blogs and news. The timeline 1002 shown in FIG. 10B is a way of displaying a list of events in chronological order which is redirected from notification.

FIG. 10C shows an exemplary Message page 1006. A user can message offline friends or a user as well as chat with users who are online. A user can chat with the friends individually or in group. This page also shows the online or offline status of friends. The message count increases responsive to receiving a message from friends. A user can send or read a message from the message page or from the public profile page.

FIG. 10D shows an exemplary Chat window 1008 that allows a user to chat with offline or online friends. An Offline chat can be performed with a user who is offline or with a user who has turned the chat off in his privacy setting. When the recipient is determined to be offline or has turned off his chat option, an Error message can be sent to the sender of the message. An exemplar Error Message can include: “Jack isn't on Chat now, He'll see your messages later.” A user can also send message to other users from his public profile page.

FIG. 10E shows an exemplary Message popup window 1010. Message Popup:—The message send from above is displayed on dashboard &has an option to send friend request too.

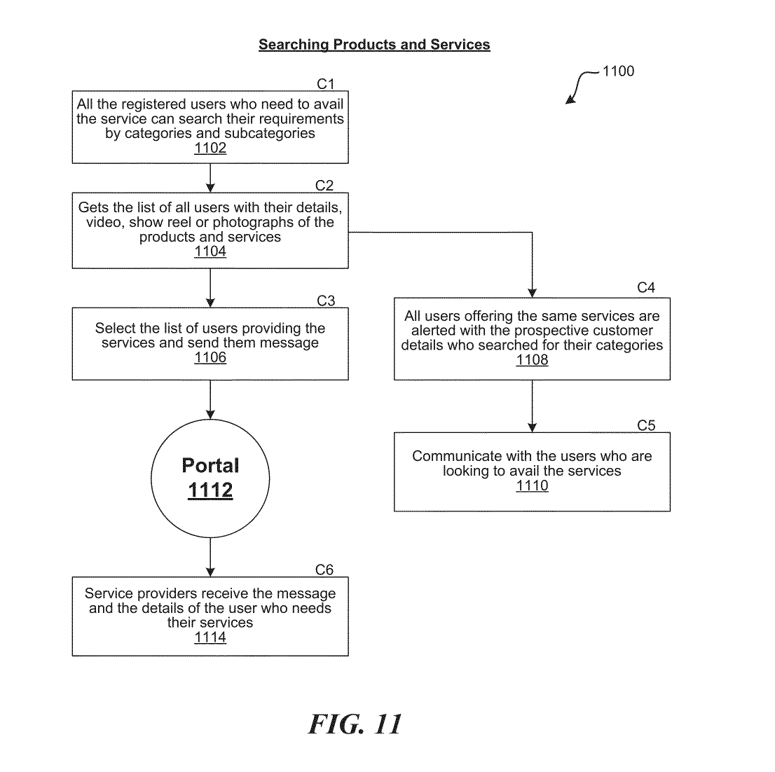

FIG. 11 is a flow diagram illustrating an example process 1100 of searching products and services. Posting a profile is Free. Users can display or post products and services for sale without paying a fee. Users can search for products and services for free. Providing contact details are free on the portal. The process 1100 includes receiving a search request from a user for a service or a product related to the film industry (1102). The system presents a list of all registered users that can provide the searched for product or service including the registered users' detailed information, video, photos, show-reels, etc. of the searched for products or services (1104). The system alerts all users that offer the searched for products and services, and the alerts may include the prospective customer (the user that requested the search) details, such as who searched for their services or products (1108). The system provides for a process to allow communication to the users that can provide the services or products (110). The system receives user selection from the list of users offering the searched services or products searched (1106). The user selection may trigger sending a message to the selected service or product provider. The portal forwards the message to the selected provider of the selected service or product (1112). The provider of the services or products receives the message from the user that requested the search and the details of the user needs the services or products (1114).

Apart from the above described options the portal can also provide the following.
1. Display useful information and industry news to the Deck or profile page of correlated products and service providers.
2. Group forums for the relevant products and service providers to discuss any latest developments or problems in their industry.
3. Interviews of the experts
4. Every user gets there personalized DECK where all their profiles, post and order status is managed.
5. Have designated advertisement space for all users with the best visibility options.

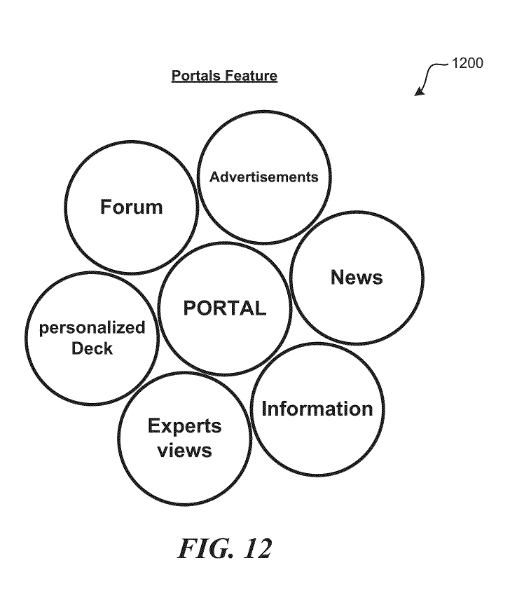

FIG. 12 is a diagram illustrating an example collection of features 1200 of the portal. The examples of the features 1200 of the portal can include Forum, Advertisement, News, Information, Expert Views, and Personalized Deck or Profile Page.

Additional Portal Features

In addition to the feature described in the previous section, the portal or system provided by the disclosed technology can provide added features to facilitate the users to directly access talented professionals in the multimedia, entertainment, and film industry. Examples of the added features can include Mutual Associates, Privacy Setting, Public Profile, Change Password, and Endorse features among others.

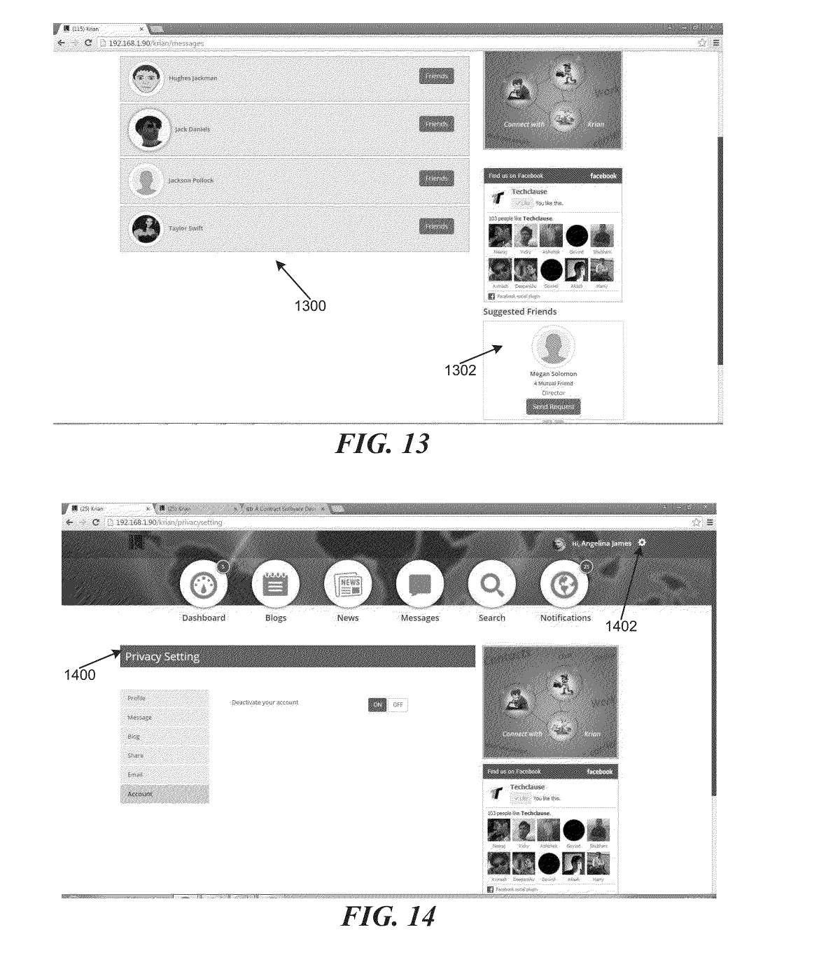

The Mutual Associates feature provides an identification of a mutual associate, a common user who is a friend of two individual who may or may not know each other. Using the Mutual Associates feature, a user can increase his network of friends. FIG. 13 shows an example of displaying and identifying a mutual associate in a mutual associate or friend list 1300. Users common between two known or unknown users are placed in the mutual friend list 1300. Mutual friend option 1302 is placed along with suggested friend i.e. on Blog, News and Messages.

The Privacy Settings feature provide controls available on the portal that allow the user to limit who can access his profile and what information visitors can see. FIG. 14 shows an example of a privacy settings page 1400. This page can be accessed by clicking on “Profile setting” and then “Privacy setting” from the drop-down menu panel 1402. The Privacy Settings feature include the following options: (1) Profile: User can hide his profile content by changing status as ON/OFF in profile section; (2) Message: User can change his status of online to offline in message setting option as ON/OFF; (3) Blog: User his provided with chase/un chase option which can be turned ON/OFF for his blogs; (4) Share: User can hide the sharing option by changing status as ON/OFF; (5) Email: user can avoid unwanted mail related to notification; (6) Account: Deactivate the user from this button.

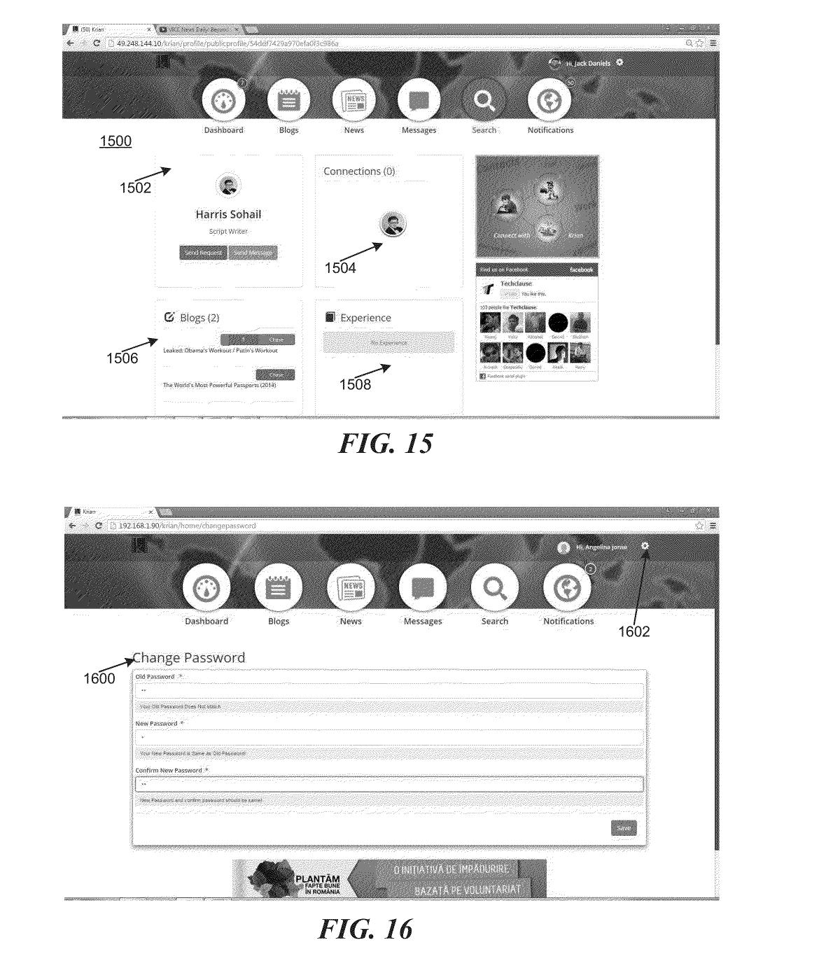

Public Profile feature includes a profile page which is public i.e. can be viewed by any one including people who aren't the user's friends. FIG. 15 is an example of a public profile page 1500. Users can block this profile page 1500 from viewing from privacy setting option. This page can be accessed by clicking on “Profile Pic” of a user on the search result.

The public profile is the profile page of a user which is publicly visible. The user can block this profile view for other users by adjusting the profile settings. The profile page 1500 provides various sections including: (1) Profile section (profile pic, users name, service name, send friend option, send messages) 1502; (2) Connections (Friends count) 1504; (3) Blogs (user's blog count and title with chase option & count) 1506; and (4) Experience 1508. Interested users can send messages from this section which is send as alert to his dashboard as unread message.

Change Password feature is an operation that allows a user to reset another password with desired new value, regardless of the current value. FIG. 16 shows an example Change Password form 1600. This page can be accessed by clicking on “Profile setting” and then “Change password” from the drop-down menu panel 1602. The Change password form 1600 includes a number of fields including: (1) Old password (current password); (2) New password (enter new password & it should be not same as old password); and (3) Confirm New Password (confirm password should be same as new password). The portal also provides for validation and displays relevant verification error messages when the fields are not filled-in as required. Examples of the Error Messages can include: (1) Error messages for old password—“Please Enter Old Password” & “Your Old Password Does Not Match”; (2) Error messages when new password is same as old password—“Your New Password is same as Old Password!”; (3) Error messages for new password—“Please Enter New Password”; and (4) Error messages for confirming password—“New Password and confirm password should be same!”

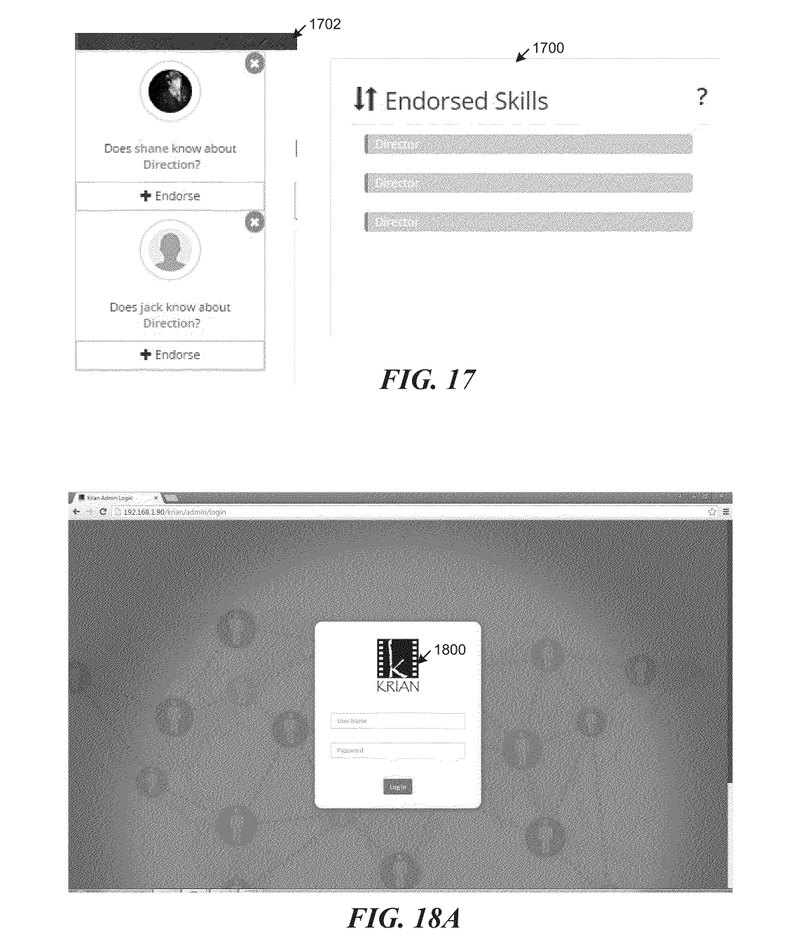

Endorsements feature allow users to easily recommend each other on their preferred skill sets. FIG. 17 shows an exemplary Endorsement Skills section 1700. Users can endorse their friends by providing their input on auto generated questions 1702. This automatically updates the friends profile Endorsed skills section. Endorsement questions can include: “Does Shane knows about Direction?” and can automatically update endorsed skills section in the user profile page.

Admin Features

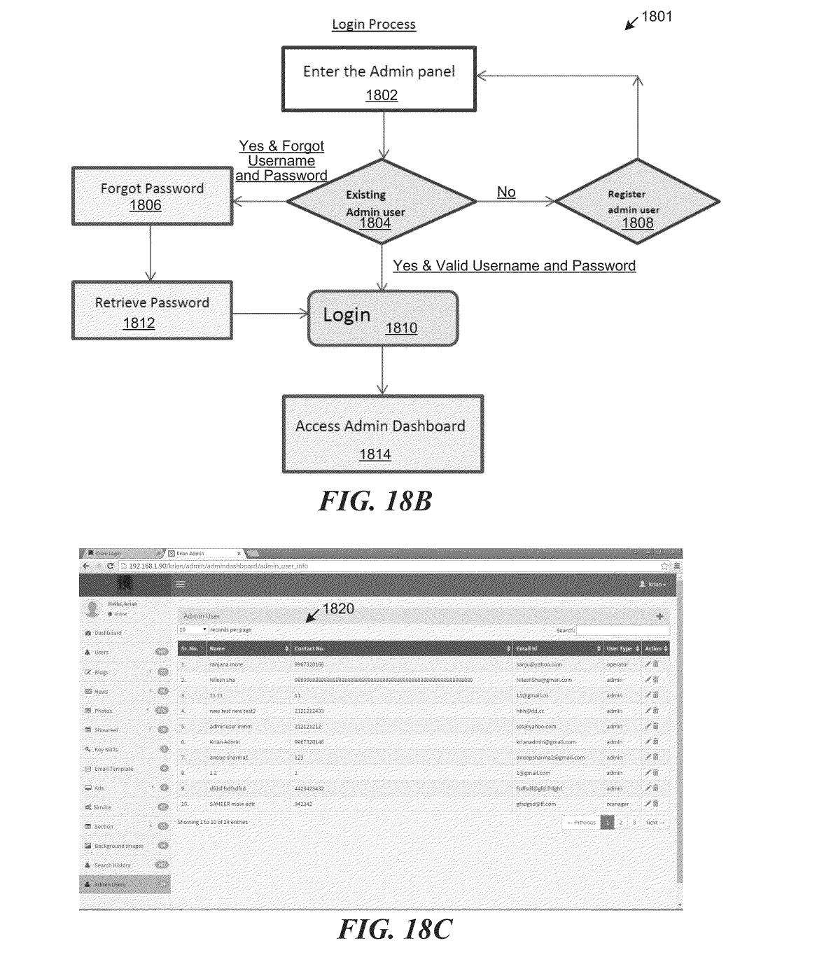

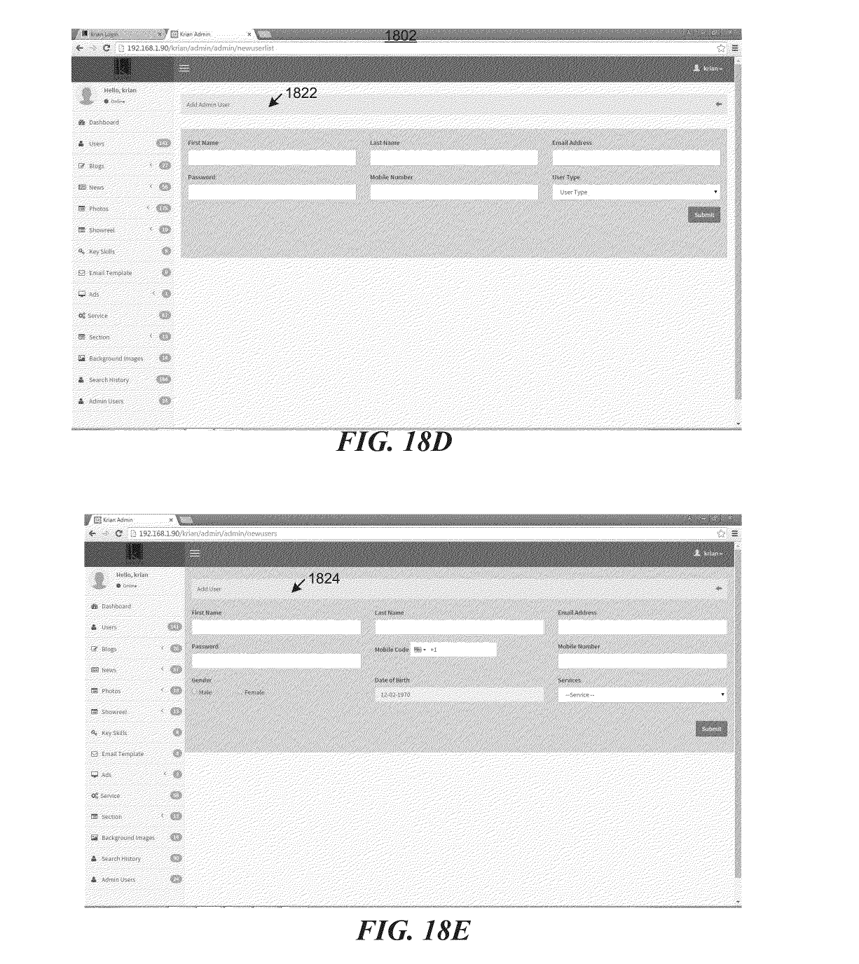

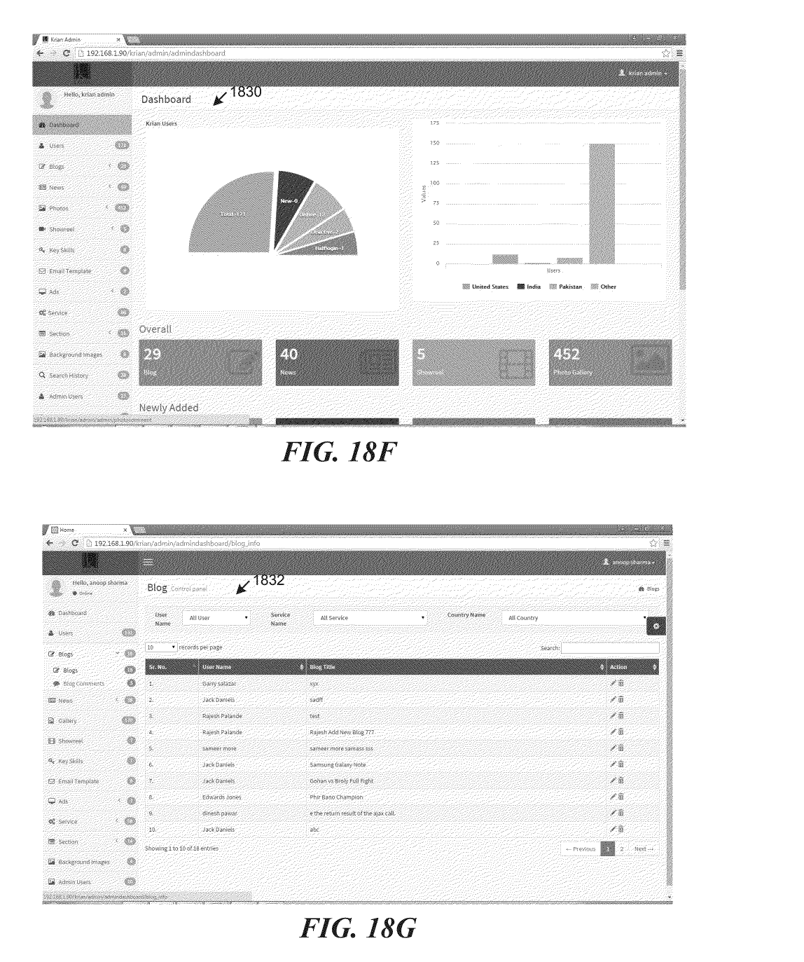

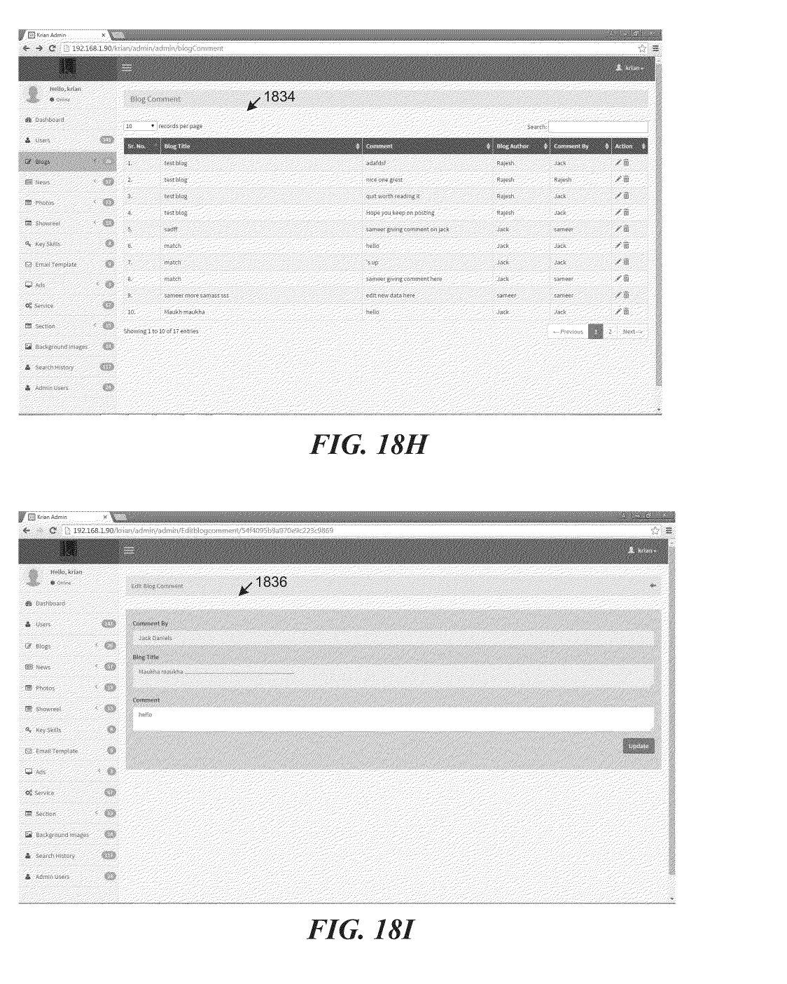

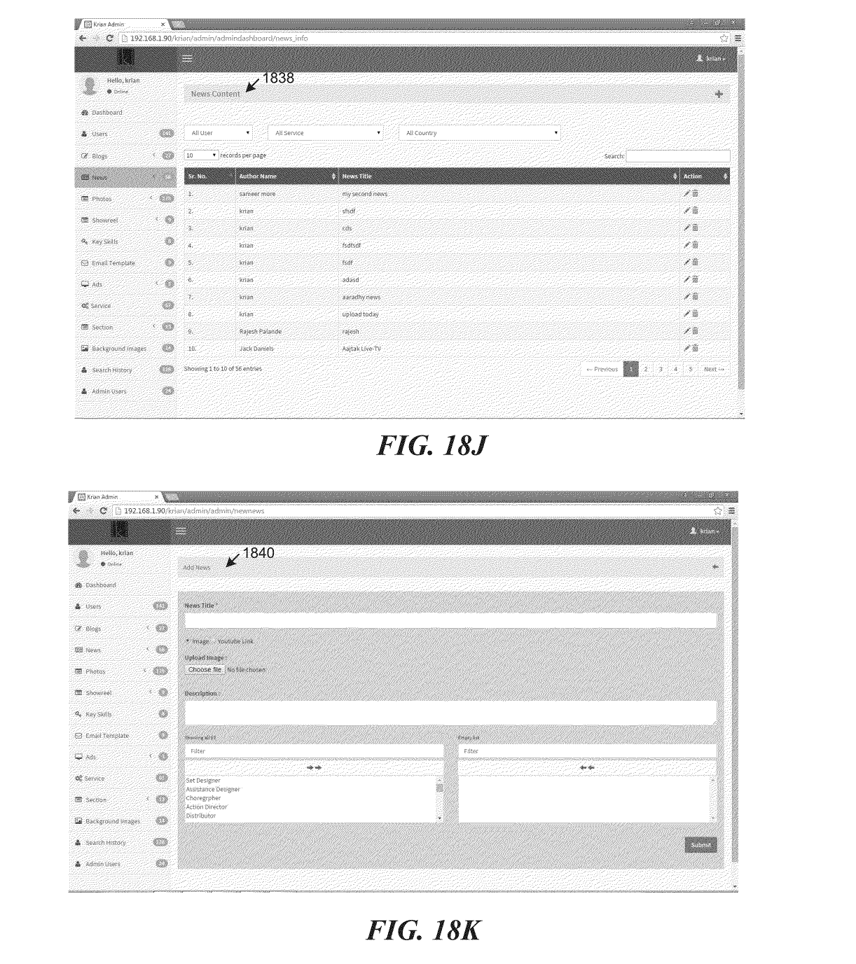

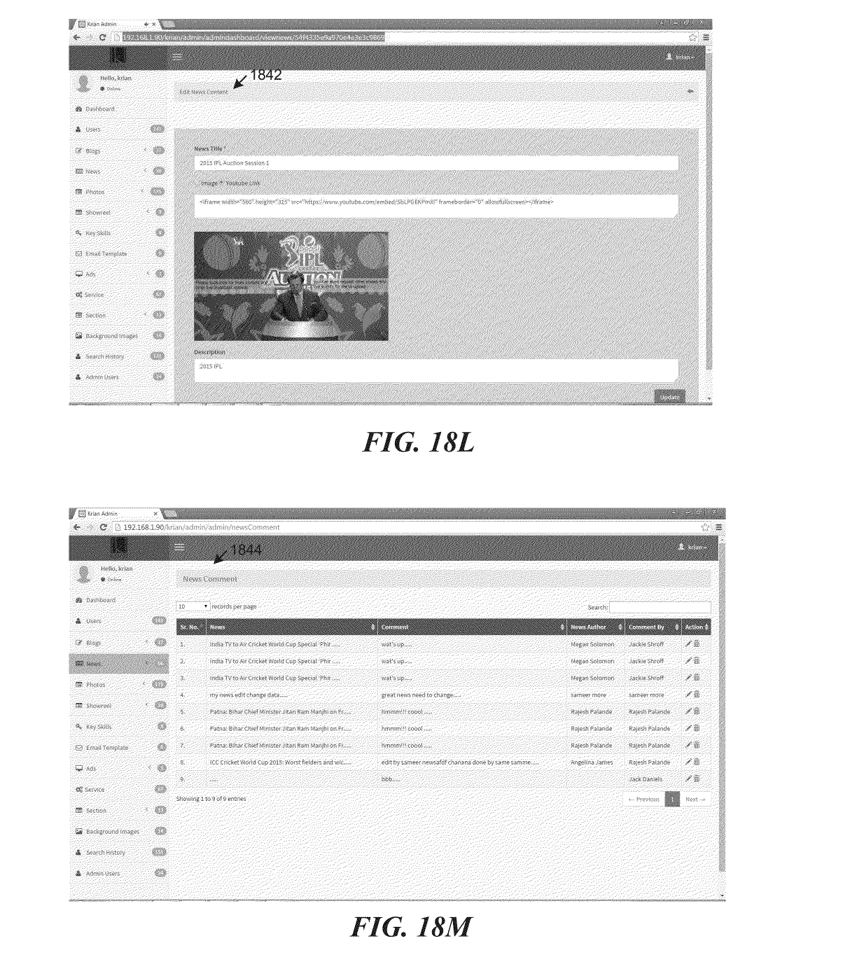

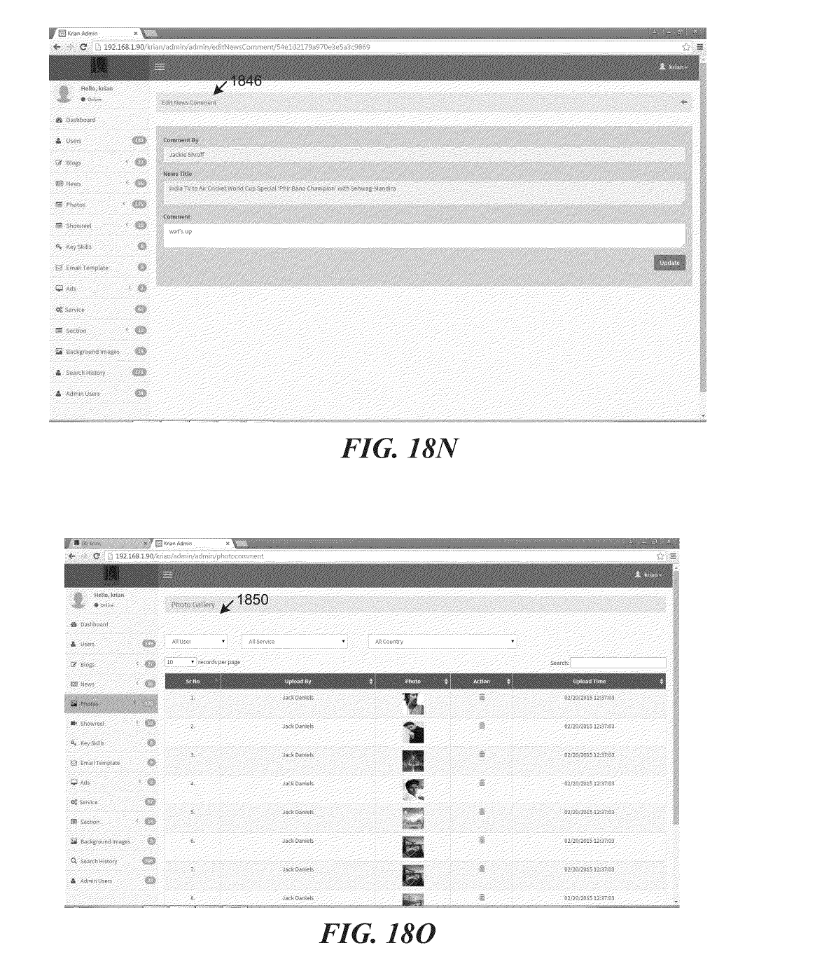

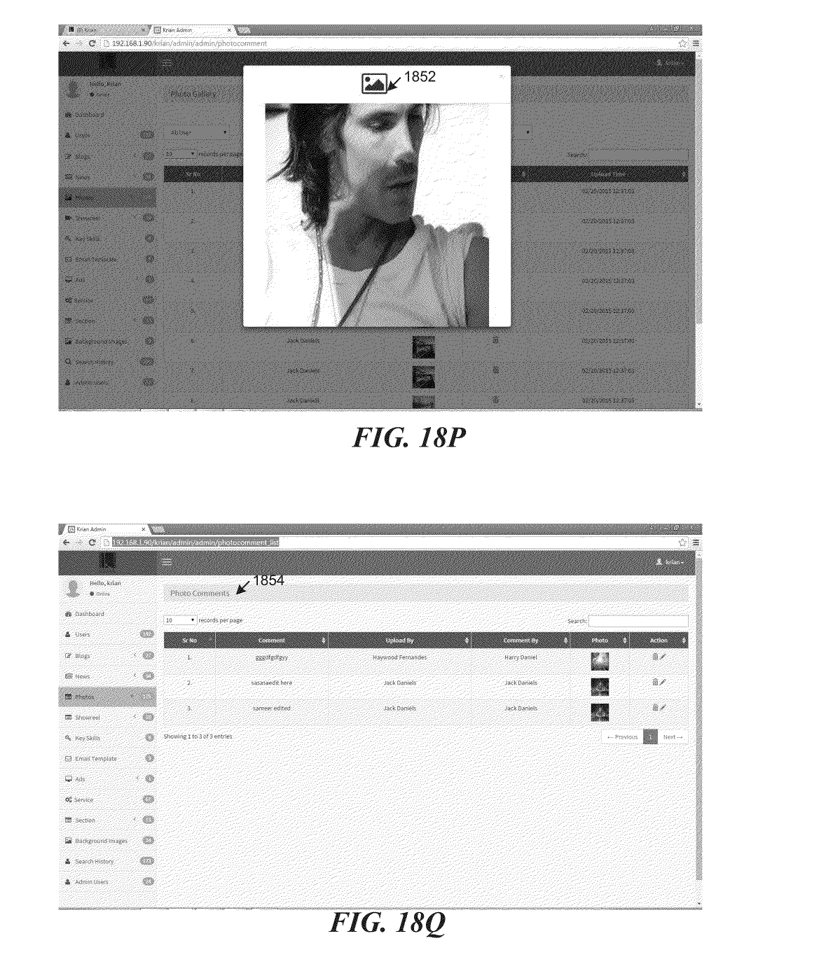

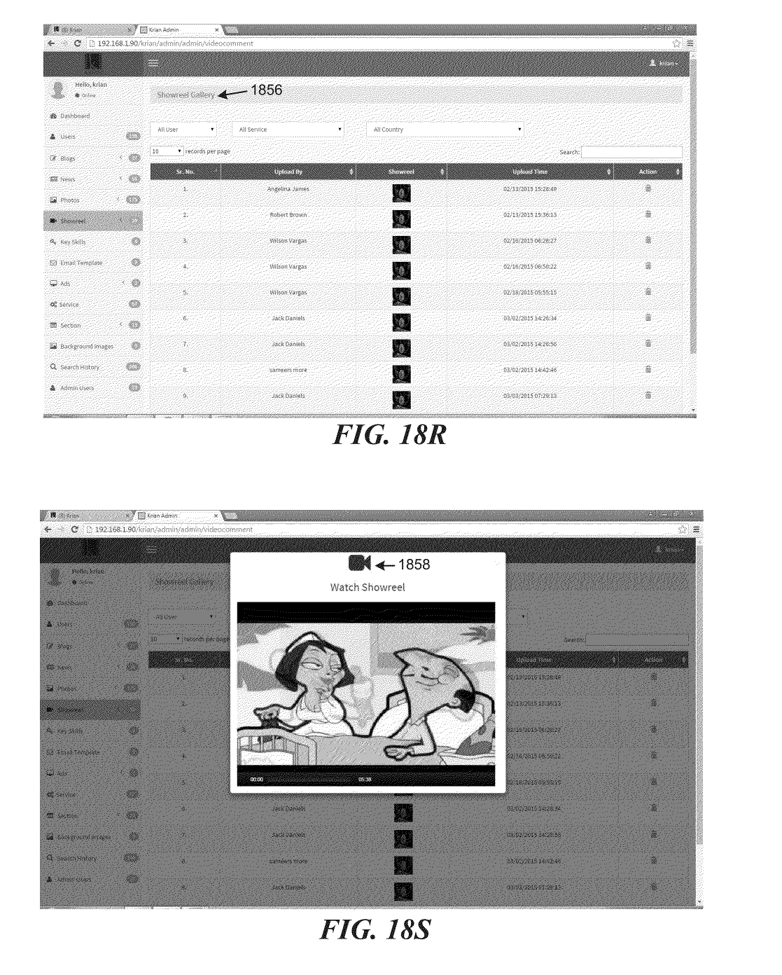

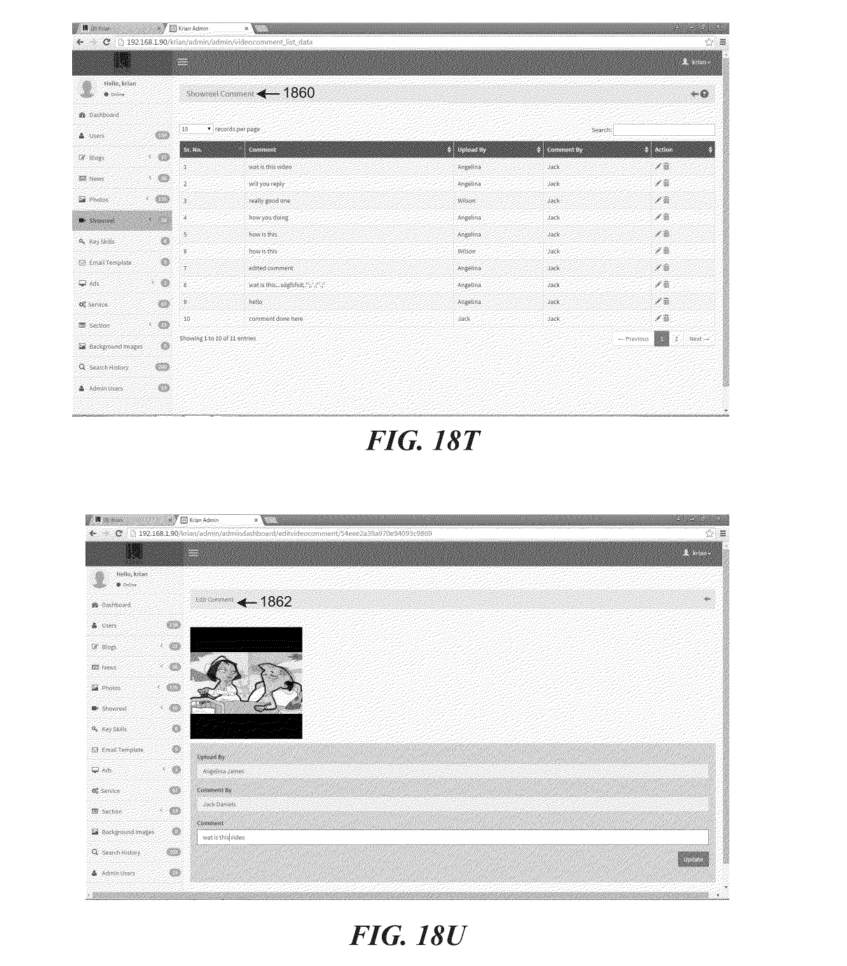

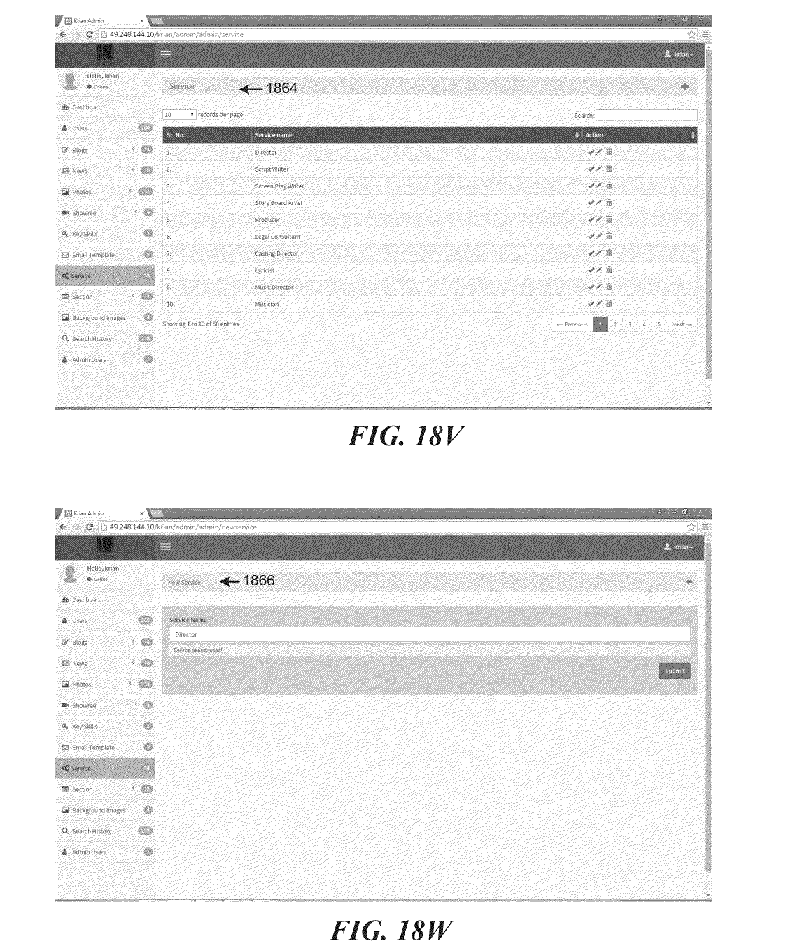

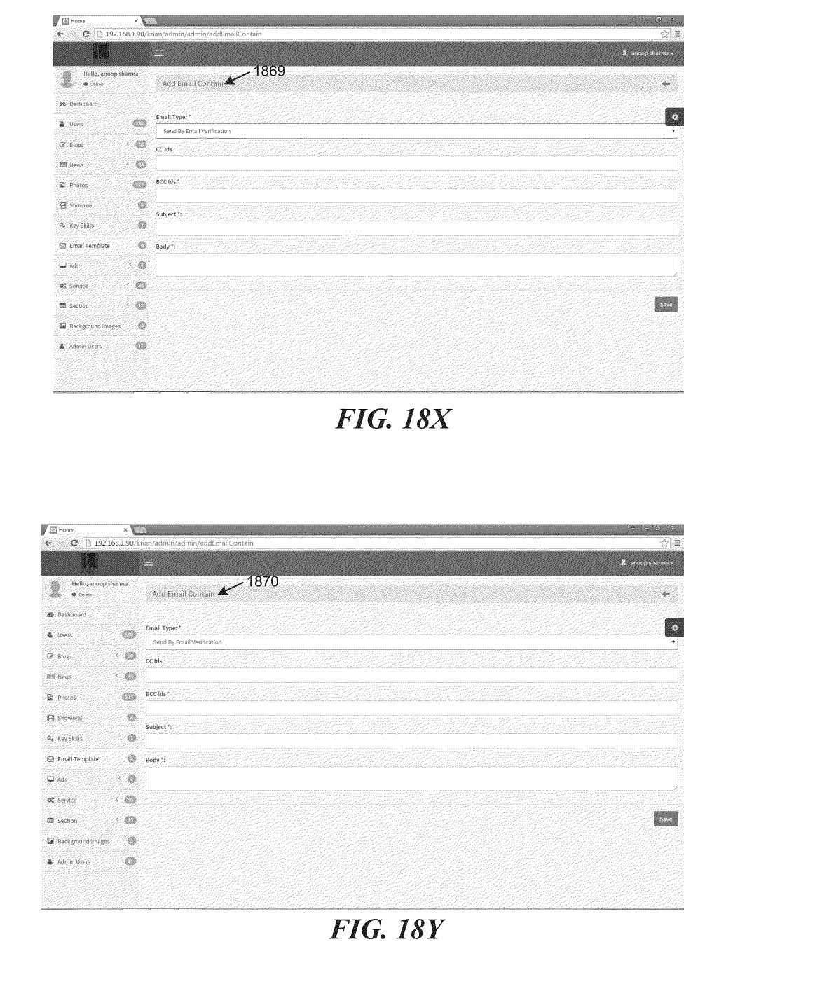

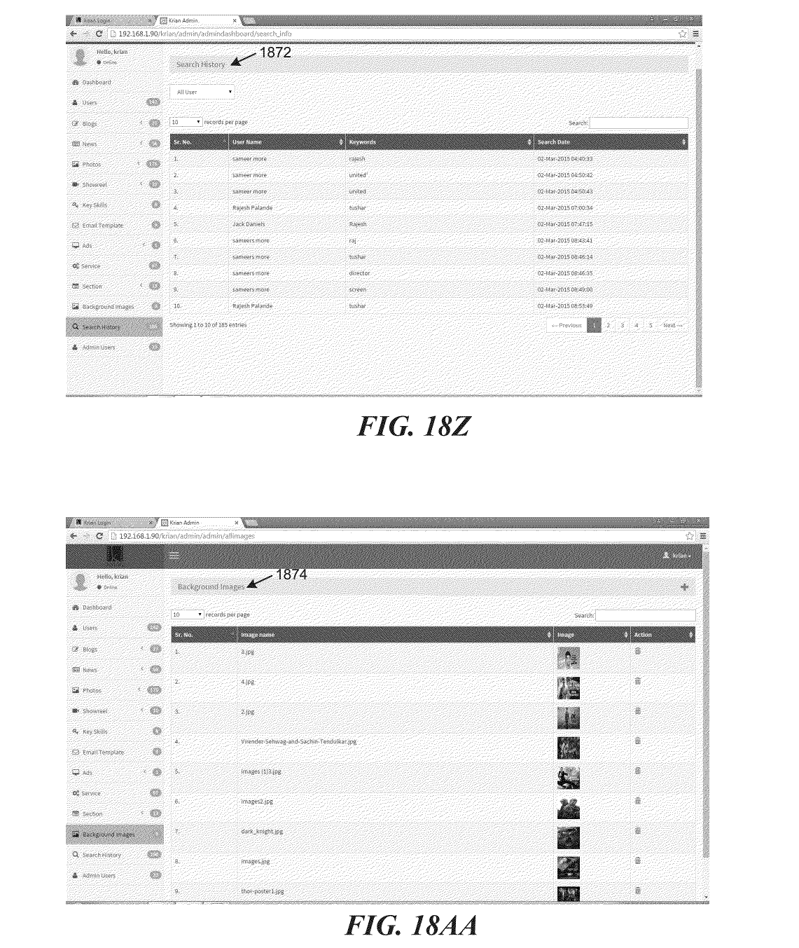

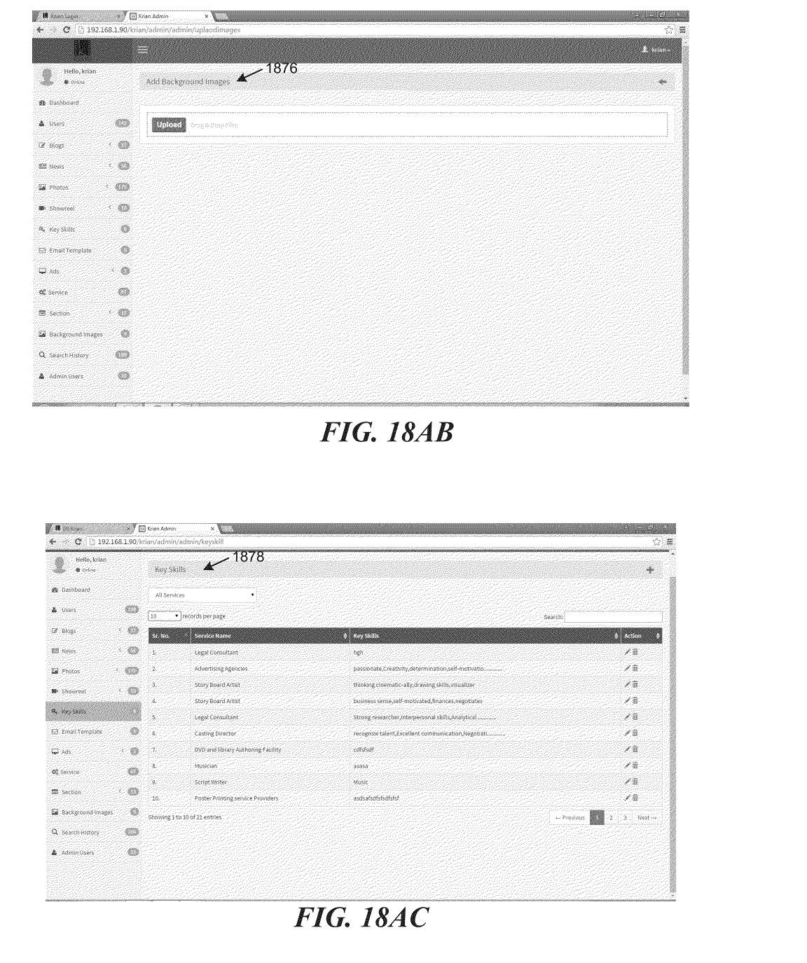

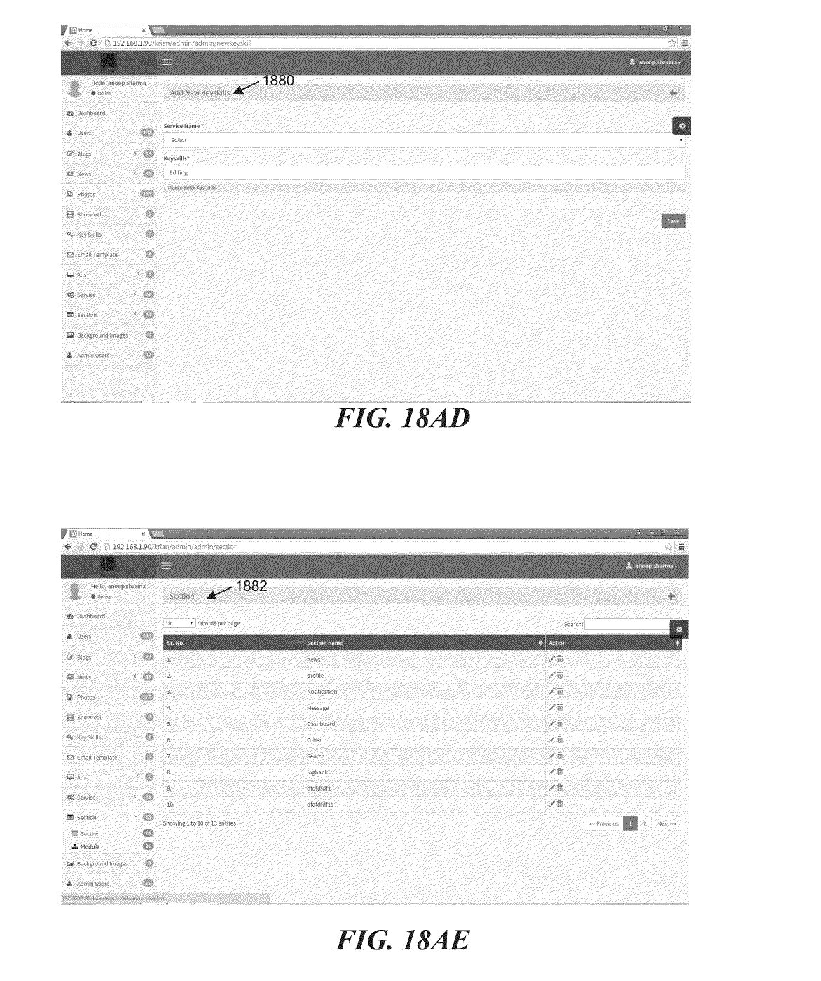

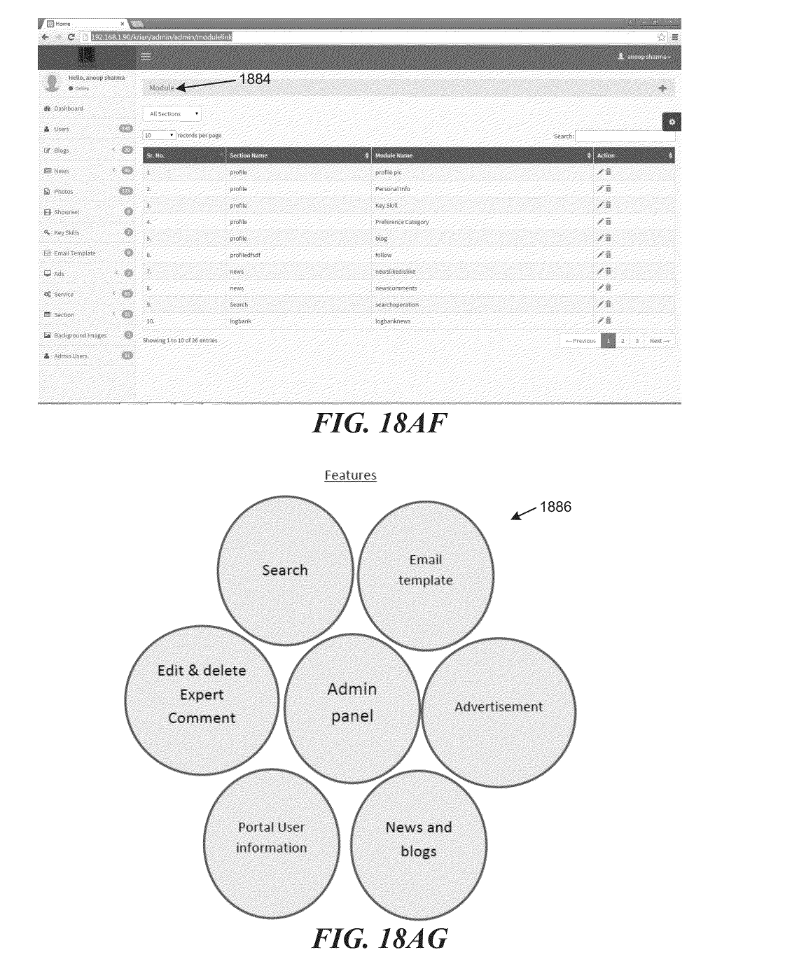

FIG. 18A shows an exemplary login screen 1800 for entering the admin panel. The Administrator of the portal has full control over registration, Content as well as the look of the system. Only those users with assigned roles including: (1) Admin, (2) Manager, and (3) Operator can login to the admin panel.

The portal or system includes various Admin Features that runs in the back-end that allows administrators or other portal officials with appropriate privileges to control and manipulate contents of the portal. A user can only log in to the Administrator interface if he has administration or back-end privileges. So users with valid Username and password will only be able to login. On Successfully login user has full access to admin control panel. Level of access to admin control panel depends on user type like admin, manager or operator. FIG. 18 is a process flow diagram of a login process 1800 for an admin panel. The process 1800 includes an admin user attempting to enter the admin panel by providing user ID or username and password (1802). The system or the portal determines whether the user is an existing user by validating the username and password (1804). When the user is an existing user (valid username, for example) but the user has forgotten his password, the user is directed to the Forgot Password process (1806). When the user is not an existing user, the user is directed to the Registration process (1808). Once registered, the newly registered user is directed to the login page to enter the admin panel (1802). Once the request to retrieve an existing user's password is received, the system retrieves the requested password and provides it to the user (e.g., via the registered email) (1812). The user is directed to login using the retrieved password (1810). Responsive to valid username and password at the login (1810), the user is provided access to the admin dashboard (1814).

Forgot Password: If admin user forgets password, they can fill forgot password page from where, temporary password will be send to his personal id. After retrieving the password user can login to the admin panel. Immediate after login the admin panel will ask for change password.

Admin Registration: Admin panel user can add, edit or delete a user's id and password from the back-end. To do this, the admin user must be logged in as a member of the Super Administrator group. The added Admin users are generally categories in terms of roles or user type like Admin, manager, operator. As per these roles users are provided with level of access to dashboard and other sections of the admin panel. For example, user type admin has access to Admin User section where new users can be registered with edit/delete option associated with it. For registering new user's credentials like first name, last name, mobile number, User type, valid admin username & password needs to be provided. Once valid admin user name and password are provided, the admin user can log into admin panel. FIG. 18C is an exemplary Admin User List Section 1820. The Admin User List section 1820 is used to update and add new admin users. Below are the attribute of admin users: (1) Name, (2) Contact number, (3) Email Id, (4) User type (Admin, manager & operator), and (5) Action (Edit or Delete Admin users). FIG. 18D is an exemplary Admin User Add form 1822. The Admin User Add form 1822 is used to add an admin user and is associated with fields or attributes including: First Name, Last Name, Email Address, Password, Mobile Number (10 digit validation), User Type (Admin, Manager, and operator).

Registered Portal User (Screen): Portal users can be registered manually from backend admin panel. For registering these users, the admin panel is provided with registration form with associated details like First name, Last name, username, password, mobile-code, mobile number, Gender, date of birth and the service provided by the user. Once registered, users can log in to website by entering this username and password. Any update or content provided on website or portal can be edited or deleted by admin panel. Admin panel has full access on user's account i.e. it can be activated or deactivated or else deleted. This allows the admin panel to retain complete control over registered users. FIG. 18E is an exemplary Add Registered Portal User form 1824. For adding new portal users, the Add Registered Portal User form 1824 includes the following fields (1) User with their essential credentials like, (2) First name, (3) Last name, (4) Email Address, (5) Password, (6) Mobile code & Number, (7) Gender, (8) Date of birth, and (9) Services.

Dashboard (Screen): When a user log in to the backend admin panel, he will arrive at the Control Panel also known as the Dashboard. From this dashboard, admin panel can keep track of any activities or updates provided by portal users. Dashboard has pie chart and bar chart displaying user information. Pie chart provides information like total number of users with newly added users, online users, deactivated users and half login users. Bar chart provides the country wise information i.e. Number of users associated to particular country. FIG. 18F shows an exemplary Dashboard 1830. After a successfully login, the Admin user gets redirected to Admin Dashboard. The Admin Dashboard contains various sections, including: (1) Pie Chart:—Total users, newly added users, currently online users, deactivated users and half login users; (2) Bar chart:—Each bar shows Users count for particular country and if users are not assigned any country it's shown in other bar; (3) Overall (Blog, News, Show-reel, Photo Gallery); (4) Newly added (Blog, News, Show-reel, Photo Gallery); and (5) Geographical (Country's, users, online, page views).

Blog: The Admin User keeps track of each blog that is posted online by portal users. Admin user has access to edit or delete this blog if required. Admin user can search the blog by directly entering key word on search box or else can search by user name, service or country. Along with Blog the expert comment posted on blogs by respective users can also be track down and if necessary can be edited or deleted accordingly. Comment can be searched by entering key word related to blog title, comment, blog author & comment. FIG. 18G shows an exemplary Blog Control Panel 1832 for displaying Blog Content. Admin User can edit and delete the content from the portal. Admin User can search a blog by users name & can delete or edit the blog content accordingly. On Admin can edit the title, image or YouTube video & description, for example. FIG. 18H shows an exemplary Blog Comment panel 1834 for displaying Blog Comment. Admin User can edit or delete the comment placed on any blog. FIG. 18I shows an exemplary Edit Blog Comment panel 1836 for editing Blog Comments. The Edit Blog Comment panel includes various attributes including (1) Comment by, (2) Blog Title, and (3) Comment. Admin User can update only the comment for the given blog.

News: News can be posted online by both, portal and admin users which can be shared with related service providers. News as well as expert comment on that news can be tracked down with credentials like author name & news title. The News patent includes various options provided for managing news including: (1) Add News with details like news title, image or YouTube embed code & description; (2) Searching news or comment on news either by entering key words on search box or else by selecting user name, service or country; and (3) Edit or delete option associated with each news and comment. FIG. 18J shows an exemplar News Content panel 1838. The News Content 1838 has a list of options associated with it, including: (1) Add news; (2) Edit News content (can edit title, photo or YouTube link, Description); and (3) Edit Comment. FIG. 18K shows an exemplary Add News form 1840. Newly added news can be visible only to the users whose service is included for sharing. FIG. 18L shows an exemplary Edit News Content panel 1842. The Edit News Content panel 1842 allows the Admin user to update all content associated with that particular news including: (1) News Title; (2) Image or YouTube link; and (3) Description. FIG. 18M shows an exemplary News Comment panel 1844. The Admin User can update or delete the comments placed on any news. FIG. 18N shows an exemplary Edit News Comment form 1846. The Admin User can edit only comments on the news.

Show-reels & Photos: Photos and Show-reels (video) posted online by each user are managed by admin panel. The photos and show-reels uploaded online are associated with attributes like uploaded by user name & uploaded time. With the uploaded name and timing, admin can keep track of the content with the edit or delete options. Admin Panel provides options to maintain the content including: (1) Admin can check incorrect or wrong photos and show-reel posted online.; (2) Delete the photos and show-reels if required; (3) Searching photos and show-reels or comment on photos and show-reels either by entering key words on search box or else by selecting user name, service or country; and (4) While on comments, admin can edit or delete comment on photos and show-reels if it's inappropriate. FIG. 18O shows an exemplary Photo Gallery 1850. Photos section have different sections including: (1) Photos Gallery (User name, Photo, Action, Upload Date Time); (2) Photo Comment; (3) Photo Gallery have below associated details along with the uploaded photo; (4) Uploaded by ; (5) Photos; (6) Action (Delete Option); and (7) Upload Date Time. FIG. 18P shows an exemplary popup window 1852 for displaying a photo. FIG. 18Q shows an exemplary Photo Comment page 1854. The Photo Comment page 1854 can include edit and delete options. FIG. 18R shows an exemplary Show-reel Gallery 1856. The show-reel Gallery 1856 shows the show-reel (video) uploaded by the portal users with details including: (1) User Name (Uploaded by); (2) Show-reel (viewed by clicking on particular show-reel in popup window); (3) Uploaded Date and Time; and (4) Action (Delete Option). FIG. 18S shows an exemplary popup window 1858 for viewing a Show-reel. FIG. 18T show an exemplary Show-reel Comment page 1860. The Show-reel Comment page 1860 shows the comments with associated terms including: (1) Uploaded by; (2) Commented by; (3) Comments; and (4) Action (Edit or Delete Options). FIG. 18U shows an exemplary Show-reel Comment Edit form 1862. The Show-reel Comment Edit form can be used to allow the Admin User to edit the comments for a particular Show-reel.

Services: Services provided by the users are added from admin panel, which get reflected on registration page. Newly created services get added to the group of services from where new portal user's selects them as their service while registration, thus each user is associated with this service id. These services are used for various purposes, including: (1) This service id is very useful while searching users with preferred services; (2) Services are used for sharing photos, show-reels, blogs and news; and (3) Providing key skills to respective service which is used in endorsing users. The Admin User can activate or deactivate these services and also, if not in use can also be deleted. FIG. 18V shows an exemplary Service page 1864. The Service page 1864 includes attributes including: (1) Add New Services; (2) Activate or Deactivate Services; (3) Edit Services; and (4) Delete Services. FIG. 18W shows an exemplary Edit and Delete Services form 1866. The Admin User can add or delete the services and once the services have been deleted, that particular services are removed from all of the service listing sites, i.e., from registration, sharing, adding news, etc.

Email Template: Admin panel has Email template in draft format, which is send as mail on registered email id of portal users for various scenarios, including: (1) Send for Email Verification; (2) Send for Notification; (3) Send for Friend request; (4) Send for Portal Error; (5) Send for forgot Password; (6) Send for user Deactivated; (7) Send for user Unfriend; (8) Send for service approved; and (9) Send for client login Detail. FIG. 18X shows an exemplary Email Template 1869. FIG. 18Y shows an exemplary Add Email Template 1870. The Add Email Template 1870 can be used to add email fields including: (1) Email Type (i.e., main sent for login verification, notification, friend request, etc.); (2) CC IDs; (3) BCC IDs; (4) Subject; and (5) Body.

Advertisement: Admin also provides the ads section from where the clients can create their profile and post their ads on portal. Ads are generally posted as rotational banners with different size. Clients can categories their ads as per gender & age group. The ad cost is depended on (1) Banner size; (2) Number of pages the ads to be posted; and (3) Time Duration for that particular ad. Every banner is associated with hyperlink which gets redirected to a client's page. The options provided by admin ads section can include: (1) Ads (which includes client registration, Ad account (placing ads as per location, gender & age group); (2) Client (manage the client, add or activate or deactivate campaign); and (3) Ads manager (from this section admin can view details of campaign running on different pages).

Search History: Admin panel is provided with search box for all section where user can search desired product or service by entering keywords on the product or service. User can also search with country name, service or username. Online search done by users is maintained by admin panel as a search history in terms of user name, keyword searched & searched date. FIG. 18Z shows an exemplary Search History page 1872. The Search history page 1872 stores the data about the search made by the portal users. The stored Search History can include details, including: (1) User Name; (2) Keywords; and (3) Search Date (search date and time).

Background Image: The Admin Panel can upload portal Login page background image. FIG. 18AA shows an exemplary Background Images page 1874 for storing uploaded Background Images. The Admin User can add or delete the background image from the Background Images page 1874. FIG. 18AB shows an exemplary Edit Background Image form 1876 for adding and deleting Background Images.

Key Skills: Key Skills are the skills assigned to particular service which is used for endorsing the portal users in question forma on the dashboard page. The Admin User can add or delete the key skills assigned to a particular service. FIG. 18AC is an exemplary Key Skills page 1878. FIG. 18AD shows an exemplary Edit Key Skills form 1880. The Edit Key Skills form can be used by the Admin User to add or delete a key skill from the Key Skills page 1878. Newly added key skill should have a unique service name.

Other Admin Features: Additional Admin Panel features are possible including: (1) Option for adding & updating sections and modules on portal; (2) Maintain Admin users by add, edit and delete option; and (3) On dashboard admin is also provided alerts of latest updates i.e. newly added users, blogs, Show-reels (videos) & photos. FIG. 18AE shows an exemplary Sections page 1882. From the Sections page, the Admin User can add new sections with different modules. Previously added Sections, such as News, Blogs, and Profiles, etc. are shown. FIG. 18AF shows an exemplary Section Modules page 1884. Each Section is divided into various Modules. For example, a Profile has a Profile Picture, Personal Information, Key Skills, etc. in the portal. The Admin User has an option to add, delete, or edit the Modules.

FIG. 18AG shows an exemplary Admin Feature diagram 1886 that illustrates an exemplary collection of features of the Admin Panel. The collection of exemplary Admin Panel features can include: (1) Search; (2) Email Template; (3) Advertisement; (4) News and Blogs; (5) Portal User Information; and (6) Edit & Delete Expert Comment.

Additional Features

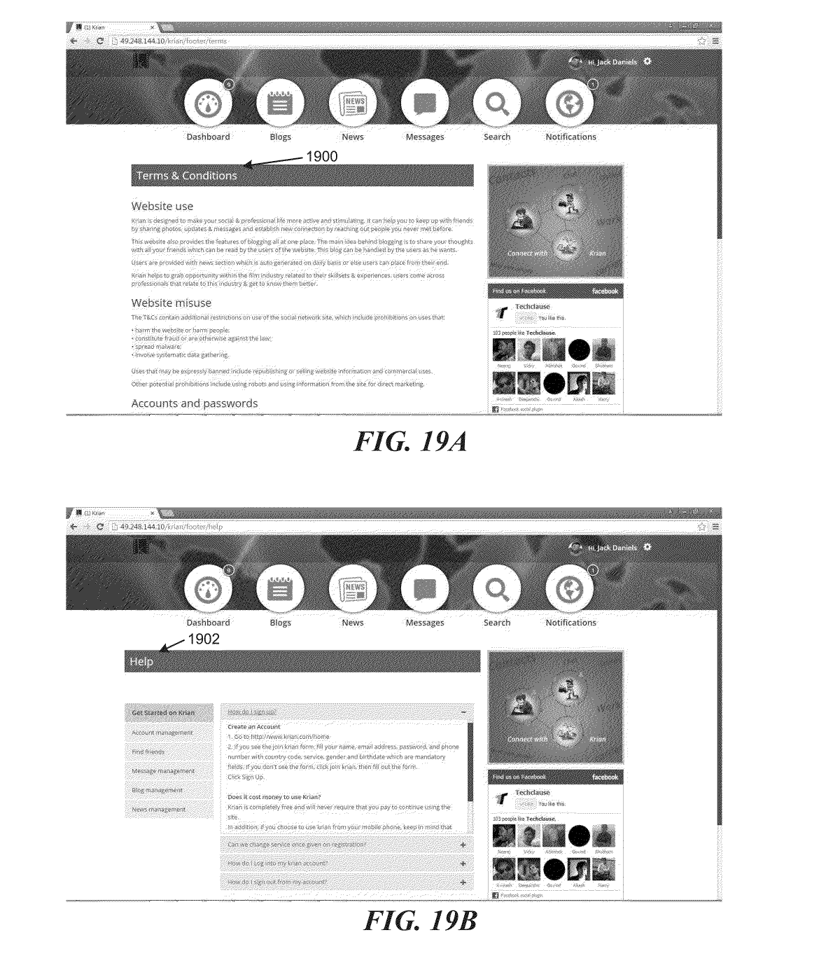

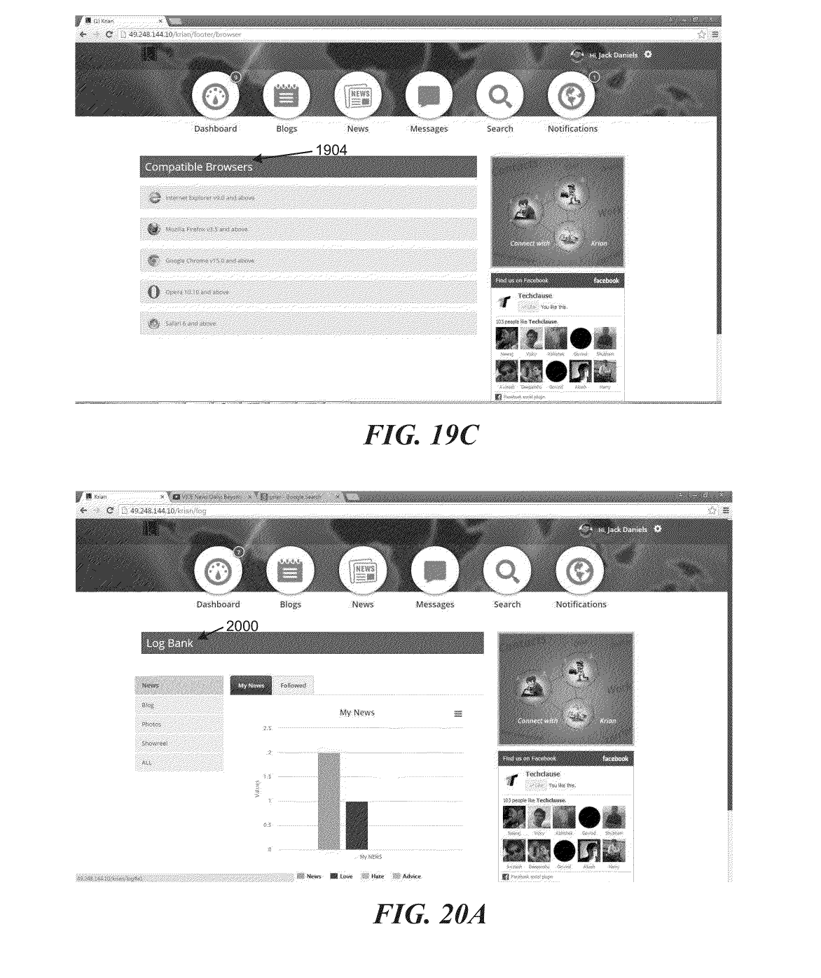

Footer Option: The content of the footer can include at least the following information—(1) Terms and Conditions; (2) Privacy; (3) About Us; (4) Help; and (5) Compatible Browser. FIG. 19A shows an exemplary Terms and Conditions page (1900). The Terms and Conditions page 1900 provides the terms and conditions for the portal relating to the website use & misuse, accounts & passwords, and user content. FIG. 19B shows an exemplary Help page 1902. Any issue or query related to the portal can be addressed in the help page 1902. The user can access the help page 1902 once the user has successfully logged into the portal. FIG. 19C shows an exemplary Compatible Browser page 1904. The Compatible Browser page 1904 provides a list of Web Browsers that are compatible with the portal. Examples of the Compatible Web Browsers can include (1) Internet Explorer v9.0 and above; (2) Mozilla Firefox v3.5 and above; (3) Google Chrome v15.0 and above; (4) Opera 10.10 and above; and (5) Safari 6 and above.

Log Bank: The portal or the system also includes a Log Bank that has multiple sections associated with different features of the portal and keeps track of all the changes to the different sections. Examples of the Log Bank sections include (1) News; (2) Blog; (3) Photos; (4) Show-reel; and (5) All. The News is updated when the user views the News and provides his Comments, Hate, or Love on the viewed News. The News section of the Log Bank includes the News Bar, Love Bar, Hate bar, and Comment Bar. The Blog section shows the update of the user's own Blog. The Blog section includes the Blog Bar that shows the number of Blogs uploaded by the user himself; Love Bar that shows the love click on the user's own blog; Hate Bar that shows the count of Hate click on the user's own blog; Comment Bar that shows the count of Comments on the user's own Blog; Chase Bar that shows the number of users chasing the user's own Blog. The Photos section shows the total number of photos shared in addition to the Comment, Lover, and Hate on the shared photos. The Photos section includes the Photos Bar, Love Bar, Hate Bar, and the Comment Bar. The Show-reel section shows the total number of show-reels shared in addition to the Comment, Love, and Hate on the shared show-reels. The Show-reel section includes the Show-reel bar, Love bar, Hate bar, and Comment bar. The All section shows the most visited pages by the user himself. The All Section includes the Search section, Blog section, News section, Profile section, Dashboard section, and Other section.

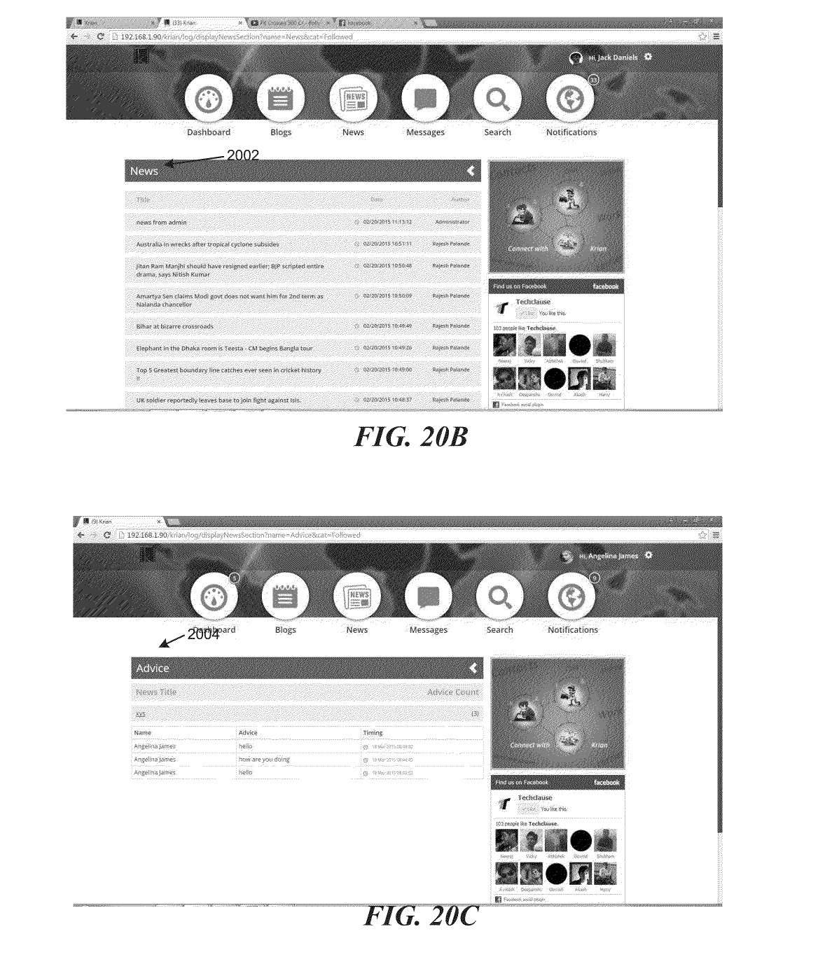

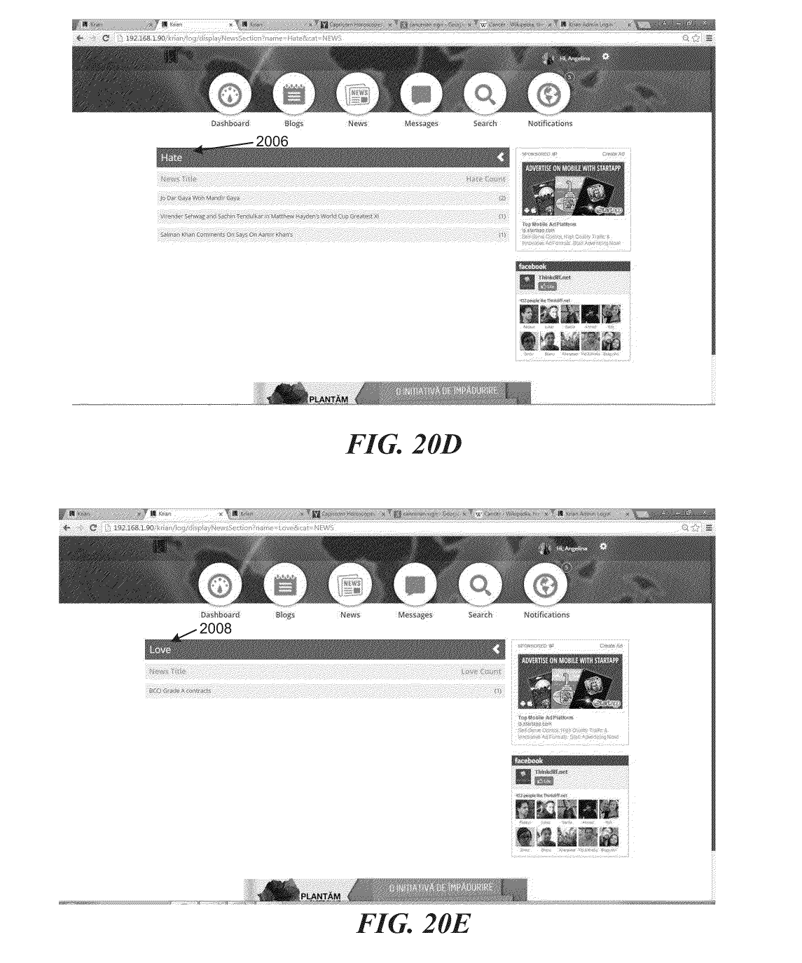

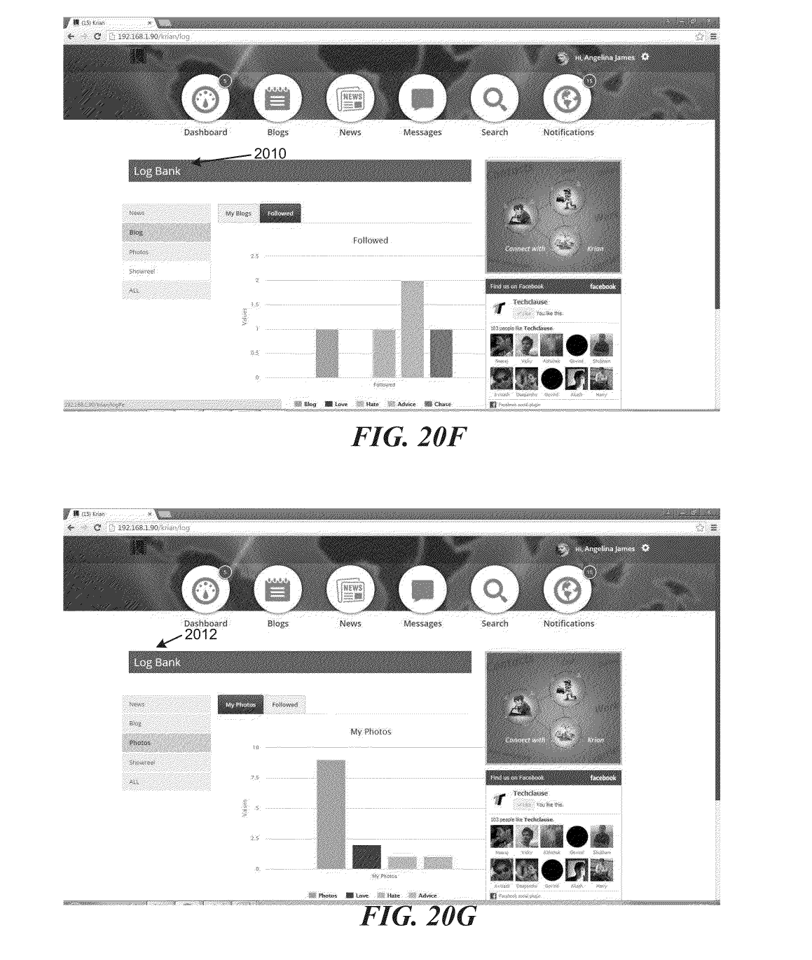

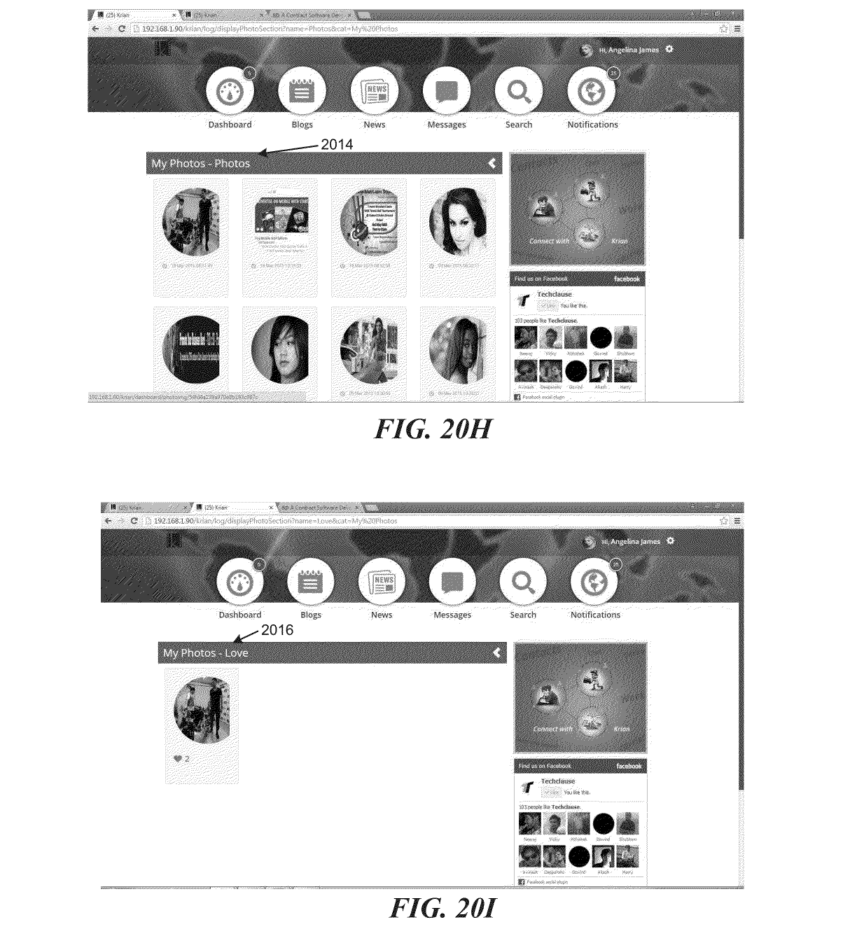

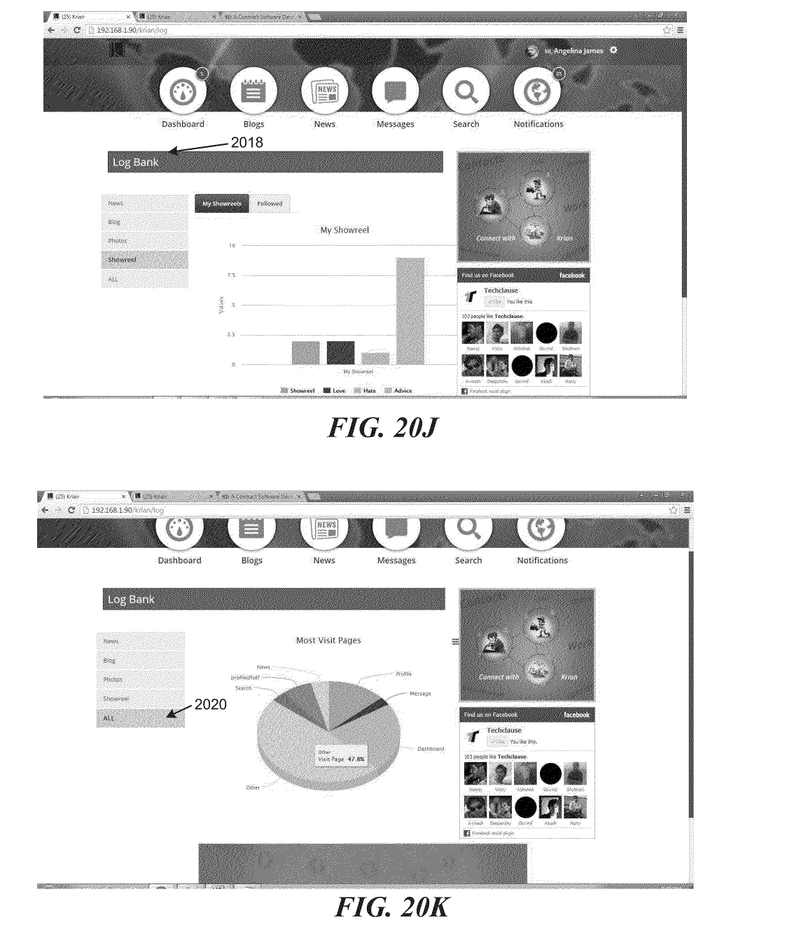

FIG. 20A shows an exemplary Log bank -News Section 2000. The Log Bank News section is updated when there is a comment, like, or hate count on particular news. The News section includes two tabs: My News; and News Followed.

FIG. 20B shows an exemplary News Count page 2002 that shows the News Title, News Date, and News Author.

FIG. 20C shows an exemplary New Advice or Comment Count page 2004. The News Advice or Comment Count page 2004 provides the News title with Comment count on respective news by the respective user.

FIG. 20D shows an exemplary Hate Bar 2006. Clicking on the Hate Bar gives the Hate Count on the respective News with News Title.

FIG. 20E shows an exemplary News Love Bar 2008. Clicking on the Love Bar gives the love count on the respective news with the news title.

FIG. 20F shows an exemplary Blog section 2010. The two sections include the My Blogs and Followed. My Blogs are placed by the user and includes data related to the two section and can include: (1) Total number of blogs with name and upload timings; (2) Total chase count on blogs; (3) Total love count on blogs; (4) Total hate count on blogs; and (5) Total comment count on blogs.

FIG. 20G shows an exemplary Photos section 2012. The Photos section of the Log Bank provides the photo count that is being shared. In addition to sharing, the Photos section also provides the Comment, Love (like), and Hate count on the photos. The different counts can include: (1) shared photos count; (2) love count on shared photos; (3) hate count on shared photos; and (4) comment count on shared photos.

FIG. 20H shows an exemplary Shared Photos bar 2014 of the Photos section. The Photos bar 2014 provides the user with the shared photos in gallery view with the Date of sharing.

FIG. 20I shows an exemplary Love Bar 2016 of the Photos section, The Love Bar 2016 provides the photo love count loved by other users on the My photos section.

FIG. 20J shows an exemplary Show-reel section 2018 of the Log Bank. The Show-reel section 2018 provides the show-reel count that is being shared. In addition to sharing the show-reel, the show-reel section 2018 shows the comment, love (like), and hate count on the shared show-reels. The count numbers can include: (1) total number of shared show-reel count; (2) total love count on the shared show-reel; (3) total hate count on shared show-reel; and (4) total comment count on shared show-reel.

FIG. 20K shows an exemplary All section 2020 of the Log Bank. The All section 2020 provides the user with data representation (e.g., pie chart) of statistical data related to highly visited sections. The highly visited sections are rated percentage wise. The Pie Chart is divided into 7 parts altogether and can include: Search; Blog; News; Profile; Message; Dashboard; and Others (Notification, profile, log bank, privacy setting, change password, deactivate account, public profile page).

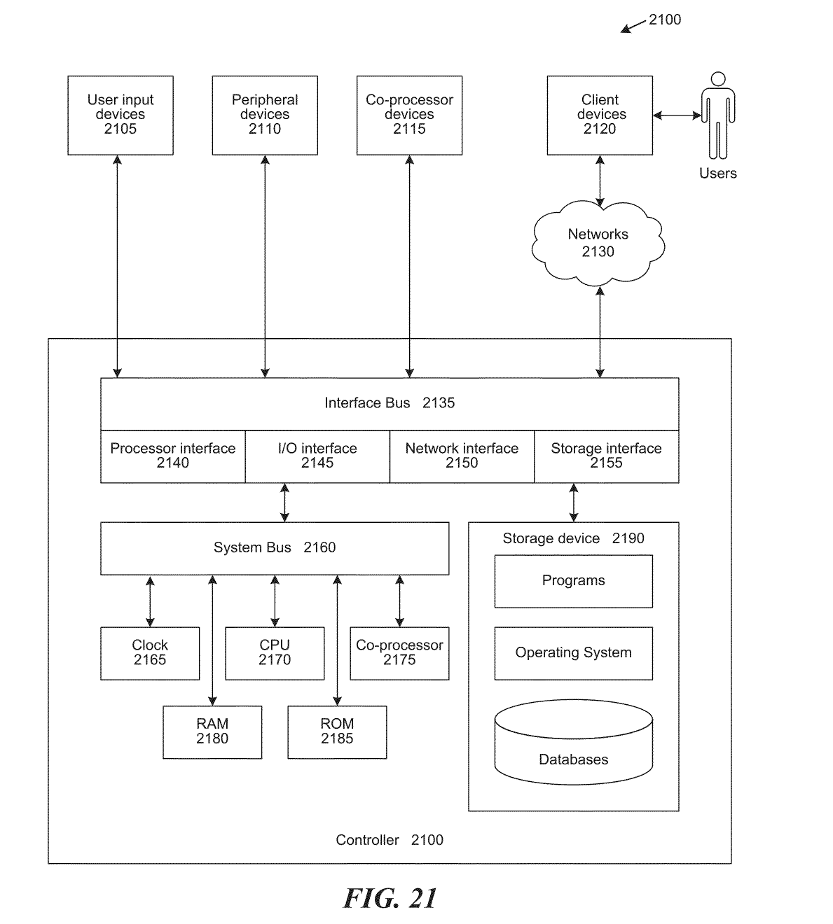

Aspects and implementations of various features and solutions disclosed in this application have been described in the general context of computer-executable instructions, such as routines executed by a general-purpose computer, a personal computer, a server, and/or other computing systems. FIG. 21 is a block diagram illustrating an example machine representing the computer systemization of the online management portal 101 as a controller 2100. The controller 2100 may be in communication with entities including one or more user input devices 2105, peripheral devices 2110, an optional co-processor device(s) (e.g., cryptographic processor devices) 2115 and networks 2130.

Computers employ a central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The controller 2100 may include clock 2165, CPU 2170, memory such as read only memory (ROM) 2185 and random access memory (RAM) 2180 and co-processor 2175 among others. These controller components may be connected to a system bus 2160 and through the system bus 2160 to an interface bus 2135. Further, user input devices 2105, peripheral devices 2110, co-processor devices 2115, and the like may be connected through the interface bus 2135 to the system bus 2160. The interface bus 2135 may be connected to a number of interface adapters such as processor interface 2140, input output interfaces (I/O) 2145, network interfaces 2150, storage interfaces 2155, and the like.

Processor interface 2140 may facilitate communication between co-processor devices 2115 and co-processor 2175. In one implementation, processor interface 2140 may expedite encryption and decryption of requests or data. Input output interfaces (I/O) 2145 facilitate communication between user input devices 2105, peripheral devices 2110, co-processor devices 2115, and/or the like and components of the controller 2100 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.).

Network interfaces 2150 may be in communication with the networks 2130. Through the networks 2130, the controller 2100 may be accessible to remote client devices 2120. Examples of networks 2130 include the Internet, Local Area Network (LAN), Metropolitan Area Network (MAN), a Wide Area Network (WAN), wireless network (e.g., using Wireless Application Protocol WAP), a cellular network, a secured custom connection, and the like. The client devices 2120 can include mobile, handheld or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a PDA, a smart phone (e.g., a BlackBerry device such as BlackBerry Z10/Q10, an iPhone, Nexus 4, etc.), a Treo, a handheld tablet (e.g. an iPad, iPad Mini, a Galaxy Note, Galaxy Note II, Xoom Tablet, Microsoft Surface, Blackberry PlayBook, Nexus 7, 10 etc.), a phablet (e.g., HTC Droid DNA, etc.), a tablet PC, a thin-client, a hand held console, a hand held gaming device or console (e.g., XBOX live, Nintendo DS, Sony PlayStation Portable, etc.), mobile-enabled powered watch (e.g., iOS, Android or other platform based), Google Glass, a Chromebook and/or any other portable, mobile, hand held devices, etc running on any platform or any operating system (e.g., Mac-based OS (OS X, iOS, etc.), Windows-based OS (Windows Mobile, Windows 7, Windows 8, etc.), Android, Blackberry OS, Embedded Linux platforms, Palm OS, Symbian platform, Google Chrome OS, and the like.

Network interfaces 2150 may use various wired and wireless connection protocols such as, direct connect, Ethernet, wireless connection such as IEEE 802.11a-x, and the like. The network interfaces 2150 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 2155 may be in communication with a number of storage devices such as, storage devices 2190, removable disc devices, and the like. The storage interfaces 2155 may use various connection protocols such as Serial Advanced Technology Attachment (SATA), IEEE 1394, Ethernet, Universal Serial Bus (USB), and the like.

User input devices 2105 and peripheral devices 2110 may be connected to I/O interface 2145 and potentially other interfaces, buses and/or components. User input devices 2105 may include card readers, finger print readers, joysticks, keyboards, microphones, mouse, remote controls, retina readers, touch screens, sensors, and/or the like. Peripheral devices 2110 may include antenna, audio devices (e.g., microphone, speakers, etc.), cameras, external processors, communication devices, radio frequency identifiers (RFIDs), scanners, printers, storage devices, transceivers, and/or the like. Co-processor devices 2115 may be connected to the controller 2100 through interface bus 2135, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The controller 2100 may employ various forms of memory including on-chip CPU memory (e.g., registers), RAM 2180, ROM 2185, and storage devices 2190. Storage devices 2190 may employ any number of tangible, non-transitory storage devices or systems such as fixed or removable magnetic disk drive, an optical drive, solid state memory devices and other processor-readable storage media. They can also include interrelated clusters in a cloud-computing architecture, using technologies such as Amazon Web Services (AWS) and the Hadoop framework. Computer-executable instructions stored in the memory may include the online management portal 101, having one or more components such as routines, programs, objects, data structures, and so on that perform particular tasks or implement particular abstract data types. For example, the memory may contain an operating system (OS) component, program modules, database components, and the like. These components may be stored and accessed from the storage devices, including from external storage devices accessible through an interface bus.

The controller 2100 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the controller 2100 may be distributed electronically over the Internet or over other networks (including wireless networks). Those skilled in the relevant art will recognize that portions of the online management portal 101 may reside on a server computer, while corresponding portions reside on a client computer. Data structures and transmission of data particular to aspects of the controller 2100 are also encompassed within the scope of the invention.

The above Detailed Description of embodiments of the disclosure is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps or employ systems having blocks, in a different order, and some processes or blocks may be deleted, moved, added, subdivided, combined, and/or modified to provide alternative combinations or sub-combinations. Each of these processes or blocks may be implemented in a variety of different ways. Also, while processes or blocks are at times shown as being performed in series, these processes or blocks may instead be performed or implemented in parallel or may be performed at different times.

From the foregoing, it will be appreciated that specific embodiments of the disclosure have been described herein for purposes of illustration, but that various modifications may be made without deviating from the scope of the disclosure. Accordingly, the disclosure is not limited.

What is claimed is:

1. A computing system for operating a global online portal which provides an end-to-end solution for film industry professionals, the system comprising:
a server system configured to register the film industry professionals with the portal;
a storage system communicatively coupled to the server system and configured to store a listing of the film industry professionals registered with the portal, wherein the listing of the registered film industry professionals include at least writers, directors, actors, and technicians listed in separate categories;
wherein the server system is configured to present the listing of the registered film industry professionals including a profile page of each of the registered film industry professionals as a part of the portal, the profile page including information on services provided by each of the registered film industry professionals.

2. The computing system of claim 1, wherein the profile page at the portal includes commercial terms of the services provided by each of the film industry professionals and a schedule of availability of each of the film industry professionals.

3. The computing system of claim 1, wherein each of the registered film industry professional is assigned to one or the different categories based on a rating associated with the film industry professional.

4. The computing system of claim 1, wherein the storage system is configured to add a new film industry professional to the listing of the film industry professionals registered with the portal responsive to the server system registering the new film industry professional.

5. The computing system of claim 1, wherein the server system is configured to validate or authenticate the film industry professionals before registering and including them in the list of the registered film industry professionals.

6. The computing system of claim 1, wherein the portal includes a global exchange platform for the film industry professionals.

7. The computing system of claim 6, where the global exchange platform for the film industry professionals includes a listing of scripts for purchase, wherein each script in the listing of scripts is in a particular language.

8. The computing system of claim 7, where the global exchange platform for the film industry professionals is configured to allow a given registered film industry professional to purchase a script from the listing of scripts in the particular language with a right to use the script to make a film in a different language.

9. The computing system of claim 6, where the global exchange platform for the film industry professionals is configured to allow a given registered film industry professional to hire one or more of the registered film industry professionals for a film project.

10. The computing system of claim 6, where the global exchange platform for the film industry professionals includes information on the services provided by the registered film industry professional, wherein the information on the services provided by the registered film industry professional includes a price for the services provided by the registered film industry professionals.

11. The computing system of claim 10, where the global exchange platform for the film industry professionals includes a platform for the registered film industry professionals to negotiate over the price.

12. The computing system of claim 10, where the global exchange platform for the film industry professionals allows each registered film industry professional to receive multiple offers for different film projects.

13. The computing system of claim 6, where the global exchange platform for the film industry professionals includes an auction or a reverse auction platform for film making services.

14. The computing system of claim 1, wherein the server system is configured to operate the portal in a language of a given user.

15. The computing system of claim 1, wherein the server system is configured to manage intellectual property issues.

16. The computing system of claim 1, wherein the server system and the storage system in combination are configured to maintain a log history of activities associated with each profile page of each of the registered film industry professionals.

17. The computing system of claim 1, wherein the log history includes updates to at least one of:
friend requests;
shared content;
posted advice;
posted love;
posted hate;
posted photos uploaded;
posted show-reels uploaded; or posted blogs.

18. A method for operating a global online portal to provide an end-to-end solution for film industry professionals, the method comprising:
registering, by a server system, the film industry professionals with the portal responsive to corresponding requests to register the film industry professionals;
storing, by a storage system communicatively coupled to the server system, a listing of the film industry professionals registered with the portal by the server system, wherein the listing of the registered film industry professionals includes at least writers, directors, actors, and technicians listed in separate categories;
presenting the listing of the registered film industry professionals including a profile page of each of the registered film industry professionals as a part of the portal, the profile page including information on services provided by each of the registered film industry professionals;
receiving a request to search the list of the registered film industry professionals based on the services provided; and
returning a search result, responsive to the received request, the search result including a subset of the registered film industry professionals that provides the requested service providing registered film industry professionals listed in an order based on the categories.

19. The method of claim 18, wherein the registering includes validating a user name and password for each film industry professional.

20. The method of claim 18, wherein the profile page at the portal includes commercial terms of the services provided by each of the film industry professionals and a schedule of availability of each of the film industry professionals.

21. The method of claim 18, wherein each of the registered film industry professional is assigned to one or the different categories based on a rating associated with the film industry professional.

22. The method of claim 18, comprising adding a new film industry professional to the listing of the film industry professionals responsive to registering the new film industry professional.

23. The method of claim 18, comprising operating the portal as a global exchange platform for the film industry professionals.

24. The method of claim 23, wherein operating the portal as the global exchange platform for the film industry professionals includes providing a listing of scripts for purchase, wherein each script in the listing of scripts is in a particular language.

25. The method of claim 24, wherein operating the portal as the global exchange platform for the film industry professionals includes allowing a given registered film industry professional to purchase a script from the listing of scripts in the particular language with a right to use the script to make a film in a different language.

26. The method of claim 23, wherein operating the portal as the global exchange platform for the film industry professionals includes allowing a given registered film industry professional to hire one or more of the registered film industry professionals for a film project.

27. The method of claim 23, wherein operating the portal as the global exchange platform for the film industry professionals includes presenting information on the services provided by the registered film industry professional, wherein the information on the services provided by the registered film industry professional includes a price for the services provided by the registered film industry professionals.

28. The method of claim 27, wherein operating the portal as the global exchange platform for the film industry professionals includes providing a platform for the registered film industry professionals to negotiate over the price.

29. The method of claim 27, wherein operating the portal as the global exchange platform for the film industry professionals includes allowing each registered film industry professional to receive multiple offers for different film projects.

30. The method of claim 23, wherein operating the portal as the global exchange platform for the film industry professionals includes operating the global exchange platform as an auction or a reverse auction platform for film making services.

31. The method of claim 23, comprising:
receiving a request to post a rating for one or more of the registered film industry professionals to provide information on the services provided by the rated registered film industry professional.

32. The method of claim 18, comprising displaying the search result showing locations of the subset of the registered film industry professionals included in the search result on a map.

33. A method for operating a global online portal to provide an end-to-end solution for film industry professionals, the method comprising:
registering, by a server system, the film industry professionals with the portal responsive to corresponding requests to register the film industry professionals;
storing, by a storage system communicatively coupled to the server system, a listing of the film industry professionals registered with the portal by the server system, wherein the listing of the registered film industry professionals includes at least writers, directors, actors, and technicians listed in separate categories;
presenting the listing of the registered film industry professionals including a profile page of each of the registered film industry professionals as a part of the portal, the profile page including information on services provided by each of the registered film industry professionals;
receiving a request from one of the registered film industry professionals to modify information associated with a corresponding profile page; and
modifying the corresponding profile page of the requesting one of the registered film industry professional based on the received request.

34. The method of claim 33, wherein receiving the request from one of the registered film industry professionals to modify information associated with the corresponding profile page includes at least one of:
posting a blog;
posting a news event;
posting photos;
posting show-reels; or posting professional experience.

35. The method of claim 33, comprising:
receiving a request from one of the registered film industry professional to chase another one of the registered film industry professional to allow the requesting registered film industry professional to automatically receive all posts by the chased registered film industry professional.

36. The method of claim 35, comprising:
receiving a request from the requesting registered film industry professional to un-chase the chased registered film industry professional to stop the automatically receiving all posts by the un-chased registered film industry professional.

37. The method of claim 34, comprising:
receiving a request from one of the registered film industry professional to share one or more of the postings with another registered film industry professional.

38. The method of claim 34, comprising:
receiving a request from one of the registered film industry professionals to send a message to another one of the registered film industry professionals.

39. The method of claim 38, comprising:
responsive to receiving the request to send the message, sending an error message to the sender of the message indicating that the recipient is offline.

40. The method of claim 33, comprising:
receiving a request from one of the registered film industry professionals to set the requestor's status to appear as being offline to other registered film industry users even though the requestor is still online.

41. The method of claim 33, comprising:
receiving a request from one of the registered film industry professionals to apply to a posting by another one of the registered film industry professionals at least one of:
comments that include information that the requestor wishes to add to the posting;
love that shows that the requestor liked the posting; or
hate that shows that the requestor does not like the posting.

42. The method of claim 33, comprising:
presenting to two of the registered film industry professionals, a list of mutual friends who are friends of the two of the registered film industry professionals.

43. The method of claim 33, comprising:
receiving a request from one of the registered film industry professionals to change a privacy setting to change who can view the profile page of the requestor.

44. The method of claim 33, comprising:
receiving from one of the registered film industry professionals a request to endorse another one of the registered film industry professionals.

45. The method of claim 33, comprising:
displaying on the profile page of a given registered film industry professional, a notification indicating a count of at least one of the following:
a number of messages unread;
a number of comments received by other registered film industry professionals on one or more of postings by the given registered film industry professional;
a number of loves received by other registered film industry professionals on one or more of postings by the given registered film industry professional;
a number of hates received by other registered film industry professionals on one or more of postings by the given registered film industry professional; or
a number of endorsement received by other registered film industry professionals on one or more of postings by the given registered film industry professional.
